(19) United States
(12) Patent Application Publication
(10) Pub. No.: US 2025/0074779 A1
(43) Pub. Date: Mar. 6, 2025

(54) AMMONIA PRODUCTION FROM NITRATE WASTE USING PtRu-BASED CATALYST

(71) Applicant: REGENTS OF THE UNIVERSITY OF MICHIGAN, Ann Arbor, MI (US)

(72) Inventors: Bryan Goldsmith, Ann Arbor, MI (US); Zixuan Wang, Ann Arbor, MI (US); Nirala Singh, Ann Arbor, MI (US)

(21) Appl. No.: 18/725,351

(22) PCT Filed: Dec. 20, 2022
(86) PCT No.: PCT/US22/82047

§ 371 Date: Jun. 28, 2024

Related U.S. Application Data
(60) Provisional application No. 63/296,659, filed on Jan. 5, 2022.

(51) Int. Cl. C01C 1/02; C25B 1/27; C25B 11/054; C25B 11/065; C25B 11/081; C25B 11/089

(52) U.S. Cl. CPC C01C 1/026; C25B 1/27; C25B 11/054; C25B 11/065; C25B 11/081; C25B 11/089

(57) ABSTRACT

Methods for electrocatalytic and thermocatalytic conversion of nitrate using PtxRuy/C catalysts are disclosed herein. The methods for electrocatalytic conversion of nitrate to ammonia can include contacting a nitrate containing source with an electrode comprising a PtxRuy/C catalyst while applying a potential sufficient to reduce nitrate to thereby convert nitrate present in the nitrate containing source to ammonia, wherein the PtxRuy/C catalyst comprises a carbon substrate having PtxRUy nanoparticles disposed thereon, and x is about 48 at % to about 90 at %, and y is 1−x.

### FIELD OF THE DISCLOSURE

The disclosure relates to methods for converting nitrate to ammonia using PtRu-based catalysts, and more particularly to electrocatalytic and thermocatalytic processes for conversion of nitrate to ammonia using PtRu-based catalysts.

### BACKGROUND

Nitrate is among the world's most widespread water pollutants, and its accumulation leads to adverse health effects and environmental damage through algal blooms and dead zone formation. Multiple approaches have been explored to manage nitrate contamination of water, including physical separation, biological denitrification, chemical reduction, catalytic hydrogenation, and electrocatalytic reduction. Each of these approaches has drawbacks for industrial applications.

Physical separation can result in fast and large-scale water treatment but produces a concentrated secondary stream that requires further processing. Current physical nitrate removal techniques in use at water treatment plants include ion exchange and reverse osmosis. Although both options are efficient, they produce a concentrated nitrate waste stream that incurs a high financial cost for disposal.

Biological nitrate treatment is a more sustainable alternative to convert nitrate to nitrogen (N₂) or ammonia (NH₃); however, this process is slow, requires organic nutrients, and cannot treat streams with cellular toxins. Biological approaches are also ineffective for treating harsh waste streams (e.g., acidic or containing heavy metals and halides) because these conditions deactivate or kill the bacteria.

Chemical reduction and catalytic hydrogenation require continuous external reducing agents, creating hazards in storage, transportation, and utilization, in addition to high cost.

Thermocatalytic nitrate reduction (TNO₃RR) and electrocatalytic nitrate reduction (ENO₃RR) can address many of the concerns and limitations in current processes and promote the rapid conversion of nitrate to either N₂ or NH₃. Despite ongoing research in electrocatalytic denitrification, there lacks a sufficiently inexpensive, active, selective (i.e., high faradaic efficiency towards N₂ or NH₃), and stable catalyst that would enable widespread application of this technology in acidic media. Rh is currently the most active and selective pure metal for nitrate reduction towards NH₃ in acidic media at low overpotentials. Nitrate adsorbs strong enough on Rh to maintain considerable surface coverages relative to hydrogen. The higher nitrate coverage promotes high rates of nitrate dissociation, which is often the rate-determining step for ENO₃RR. However, Rh is extremely expensive, costing over $8,200/oz. Besides the catalyst cost, another significant cost in an electrochemical process is electricity, typically accounting for 33% of commodity chemical production. To reduce operating costs in the system, catalysts need to be active at low overpotentials. Finding an inexpensive, stable electrocatalyst with activity and selectivity comparable to those of Rh at low overpotentials is a major challenge for widespread commercial denitrification. Most studies of TNO₃RR have used Pd-based catalysts that are effective for converting nitrite to N₂. However, Pd is an expensive platinum group metal and requires a promoter metal to initiate nitrate reduction to nitrite. Non-precious metals have been explored for TNO₃RR to reduce catalyst costs, but are selective towards undesirable products such as nitrite, NO, or N₂O. Additionally, TNO₃RR requires materials that can dissociate H₂.

In contrast to TNO₃RR, the ENO₃RR can use materials that are less active toward H₂ dissociation by tuning the applied potential. In both TNO₃RR and ENO₃RR, there is no consensus for the best catalyst for nitrate conversion to ammonia.

### SUMMARY

A method for electrocatalytic conversion of nitrate to ammonia can include contacting a nitrate containing source with an electrode comprising a PtxRuy/C catalyst while applying a potential sufficient to reduce nitrate to thereby convert nitrate present in the nitrate containing source to ammonia, wherein the PtₓRu_{y}/C catalyst comprises a carbon substrate having PtₓRu_{y} nanoparticles disposed thereon, and x is about 48 at % to about 90 at %, and y is 1−x.

A method for electrocatalytic nitrate reduction in a flow reactor can include flowing a nitrate containing source into a working electrode compartment of an electrochemical cell while applying a potential to the cathode. The electrochemical cell can include a cathode electrode in the catholyte electrode compartment, and an anode electrode disposed in an anolyte electrode compartment. The anode electrode compartment is separated from the cathode electrode compartment by a membrane. The cathode electrode includes a carbon substrate with a PtₓRu_{y} nanoparticles disposed thereon to form a PtₓRu_{y}/C catalyst, with x being about 48 at % to about 90 at %, and y is 1−x. Upon contact with the PtₓRu_{y}/C catalyst nitrate is converted to ammonia.

A method of thermocatalytic conversion of nitrate to ammonia can include generating H₂ in an aqueous suspension of a PtₓRu/C catalyst, wherein x is about 48 at % to about 90 at % and y is 1−x, and flowing a nitrate containing source into the suspension containing the catalyst and generated H₂. Upon contact with the catalyst nitrate in the nitrate containing source is converted to ammonia.

### BRIEF DESCRIPTION OF THE DRAWINGS

FIG. 1A is a schematic illustration of a process of nitrate conversion using electrocatalytic conversion.

FIG. 1B is a schematic illustration of process of nitrate conversion using thermocatalytic (left) and electrocatalytic (right) conversion.

FIG. 2A is a graph showing the k-weighted |x(R)| spectra of ex-situ PtₓRu_{y}/C catalysts in real space (unadjusted). The signal of the Pt foil in the EXAFS is rescaled by 0.5× to aid comparison against the synthesized PtₓRu_{y}/C catalysts.

FIGS. 2B and 2C are graphs of the XANES spectra for catalysts at (B) Pt L₃-edge and (C) Ru K-edge showing partial oxidation of the nanoparticle catalysts.

FIG. 2D is a graph of XRD spectra of PtₓRu_{y}/C with Pt #04-0802 and Ru #06-0663 standards, respectively.

FIG. 2E is a graph of location of the Pt(111) peak from XRD and the Pt—Ru coordination number (CN) from EXAFS shown vs. bulk Ru content. The inset provides a local magnification around the Pt(111) peak between 38-42°, and the gray line represents Pt #04-0802 standard.

FIG. 3 is a graph and associated TEM images for particle size distributions for (a) Pt₉₀Ru₁₀/C, (b) Pt₇₈Ru₂₂/C, (c) Pt₆₃Ru₃₇/C, and (d) Pt₄₈Ru₅₂/C. The scale bar indicates 20 nm in the micrograph. SD=standard deviation

FIG. 4A is a graph of the electrochemically active surface areas (ECSAs) of PtxRuy/C catalyst glassy carbon electrode determined using hydrogen underpotential deposition (Hupd) and copper underpotential deposition (Cuupd).

FIG. 4B is a graph of the Ru surface at % from XPS measurements and discrepancy between the copper underpotential deposition charge (Q_{Cu}) and hydrogen underpotential deposition charge (Q_{H}) normalized to Q_{Cu} as a function of bulk Ru composition.

FIG. 5A is a graph of steady-state nitrate reduction current densities in 1 M NaNO3 and 1 M H₂SO₄ at eight operating potentials between 0.05 to 0.4 V vs. RHE for PtₓRu_{y}/C catalysts, as normalized by Cu_{upd}.

FIG. 5B is a graph of the reduction current density at 0.1 V vs. RHE for five compositions of PtₓRu_{y}/C alloys with Cu_{upd} normalization. The corresponding plots for 0.05 and 0.075 V vs. RHE are given in FIGS. 5C-5E.

FIGS. 5C-5E are graphs of the reduction current density at (C) 0.05 V, (D) 0.075 V, and (E) 0.1 V vs. RHE as normalized to both H_{upd} and Cu_{upd} active sites. Steady-state measurements were conducted in 1 M H₂SO₄+1 M NaNO₃. Each potential is applied for 5 min with RDE rotation of 2500 rpm.

FIG. 6A are schematic illustrations of binding energies and geometry of the strongest-binding adsorbed 0 positions for (211) PtₓRu_{y} surface slab models (denoted “s-PtₓRu_{y}”) with Ru content up to 50 at %. Solid black line denotes the supercell. Atom color legend: gray=Pt and dark gray large circles=Ru.

FIG. 6B is a graph of ENO₃RR volcano plot contours at 0.1 V vs. RHE. Each point represents the strongest predicted binding energy on a specified PtₓRu_{y} random surface alloy or pure metal surface, for Ru surface compositions up to 50 at % (the same range as in experiment). The corresponding plot containing points for Ru surface compositions above 50 at % appears in FIG. 6D.

FIG. 6C is a graph showing a comparison between the log (TOF/s⁻¹) values calculated from DFT and the magnitude of the current densities obtained via experimental results at 0.1 V vs. RHE as a function of bulk Ru at %.

FIG. 6D is a graph showing a theoretical volcano plot at 0.1 V vs. RHE showing nitrate reduction activity of PtₓRu_{y}, Pt(211), Ru(211), and the Pt3Ru(211) point. The predicted N and O binding energies were overlaid on a map of catalyst turnover frequency (TOF) as a function of N and O binding energies.

FIG. 6E is a graph showing Comparison between the log (TOF/s⁻¹) values calculated from microkinetic modeling and the magnitude of the current densities obtained via RDE experiments. Active sites were detected and normalized by Cu_{upd}.

FIG. 7A is a graph showing the FE towards ammonia production for five different PtₓRu_{y} compositions supported on carbon felt (CF) after applying 0.1 V vs. RHE for seven hours in 0.1 M HNO₃. No nitrite was detected using ion chromatography and “Other Products” make up the potential gas-phase products that were not examined.

FIG. 7B is a graph showing the total (solid bars) and partial (striped bars) current densities towards ammonia production with PtₓRu_{y}/CF. Normalized to the ECSA from Cu_{upd}.

FIG. 8 is a schematic illustration of NaBH₄ synthesis procedure for making Pt_{X}Ru_{y}/C catalyst.

FIGS. 9A-9D are graphs showing the unadjusted raw XAFS spectra for PtₓRu_{y}/C catalysts at the Pt L₃-edge as (A) normalized XANES spectra (also shown in FIG. 2B), (B) EXAFS in the k-space, (C) magnitude of the R-space (also shown in FIG. 2A), and (D) the imaginary R-space. The black lines represent the measured spectra for the Pt foil, which has been rescaled by 0.5x in the k- and R-space.

FIGS. 10A-10F are graphs of measured and fitted EXAFS spectra for (A, B) Pt foil, (C, D) Pt₁₀₀/C, and (E, F) Pt₉₀Ru₁₀/C in R- and k-space, respectively. The experimental data is presented as the solid lines, whereas the dashed lines represent the fits. Paths for the Pt foil only include Pt—Pt, whereas the PtₓRu_{y}/C include Pt—Pt, Pt—O, and Pt—Ru fitted with R-range=1 to 3 Å and k-range=3 to 15 Å⁻¹.

FIGS. 11A-11F are graphs of measured and fitted EXAFS spectra for (A, B) Pt₇₈Ru₂₂/C, (C, D) Pt₆₃Ru₃₇/C, and (E, F) Pt₄₈Ru₅₂/C in the R- and k-space, respectively. The experimental data is presented in the solid lines, whereas the dashed lines represent the FEFF fits. Paths include Pt—Pt, Pt—O, and Pt—Ru fitted with R-range=1 to 3 Å and k-range=3 to 15 Å⁻¹.

FIGS. 12A-12D are the unadjusted raw XAFS spectra for PtₓRu_{y}/C catalysts at the Ru K-edge as (A) normalized XANES spectra, (B) in the k-space, (C) magnitude of the R-space, and (D) the imaginary R-space. The black lines represent the measured spectra for the Ru foil, which has been rescaled by 0.5× in the k- and R-space.

FIG. 13 is a transmission electron microscopy (TEM) image Pt₇₈Ru₂₂/C at 1.5 million magnification.

FIGS. 14A-14D are graphs of electrochemical surface area measurements. All H_{upd} and Cu_{upd} experiments were performed in 0.1 M H₂SO₄ and 0.1 M H₂SO₄+2 mM CuSO₄, respectively. (A) H_{upd} and Cu_{upd} experiments of Pt₁₀₀/C at 100 mV s⁻¹ scan rate. The peak at 0.3 V vs. RHE represent bulk Cu stripping, whereas the smaller peaks from −0.4-0.8 V vs. RHE is the Cu_{upd} region (highlighted box). (B) H_{upd} CV and Cu_{upd} LSV baseline on Vulcan carbon at 100 mV s⁻¹ scan rate. (C) A ratio of copper underpotential deposition desorption charge (Q_{Cu}) and hydrogen underpotential desorption charge (Q_{H}) on Pt₁₀₀/C was used to the find the deposition potential for a monolayer of adsorbed Cu. E_{Dep} is the applied deposition potential for 120 seconds. (D) H_{upd} and Cu_{upd} ECSAs at varying scan rates for commercial PtRu/C.

FIGS. 15A-15E are graphs showing baseline H_{upd} CVs in 0.1 M H₂SO₄ and corresponding Cu_{upd} LSV in 0.1 M H₂SO₄ and 2 mM CuSO₄ at 100 mV s⁻¹ for (A) Pt₁₀₀/C, (B) Pt₉₀Ru₁₀/C, (C) Pt₇₈Ru₂₂/C, (D) Pt₆₃Ru₃₇/C, (E) Pt₄₈Ru₅₂/C.

FIGS. 16A and 16B are X-ray photoelectron spectra shown for (A) Pt/C and (B) Ru/C. The signal intensity from these regions represent the amount of Pt and Ru on the surface of the material.

FIG. 17 is a graph showing a comparison of current densities between synthesized catalysts and their commercial counterparts. The activities were tested in 1 M H₂SO₄+1 M NaNO₃ and currents were normalized by H_{upd}.

FIG. 18A is graphs of cyclic voltammetry of commercial Ru/C in 1 M H₂SO₄ showing scanning at 100 mV/s, cycles in the oxidation region over time shows an increase in oxidation onset potential.

FIG. 18B is a graph of cyclic voltammetry of commercial Ru/C in 1 M H₂SO₄ for showing a comparison of Ru/C with Pt/C after 50 electrochemical pretreatment cycles showing little to no faradaic activity for Ru/C, which is attributed to Ru leaching into the electrolyte solution.

FIGS. 19A-19E are graphs of the last three cycles of H_{upd} CVs in 1 M H₂SO₄ before steady-state measurements for (A) Pt₁₀₀/C, (B) Pt₉₀Ru₁₀/C, (C) Pt₇₈Ru₂₂/C, (D) Pt₆₃Ru₃₇/C, and (E) Pt₆₃Ru₃₇/C.

FIG. 20A is a graph showing the current densities for commercial Pt/C, RH/C, and the Pt₇₈Ru₂₂/C catalysts of the disclosure at four different applied potentials. The electrolyte solution consisted of 1 M H₂SO₄+1 M NaNO₃. The measured currents were all normalized via H_{upd} of the active sites.

FIG. 20B is a graph showing the metal cost to purchase sufficient catalyst to convert 1 mole of NO₃ per hour based on activity of catalysts at 0.05 V vs. RHE and 0.1 V vs. RHE.

FIG. 21 are graphs showing Linear adsorbate scaling relationships between N, O, H⁺, and NO₃ ion PtₓRu_{y} alloys. Dashed lines are linear least-squares fits, and r² is the coefficient of determination. Electronic binding energies are reported at 0 K and 0 V vs. RHE, and Gibbs binding energies are at 298.15 K and 0 V vs. RHE.

FIG. 22 is a Bronsted-Evans-Polanyi plot for the NO₃*→NO*₂+O* dissociation on PtₓRu_{y} surfaces, along with Rh(211) and Ru(211).

FIGS. 23A and 23B are schematic illustrations of initial, transition state, and final geometries for CI-NEB calculations for each surface model. Electron energies are relative to the initial state. Solid black lines denote the boundary of the periodic supercell.

FIG. 24 is a schematic illustration of top views of the supercells of the PtₓRu_{y}(211) surfaces, as well as Rh(211) and Ru(211) for comparison. Each surface is FCC(211), so that the rightmost column of atoms is the highest in the z direction (normal to the surface). Dark grey=Ru, lightest grey=Pt, darkest grey=Rh.

FIG. 25 is a schematic illustration of nitrogen atom adsorption on the PtₓRu_{y} alloys. The strongest N binding energy is reported for each PtₓRu_{y} composition in eV, as well as Rh(211) and Ru(211) for comparison. Black solid lines denote the supercell. Dark grey=Ru, lightest grey=Pt, small circles=N, darkest large circle=Rh.

FIG. 26 is a schematic illustration of oxygen atom adsorption on the PtₓRu_{y} alloys. The strongest 0 binding energy is reported for each PtₓRu_{y} composition in eV, as well as Rh(211) and Ru(211) for comparison. Dark grey=Ru, lightest grey=Pt, dark small circles=0, darkest grey large circles=Rh.

FIG. 27 is a schematic illustration of NO₃ adsorption on PtₓRu_{y} alloys. The strongest NO₃ binding energy is reported for each PtₓRu_{y} composition in eV, as well as Rh(211) and Ru(211) for comparison. Dark grey=Ru, lightest-grey=Pt, darkest large circle grey=Rh.

FIG. 28 is a schematic illustration of hydrogen adsorption on PtₓRu_{y} alloys. The strongest H binding energy is reported for each PtₓRu_{y} composition in eV, as well as Rh(211) and Ru(211) for comparison. Darkest gray dark grey=Ru, mid-grey=Pt, lightest grey=H, darkest grey=Rh.

FIG. 29 is graphs showing N, O, H, and NO₃⁻ binding energies sampled on the PtₓRu_{y} alloys, Ru(211), and Rh(211). Each point represents an adsorption calculation, and the solid lines track the strongest binding energies as a function of alloy composition. Electronic binding energies are reported at 0 K (except for NO₃⁻ binding free energies, which are reported at 298.15 K using a thermodynamic cycle).

FIG. 30 is a graph showing the strongest DFT-predicted binding free energies of NO₃⁻ on PtₓRu_{y} surface alloys, Ru(211), and Rh(211). Each inset shows a representative example of the adsorption motif for each cluster of binding energies. Binding free energies are reported at 298 K and 0 V vs. RHE.

FIG. 31 is a graph showing Campbell degree of rate control (DRC) factor for all elementary steps as a function of O and N binding energies at 0.1 V vs. RHE. The Pt₃Ru(211) point is shown for comparison. All computed DRC values were clipped to the range [−2.0, 2.0]. White regions outside each envelope indicate O and N binding energies for which at least one surface reaction barrier is unphysical (negative).

FIG. 32 is a graph showing concentration of nitrate as a function of time during electrolysis at applied potential of 0.1 V vs. RHE in 0.1 M HNO₃ for the five synthesized catalysts. The error bars indicate the propagated error obtained from measurement and sampling variability.

FIGS. 33A and 33B are graphs showing performance of PtₓRu_{y}/CF over a seven-hour reaction. A) Faradaic efficiency of PtₓRu_{y}/CF towards NH₃ over seven hours at applied potential of 0.1 V vs. RHE. (B) Total charge of PtₓRu_{y}/CF during the reaction.

FIG. 34A is a graph showing a comparison of PtₓRu_{y}/C activity for nitrate conversion at different hydrogen partial pressures in thermocatalytic nitrate reduction reaction (TNO₃RR) based on ammonia production rate. All measurements were performed in pH 7 solution with 0.1 M NaNO₃. Assuming all electrons for ENO₃RR go to ammonia, a current density of 1 μA·cm⁻² is equivalent to a TOF of 31 min⁻¹ on Pt/C

FIG. 34B is a graph showing a comparison of PtₓRu_{y}/C activity for nitrate conversion at different applied potentials in ENO₃RR. All measurements were performed in pH 7 solution with 0.1 M NaNO₃. Assuming all electrons for ENO₃RR go to ammonia, a current density of 1 μA·cm⁻² is equivalent to a TOF of 31 min⁻¹ on Pt/C. Hydrogen pressure is shown increasing right to left in FIG. 34A to match the convention for less positive applied potential increasing the driving force for proton reduction in FIG. 34B.

FIG. 35 is a graph showing the activity of PtRu/C as a function of nitrate concentration in pH 7 solution. The activity of the TNO₃RR and ENO₃RR is defined in TOF (min⁻¹) and |Current Densityl (μA·cm⁻²), respectively. All experiments were performed at room temperature (23.3° C.), and the hydrogen partial pressure for TNO₃RR was set at 0.5 atm. 100% selectivity to ammonia was assumed for ENO₃RR measurements.

FIG. 36A is a graph showing Arrhenius plots of PtRu/C for thermocatalytic nitrate reduction reaction (TNO₃RR) and electrocatalytic nitrate reduction reaction (ENO₃RR) at pH 1 and pH 7. Temperatures for TNO₃RR experiments range from 20-50° C. and 10-30° C. for ENO₃RR. The activity of the TNO₃RR and ENO₃RR is defined in TOF (min⁻¹) and |Current Densityl (μA·cm⁻²), respectively. 100% selectivity to ammonia was assumed for ENO₃RR measurements.

FIG. 36B is a graph showing a comparison of apparent activation energy (Eₐ) and faradaic efficiency (FE) towards NH₃ across different solution pH and reaction systems. The light-purple solid bars denote Eₐ from ENO₃RR and dark-purple striped bars denote Eₐ from TNO₃RR. H₂ partial pressure was set at 0.5 atm and FE experiments were performed at 0.1 V vs. RHE.

FIG. 37 is a graph showing absolute current densities for pH 0-10 in 1 M NaNO₃ using PtRu/C at different applied potentials vs. RHE. The electrolyte solution at each pH is: pH 0-1 M H₂SO₄, pH 1-0.1 M H₂SO₄, pH 3-0.1 M sodium citrate+0.1 M citric acid, pH 5-0.2 M sodium acetate+0.2 M acetic acid, pH 7-0.2 M sodium phosphate+0.1 M citric acid, pH 10-0.1 M sodium carbonate+0.1 M sodium bicarbonate.

FIG. 38 is a graph showing a thermal gravimetric analysis data of the Vulcan carbon-based catalysts in air. Treatments were conducted by first degassing the samples in He at 100° C. before ramping at 10° C./min.

FIG. 39 is a graph showing X-ray diffraction spectra of PtₓRu_{y}/C catalysts with Cu Kα radiation and a Ni filter (λ=1.5418 Å) from 10° to 90° 2θ range. Crystallite sizes were estimated by applying the Scherrer equation and the Pt and Ru peaks are referenced to #04-0802 and #06-0663, respectively.

FIGS. 40A-40D are scanning electron microscopy images of (A) Pt/C, (B) Pt₂₅Ru₂₅/C, (C) PtRu/C, and (D) Ru/C. The accelerating voltage is set at 10 kV with 5 mm working distance.

FIGS. 41A-41D are images showing an overlay of elemental analysis from energy-dispersive X-ray spectroscopy on SEM images for (A) Pt/C, (B) Pt₂₅Ru₂₅/C, (C) PtRu/C, and (D) Ru/C.

FIG. 42 is a graph showing measured ammonia production rate for TNO₃RR on PtRu/C at pH 2 and 0.01 M NaNO₃ at stir rates from 500-1000 rpm. Average ammonia production rates are written inset. Experiments were performed at room temperature (23.3° C.) and the partial pressure of H2 was 0.5 atm.

FIGS. 43A-43D are graphs of initial baseline measurements for TNO₃RR measurements. Nitrate, nitrite, and ammonia concentration under reaction conditions (pH 2, 0.01 M NaNO₃) (A) with no added catalyst and (B) with Vulcan carbon support only. (C) Known concentration of ammonia over 90 min of reaction to ensure no ammonia evaporation from H2 bubbling into the system. (D) Comparison of the nitrate concentration of reaction with 50 mg of Pt/C and 10 mg of PtRu/C. Ammonia and nitrite concentrations throughout the reaction from Pt/C.

FIGS. 44A and 44B are graphs showing a Langmuir-Hinshelwood model of ENO₃RR activity for PtₓRu_{y}/C catalysts as a function of nitrate concentration at (A) pH 1 and (B) pH 7. All experimental data points are collected at 0.1 V vs. RHE. Coefficient of determination R² is written inset.

FIGS. 45A-45B are graphs of SSM and MSM Langmuir-Hinshelwood models of ENO₃RR activity for PtₓRu_{y}/C catalysts as a function of pH. (A) LH fitting for data collected between pH 0-7. (B) SSM for pH 0-3, and (C) MSM for pH 0-3. All experimental data points are collected at 0.1 V vs. RHE.

FIG. 46 is a graph showing a comparison between the faradaic efficiency of 10 mg of PtRu/C deposited on carbon felts in pH 1 (0.1 M HNO3) and pH 7 (0.2 M sodium phosphate+0.1 citric acid) electrolyte solution. Both experiments are conducted with 0.1 M nitrate at 0.1 V vs. RHE for at least 6 hrs.

FIG. 47 is a graph of a Tafel analysis of PtRu/C for pH 0-10. The electrolyte solution at each pH is: pH 0-1 M H2SO4, pH 1-0.1 M H2SO4, pH 3-0.1 M sodium citrate+0.1 M citric acid, pH 5-0.2 M sodium acetate+0.2 M acetic acid, pH 7-0.2 M sodium phosphate+0.1 M citric acid, pH 10-0.1 M sodium carbonate+0.1 M sodium bicarbonate.

FIG. 48 is a graph showing a comparison between the faradaic efficiency of 10 mg of PtRu/C deposited on carbon felts in pH 1 (0.1 M HNO3) and pH 7 (0.2 M sodium phosphate+0.1 citric acid) electrolyte solution. Both experiments are conducted with 0.1 M nitrate at 0.1 V vs. RHE for at least 6 hrs.

FIG. 49A is a graph showing a Pt 4d scan of the PtRu/C catalyst deposited onto a glassy carbon disk before and after operation at 0.1 V vs. RHE in sodium carbonate/sodium bicarbonate (pH=10) for 8 hours.

FIG. 49B is a graph showing a Ru 3p scan for the same catalysts as in FIG. 49A.

FIG. 50 is a graph showing the calculated ionic strength of all pH solutions for ENO3RR experiments. The electrolyte solution at each pH is listed: pH 0: 1 M H2SO4, pH 1:0.1 M H2SO4, pH 3: 0.1 M sodium citrate+0.1 M citric acid, pH 5: 0.2 M sodium acetate+0.2 M acetic acid, pH 7: 0.2 M sodium phosphate+0.1 M citric acid, pH 10: 0.1 M sodium carbonate+0.1 M sodium bicarbonate.

FIG. 51A is a top view of a partially assembled flow cell with a counter electrode (CE) compartment assembled showing the CE carbon felt and the membrane laying on top of the CE. The gasket and flow field for the working electrode (WE) are spread out in the order they would be assembled from left to right until the current collector on the right.

FIG. 51B is a photograph of the flow cell of FIG. 51B as assembled, showing the inlets, which during operation, are connected to two syringe (WE and CE input) in a syringe pump.

FIGS. 52A-52D are graphs of H_{upd} and Cu_{upd}, which were used to estimate the electrochemically active surface area of Rh/C, Pt/C, and PtRu/C deposited onto either a glassy carbon electrode (RDE, dashed lines) or a carbon felt (flow cell, solid lines). H_{upd} current densities for (A) Rh/C were taken at 50 mV/s. For (B) Pt/C, the H_{upd} was measured at 50 mV/s in the batch cell and at 5 mV/s in the flow cell. The flow cell currents for Pt/C are multiplied by 10 times to account for the difference in scan rate. The H_{upd} for (C) PtRu/C was taken at 100 mV/s and 50 mV/s on the RDE and carbon felt in the flow cell, respectively. The currents for PtRu/C in the flow cell are multiplied by 2 to compare to the RDE H_{upd} currents. All H_{upd} measurements were taken in de-oxygenated 0.1 M H₂SO₄. (D) Cu_{upd} current density and the corresponding baseline current density (without CuSO₄) are given for PtRu/C deposited on a glassy carbon RDE in 0.1 M H₂SO₄+2 mM CuSO₄ at 100 mV/s.

FIG. 53A-53C are graphs H_{upd} and Cu_{upd} currents at 50 mV/s in 0.1 M H₂SO₄ for (A) Rh/C, (B) Pt/C, and (C) PtRu/C on RDE before and after the electrode was used for electrocatalytic nitrate reduction at 0.1 V vs. RHE in 0.1 M HNO₃. CA=chronoamperometry.

FIGS. 54A and 54B are graphs showing steady-state nitrate reduction current density (j, solid lines) and partial current density to ammonia (dashed lines) at 0.1 V vs. RHE on Pt/C (circles), Rh/C (squares), and PtRu/C (diamonds) in 0.1 M HNO₃ at different (A) rotation rates in the batch cell with catalyst on a rotating disk electrode and (B) flow rates in the flow cell with catalyst supported on a carbon felt.

FIGS. 55A-55C are graphs showing steady-state nitrate reduction current density (j) and partial current density to ammonia (j_{NH4+}) at potentials between 0 and 0.2 V vs. RHE in the batch cell at 2000 rpm and the flow cell at 2 mL min⁻¹ for (A) Pt/C, (B) PtRu/C, and (C) Rh/C in 0.1 M HNO₃. Open symbols represent partial current densities.

### DETAILED DESCRIPTION

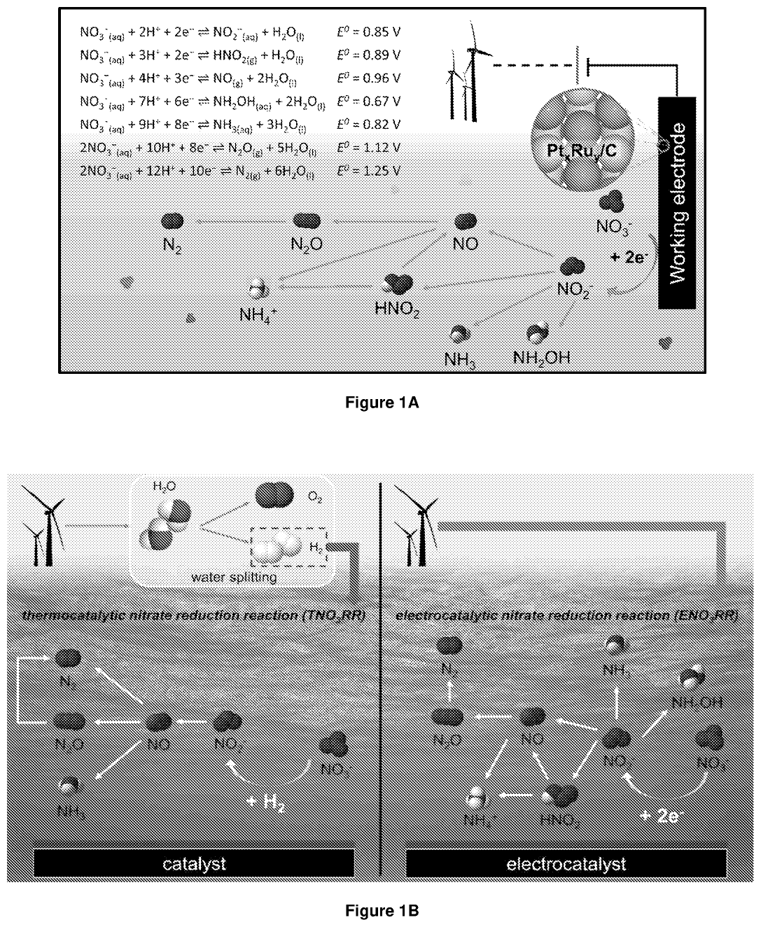

Thermocatalytic nitrate reduction (TNO₃RR) and electrocatalytic nitrate reduction (ENO₃RR) can address many of the concerns and limitations in current processes and promote the rapid conversion of nitrate to either N₂ or NH₃. The electrocatalytic nitrate reduction reaction (ENO₃RR) uses protons and electrons, which removes the need for an external H₂ stream and can be powered via renewable electricity. Referring to FIG. 1A, ENO₃RR converts aqueous NO₃ to NO₂ and then to products such as HNO₂, NO, NH₂OH, NH₃, N₂O, and N₂. As shown also shown in FIG. 1B, TNO₃RR converts aqueous NO₃⁻ to NO₂⁻ and then to produce NO and products such as N₂, N₂O, and NH₃. Preferential selectivity towards N₂ or NH₃ is often the target in literature. N₂ is a benign, easily separable, and the most stable nitrate reduction product with a standard redox potential (E⁰) of 1.25 V vs. RHE. NH₃ is a commodity chemical that would, in principle, reduce the reliance on the Haber-Bosch process for ammonia production if made from NO₃RR (E⁰=0.82 V vs. RHE). Producing NH₃ from NO₃⁻ is kinetically more accessible than breaking the N₂ triple bond, and NO₃RR may enable decentralized ammonia production using renewable electricity.

A method for electrocatalytic conversion of nitrate to ammonia can include contacting a nitrate containing source with a working electrode comprising the PtₓRu_{y}/C catalyst while applying a potential sufficient to reduce nitrate to thereby convert nitrate present in the nitrate containing source to ammonia. The method will also result in oxidation of water to oxygen.

The electrocatalytic conversion method can include flowing a nitrate containing source into a working electrode compartment of an electrochemical cell while applying a potential to the working electrode sufficient to reduce nitrate.

The working electrode can be the cathode and the counter electrode can be the anode. In such an arrangement, the working electrode compartment is the catholyte electrode compartment and the anode is disposed in an anolyte electrode compartment. The catholyte and anolyte compartments (or working and counter electrode compartments) can be separated by a membrane. The working electrode, which can be the cathode, includes the PtₓRu_{y}/C catalyst. Upon contact with the catalyst, the nitrate present in the nitrate containing source is converted to ammonia.

The nitrate containing source in electrocatalytic methods can have a pH of about 5 to about 7. For example, the pH can be 5, 6, 7 or any ranges defined between such values.

The working electrode, which can be the cathode, can have a catalyst loading of about 0.1 mg per cm² to about 10 mg per cm². Other suitable values include about 0.1, 0.2, 0.3, 0.4, 0.5, 0.6, 0.7, 0.8, 0.9, 1, 2, 3, 4, 5, 6, 7, 8, 9 or 10 mg per cm² or any values defined between such ranges.

A method of thermocatalytic conversion of nitrate to ammonia can include generating H₂ in an aqueous suspension of the PtₓRu_{y}/C catalyst and flowing a nitrate containing source into the suspension. Upon contact with the catalyst, nitrate in the nitrate containing source is converted to ammonia. The suspension can be maintained at a temperature of about 25° C. to about 90° C. For example, the suspension can be maintained at room temperature.

In methods of thermocatalytic conversion, the aqueous suspension can have a pH of about 1 to about 5. For example, the pH can be about 1, 2, 3, 4, or 5 or any ranges defined between such values.

The aqueous suspension can be stirred while flowing the nitrate containing source into the suspension. For example, the aqueous suspension can be stirred at a rate of about 100 rpm to about 10,000 rpm, about 1000 rpm to about 5000 rpm, about 1000 rpm to about 3000 rpm, or about 6000 rpm to about 9000 rpm. Other suitable rates, include, about 100, 200, 300, 400, 500, 600, 700, 800, 900, 1000, 2000, 3000, 4000, 5000, 6000, 7000, 8000, 9000, or 10,000 rpm or any ranges defined between such values.

The H₂ can be generated by applying a potential to the aqueous suspension to generate H₂ through water splitting. Alternatively or additionally, H₂ can be generated by sparging the suspension with H₂ gas.

The catalyst can be present in the aqueous suspension in an amount of about 1 mg catalyst per liter aqueous suspension to about 100 mg catalyst per liter aqueous suspension. Other suitable catalyst amounts per liter aqueous suspension include about 1, 2, 3, 4, 5, 6, 7, 8, 9, 10, 15, 20, 25, 30, 35, 40, 45, 50, 55, 60, 65, 70, 75, 80, 85, 90, 95, 100, and any ranges defined between and such values.

In any of the methods herein, the nitrate containing source can be wastewater, agricultural runoff, refuse runoff, sewage waste, low-level nuclear waste, and urban drainage. Other sources of nitrate can also be contemplated herein as suitable sources to be processed to ammonia. The nitrate can be present in the nitrate containing source in concentrations about 1 mM to about 1000 mM.

The nitrate containing source can undergo any suitable preprocessing if needed, for example, to concentrate or dilute the nitrate concentration. For example, the nitrate source can be pretreated by concentration to increase the nitrate concentration by various methods such as reverse osmosis, electrodialysis, or the like. Other pretreatments can include removal of heavy metal ions that may act as catalyst poisons.

Methods of the disclosure can have improved Faradaic Efficiency toward ammonia. For example, methods the disclosure can have an FE of ammonia of at least about 85%, at least about 88%, at least about 90%, or at least about 95%.

Methods for electrocatalytic conversion and thermocatalytic conversion utilize a PtₓRu_{y}/C catalyst. The catalyst can include a carbon support having PtₓRu_{y} nanoparticles disposed thereon, wherein x is about 48 at % to about 90 at % and y is 1-x. Other suitable values for x can include about 50 at % to about 80 at %, about 75 at % to about 90 at %, or about 65 at % to about 85 at %. For example, x can be about 48, 49, 50, 52, 54, 56, 58, 60, 62, 64, 66, 68, 70, 72, 74, 76, 78, 80, 82, 84, 86, 88, 90 at % or any ranges defined between such values.

The PtₓRu_{y} nanoparticles can have an average diameter, as measured by transmission electron microscopy or estimated using extended X-ray absorption fine structure, of about 2 nm to about 6 nm, about 2 nm to about 5 nm, or about 2 nm to about 4 nm. For example, the average diameter can be about 2, 3, 4, 5, or 6 nm or any ranges defined between such values, as measured by transmission electron microscopy or estimated using extended X-ray absorption fine structure.

For electrocatalytic any suitable carbon support can be used. The support could be carbon black, for example. For example, the support can be a substrate such as carbon felt. The carbon felt can be disposed on a graphite rod for electrocatalytic conversion methods.

Methods of electrocatalytic conversion in accordance with the disclosure can utilize electrochemical flow cells configurations. In such configurations, the counter electrode can include a carbon substrate having a conductive catalyst disposed thereon. The conductive catalyst can be, for example, RuO₂, IrO₂, and mixtures thereof.

Surface Characterization of the Supported PtₓRu_{y} Alloys

In many PtₓRu_{y} systems, changing the synthesis temperature or support can drastically alter the level of Pt-surface enrichment. Thus, alloys with the same bulk composition may have different levels of activity depending on the composition of the metals on the surface that catalyze the reaction.

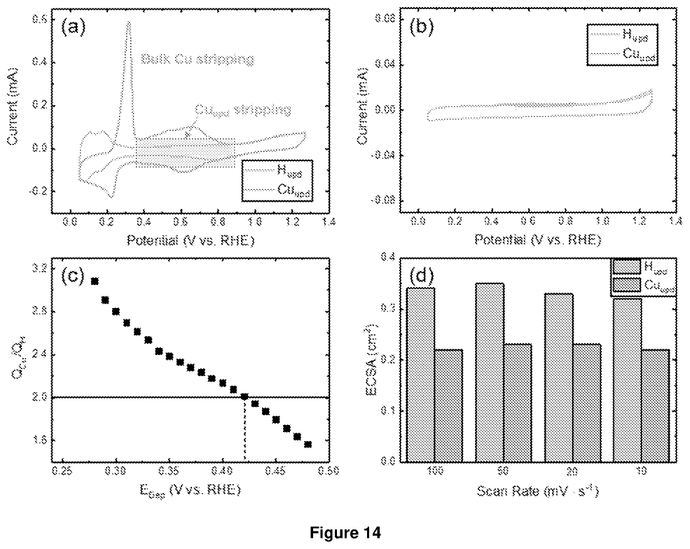

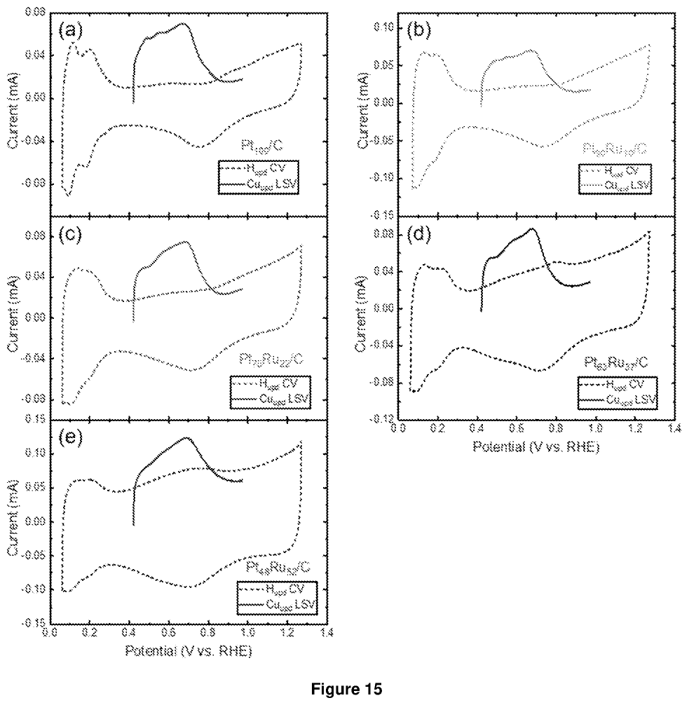

Accurately determining the ECSA allowed for counting the number of surface Pt and Ru sites, which served to both normalize measured activity for qualitative comparison to theory and quantify the surface composition. Because each surface Pt atom adsorbs approximately one hydrogen atom, the charge associated with hydrogen adsorption and desorption is often used to calculate the ECSA. However, this well-known H_{upd} technique was unsuitable for Ru-based materials due to overlapping hydrogen and ruthenium oxidation currents. Additionally, more than one monolayer of hydrogen may adsorb onto Ru sites. To overcome this challenge for PtₓRu_{y}/C alloys, copper underpotential deposition (Cu_{upd}) was used because there is roughly one Cu atom electrodeposited per surface Pt or Ru site (FIG. 14A). It was ensured that no Cu adsorbed to the surface of the carbon support (FIG. 14B) and determined that a single monolayer of Cu adsorbs on Pt₁₀₀/C at 0.42 V vs. RHE based on a charge ratio of Cu:H=2 (FIG. 14C). Cu_{upd} was also performed at different scan rates to ensure there was no significant impact on the measured ECSA (FIG. 14D). 0.42 V vs. RHE was selected as the deposition potential for all PtₓRu_{y}/C catalysts (FIG. 15). This was based on close agreement between the ECSA results using Cu_{upd} and H_{upd} at low Ru %. Under the assumption that copper atoms adsorb on the electrode surface at the same sites as the hydrogen atoms, the ratio of copper and hydrogen charge was expected to be two on the Pt nanoparticles. 0.42 V vs. RHE was determined as the potential for adequate formation of a Cu_{upd} monolayer without interference from bulk Cu. At deposition potentials lower than 0.42 V vs. RHE, the charge ratio is greater than two, meaning that bulk Cu could still be adsorbed to the surface. There was a loss in charge above 0.42 V vs. RHE, indicating that the underpotential monolayer is not fully formed. This deposition potential of 0.42 V was used to measure the Cu_{upd} of all PtₓRu_{y}/C materials (FIG. 15A-15E).

Even though the selected deposition potential may slightly change the ECSA (Δ10 mV in deposition potential is ±0.014 cm² in ECSA), it was not believed that it would significantly impact the changes observed in the measured activities of the alloy. After measuring the charge of the Cu_{upd} peak, the ECSA is calculated by assuming that a single Cu atom will bind to Pt or Ru with a 1:1 ratio and that two electrons are transferred from Cu²⁺. The Cu_{upd} values used to normalize the current activity are determined prior to kinetic experiments performed in fresh electrolyte solution. Due to the small differences in the amount of catalyst deposited on the glassy carbon electrode and contact with the electrolyte solution, the ECSA may vary up to 30% from run to run, so reported activities were normalized to the ECSA from a particular run. The normalized current densities for each catalyst were reproducible when normalizing to the ECSA for that deposition.

The measured ECSAs from both H_{upd} and Cu_{upd} are shown in FIG. 4A. Regardless of the measurement technique, the ECSA for the five different compositions of PtₓRu_{y}/C catalysts ranges between 0.20-0.35 cm², which was lower than the ECSA for commercial Pt/C and PtRu/C catalysts (Table 1).

The commercial Pt/C and PtRu/C both had higher ECSA compared to the synthesized materials despite having the same metal loading. This may arise because the commercial catalysts had higher dispersion, therefore a smaller average particle size calculated from XRD. The ECSA of synthesized PtₓRu_{y}/C ranged from 0.2-0.4 cm, regardless of measurement technique. The difference between the ECSAs of H_{upd} and Cu_{upd} increases as the Ru content increases because more than one hydrogen binds to Ru active sites. The Cu_{upd} approach eliminates the over counted sites because only one Cu atom adsorbs per Ru site.

TABLE 1
Measured electrochemical active surface area
from H_{upd} and Cu_{upd} technique for
commercial and synthesized PtₓRu_{y}/C catalysts.

| Catalysts | H_{upd} (cm²) | Cu_{upd} (cm²) |
|---|---|---|
| Pt/C—commercial | 0.94 | 0.94 |
| PtRu/C—commercial | 0.71 | 0.51 |
| Pt₁₀₀/C | 0.36 | 0.36 |
| Pt₉₀Ru₁₀/C | 0.22 | 0.22 |
| Pt₇₈Ru₂₂/C | 0.25 | 0.20 |
| Pt₆₃Ru₃₇/C | 0.35 | 0.29 |
| Pt₄₈Ru₅₂/C | 0.34 | 0.22 |

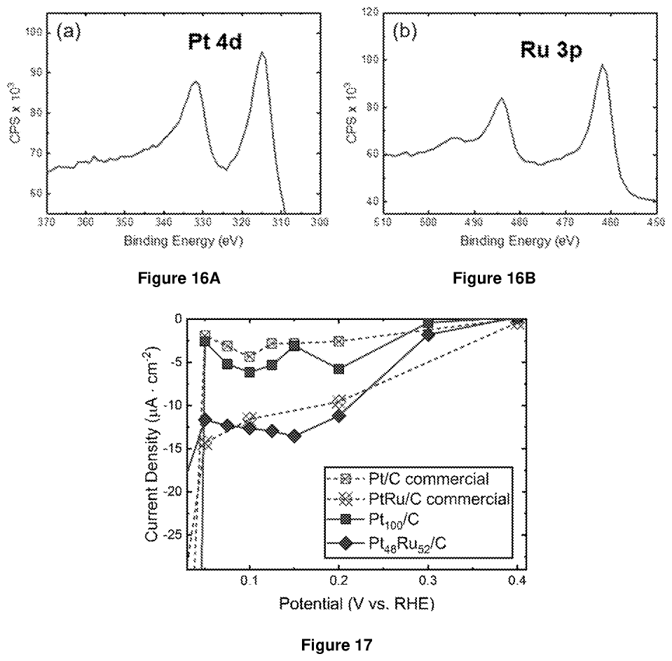

The H_{upd} and Cu_{upd} ECSA measurements increasingly disagree as the bulk Ru at % increased. Without intending to be bound by theory, it is believed that this phenomenon is attributable to more than one hydrogen adsorbing per Ru site, such that H_{upd} over-counts the ECSA when Ru is present on the surface, causing a disagreement between H_{upd} and Cu_{upd} that increases with increasing surface Ru. The increasing discrepancy between H_{upd} and Cu_{upd} charge ((Q_{H}−Q_{Cu})/Q_{Cu}) is shown in FIG. 4B, which correlates with increased surface Ru at % as the bulk Ru at % increases. Likewise, the surface composition from ex-situ XPS (FIG. 16 and Table 2) shows a similar trend as bulk Ru at % increases. The qualitative agreement between the ex-situ XPS Ru surface composition and the Ru surface composition in electrolyte implies minimal restructuring of the surface upon exposure to the supporting electrolyte. The Cu_{upd} ECSAs measured here will be used to normalize the activity of the catalysts in the next section unless specified otherwise.

X-ray photoelectron spectroscopy (XPS) was conducted using a Kratos Axis Ultra X-ray photoelectron spectrometer. While keeping the analysis chamber at 1×10⁻⁹ Torr, a monochromatic Al X-ray source (10 mA and 12 kV) was used with a pass energy of 12 eV and step size of 1 eV. Collected spectra were calibrated by positioning the C(1s) peak at 248.8 eV. Survey scans ranged from 600-0 eV while the narrow scans were performed between 370-300 eV and 510-450 eV for Pt 4d and Ru 3p, respectively (FIG. 16). The resulting Pt 4d and Ru 3p peaks were fitted with the Shirley-type background with the CasaXPS software. The relative compositions were determined by integrating the peaks and normalized by the relative sensitivity factor for Pt 4d and Ru 3p.

The data from Table 2 is plotted in FIG. 4B and shows that the surface Ru at % from XPS correlates with the bulk Ru at % obtained from ICP-MS. At lower Ru loading, the bulk and surface concentrations are more similar than that at higher Ru loading.

TABLE 2
Comparison between bulk Ru at % determined
from ICP-MS and surface Ru at % determined
from Ru XPS intensity. The naming convention of
the catalysts are based on the bulk at % of the metals.

| | Bulk Ru | Surface | Ru XPS |
|---|---|---|---|
| Catalysts | at % | Ru at % | Intensity |
| Pt₁₀₀/C | 0 | 0 | 0 |
| Pt₉₀Ru₁₀/C | 10 | 12 | 2932.6 |
| Pt₇₈Ru₂₂/C | 22 | 25 | 6221.5 |
| Pt₆₃Ru₃₇/C | 37 | 55 | 17172.6 |
| Pt₄₈Ru₅₂/C | 52 | 58 | 18634.2 |

### Density Functional Theory Modeling

All DFT calculations used the Vienna Ab Initio Simulation Package, version 5.4.4. Calculations used the projector-augmented wave method with an energy cutoff of 400 eV, the PBE functional, and Gaussian smearing of 0.2 eV. For surface calculations, the Brillouin zone was sampled with a 6×6×1 Monkhorst-Pack k-point grid. Self-consistent electronic calculations used a between-iteration tolerance of 10⁻⁴ eV and ionic relaxation proceeded until all forces on atoms were less than 0.02 eV/A.

The alloy catalysts were constructed using the Atomic Simulation Environment software package, version 3.17.0. Nine random surface alloys were created based on a 3×4×4 supercell of Pt(211), using a Pt lattice constant which was optimized (3.97677 Å) with the PBE functional on a 16×16×16 k-point grid. For all simulations, the surface slab contained four layers of atoms, where the bottom two layers were constrained to their bulk positions and the top two layers could relax. Surface alloy models were prepared by randomly assigning each of the 12 atoms in the top surface layer as either Pt or Ru, resulting in surface compositions ranging from 0 at % Ru to 50 at % Ru. Surfaces were then geometry-optimized with a vacuum of at least 15 Å in the z direction.

The Pymatgen software package was used to locate unique adsorption sites. The electronic binding energy ΔE_{A} of species A was calculated with respect to the bare surface and the electronic energy of species A in the gas phase. Aqueous-phase NO₃⁻ adsorption Gibbs free energies were obtained at 298.15 K and 0 V vs. RHE using a thermodynamic cycle.

The catalyst activity was predicted by relating the gas-phase electronic binding energies of atomic O and N (ΔE_{O} and ΔE_{N}) to the overall mean-field kinetics of the nitrate reduction reaction. This task was accomplished by using a theoretical volcano plot. The PBE functional and face-centered cubic (FCC) (211) facet were chosen to enable the comparison of results with its theoretical volcano plot. This was also considered an appropriate comparison to the synthesized PtₓRu_{y} particles because only Ru compositions was considered for which Pt_{X}Ru_{y} particles form in an FCC lattice.

The nitrate-to-nitrite dissociation barrier (NO₃*+*⇄NO₂*+O*) for each random surface alloy slab was computed using the climbing-image nudged elastic band (CI-NEB) method. The band was formed with five interior images linearly interpolated between the initial and final endpoint geometry. CI-NEB relaxation used spring forces of 5 eV Å⁻¹ between images and the same electronic and force tolerance parameters as the adsorption calculations.

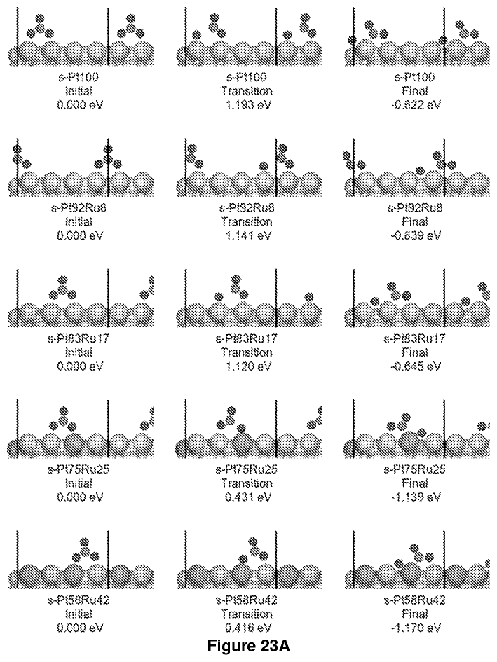

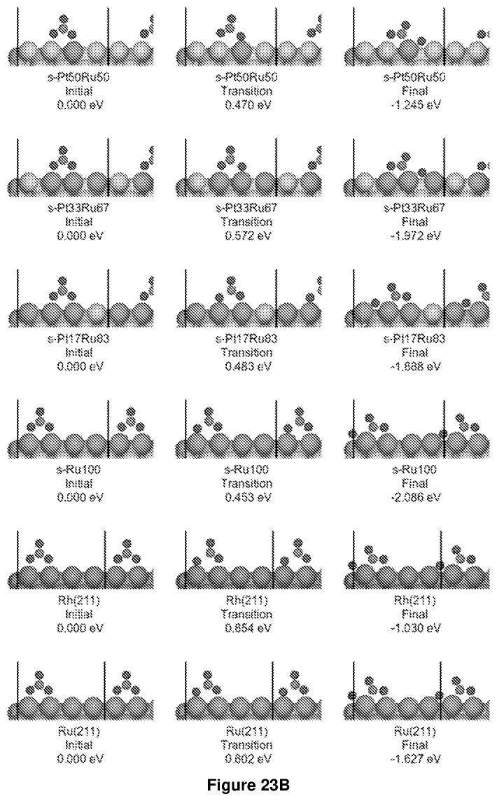

For each NEB calculation, the initial image was the relaxed geometry of NO₃* at its optimal [O—O]-chelating binding position on the third ridge of each FCC(211) material. The final endpoint was formed by assuming an elementary step in which one of the basal 0 atoms migrates to a neighboring bridge site up or down the third ridge, following which the remaining NO₂ fragment rotates downward into a [N—O]-chelating position. FIG. 23 shows the initial, transition state, and final images for each CI-NEB calculation performed to calculate the activation barrier for nitrate-to-nitrite dissociation.

All DFT-predicted energetics (adsorption energies, reaction energies, and activation energies) are done at low coverages (i.e., 1/12 ML for H, N, and 0 and ⅙ ML for NO₃) and neglect lateral adsorbate-adsorbate interactions due to high coverage of a single species or the presence of co-adsorbed species (e.g., co-adsorbed H affecting the adsorption strength of NO₃⁻, which weakens adsorption strength of nitrate by ˜0.25 eV at 1/12 ML H coverage). Such shifts are typical of co-adsorption of H with small molecular adsorbates on metal surfaces. This effect would also similarly weaken adsorption energies for other NO₃RR species, and thus would likely not qualitatively change trends. Neglecting co-adsorbate interactions on adsorption free energies is a common approximation when studying complex reaction networks such as electrocatalytic nitrate reduction because of the large computational expense to treat coverage-dependent interactions for all species in the model.

On pure transition metals, linear adsorbate scaling relations (among N, O, and other reaction intermediates) and Bronsted-Evans-Polanyi relations (between adsorption and activation energies) exist for the NO₃RR. Consequently, a microkinetic model for NO₃RR was found to be able to predict trends in the reaction rates, steady-state coverages, and degrees of rate control given only the N and O binding energies and an applied potential.

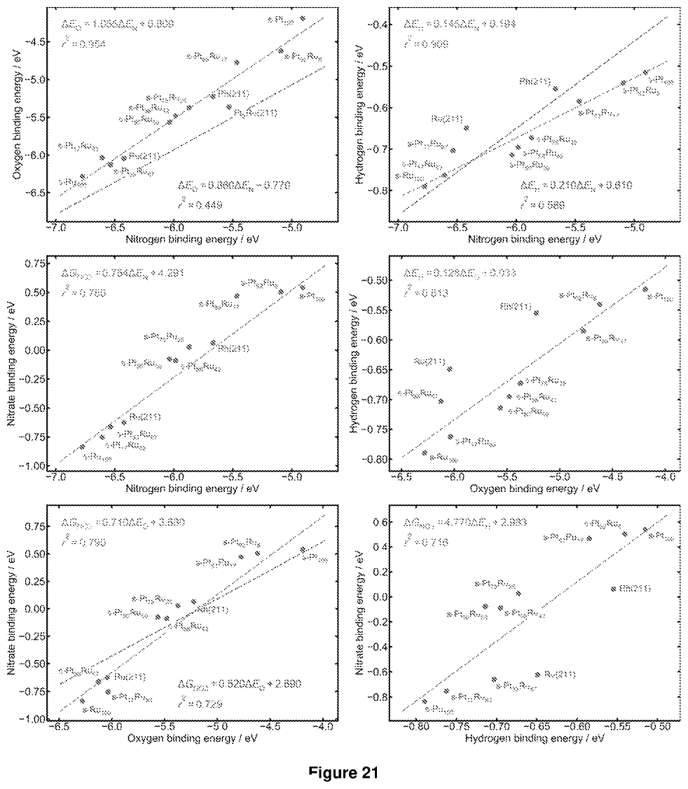

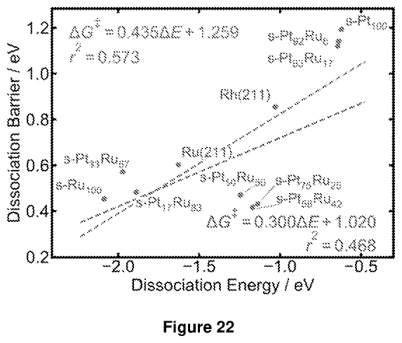

N and O binding energies were also shown to serve as NO₃RR activity descriptors on PtₓRu_{y} alloys because similar free energy scaling relations hold on the model PtₓRu_{y} surfaces. Examining the sites of strongest binding energy (FIG. 21), it was determined that PtₓRu_{y} alloys approximately followed the same (i) linear adsorbate scaling relations among O, N, NO₃, and H (FIG. 21) and (ii) Bronsted-Evans-Polanyi relations for nitrate-to-nitrite dissociation (FIG. 22) when compared to the pure-metal relations. The nitrate dissociation step (NO₃*+*⇄NO₂*+O*) was analyzed, as this step was hypothesized to be rate-determining for NO₃RR on pure transition metal surfaces under most conditions. Geometries and energetics for the initial state, transition state, and final state configurations for nitrate dissociation on each alloy are provided in FIG. 23. These findings suggested that the volcano plot derived for pure metals can be qualitatively used to rationalize the activity of PtₓRu_{y} alloys.

Linear adsorbate scaling relationships between adsorbates were predicted to exist on PtₓRu_{y} alloys. The data in FIG. 21 shows six linear adsorbate scaling relationships found between N, O, H⁺, and NO₃⁻ binding energies on PtₓRu_{y} random surface alloys. N and o binding energies correlate highly with each other, and each correlate well with NO₃⁻ binding energy. In general, N, O, and NO₃⁻ follow poorer scaling relationships with H⁺ than with each other, as shown previously. These linear scaling relations on PtₓRu_{y} were similar to those used to construct the volcano plot using pure metals.

Binding Energy Trends of O and N on PtₓRu_{y}

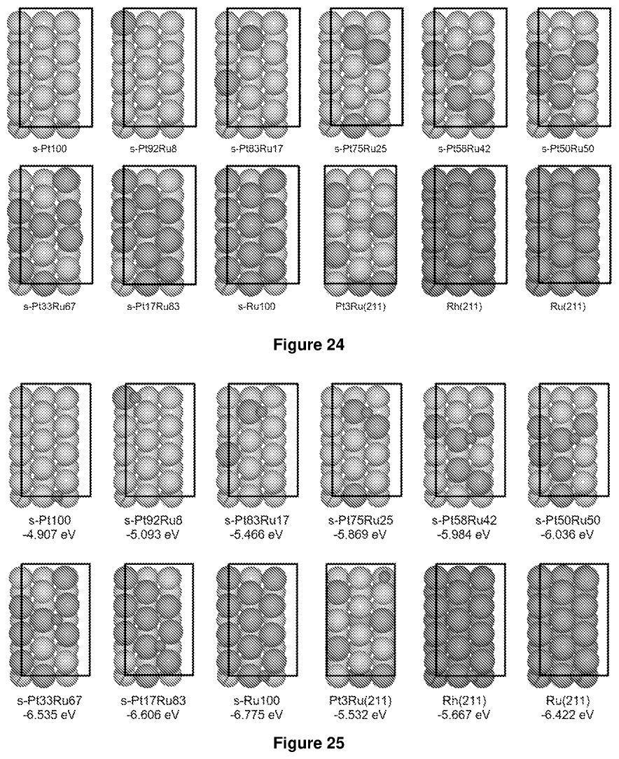

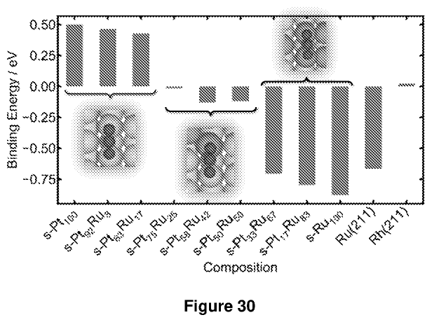

DFT modeling was used to examine how adsorption strength of O and N depends on PtₓRu_{y} surface alloy composition. The atomic distribution of Pt and Ru in each alloy's surface was generated using random assignment (FIG. 24). DFT-predicted adsorption geometries for N*, O*, H*, and NO₃* are shown in FIGS. 25-28. H⁺ and NO₃⁻ adsorption were also studied to show scaling relations between N and O. For each PtₓRu_{y} alloy (as well as Ru(211) and Rh(211)), binding energies were sampled on all unique atop sites for N, O, and H and for all unique third-ridge atop bidentate sites for NO₃⁻ (see FIG. 29 for the distributions of binding energies and FIG. 30 for nitrate binding configurations).

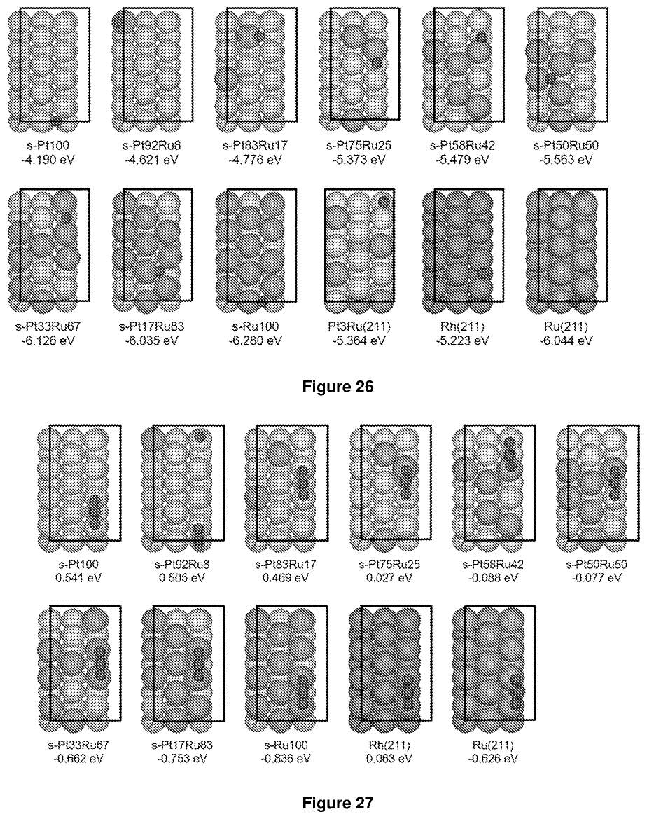

The N atom prefers to adsorb in hollow sites, but also in locations that maximize its coordination with surface Ru atoms (FIG. 25). N prefers a FCC or HCP hollow site between the middle and rightmost ridges of the FCC(211) surface, but will also adsorb strongly in a hollow site between the left and middle ridges if that is the only location where a Ru atom is available (e.g., see s-Pt₉₂Ru₈). Like N, the O atom prefers adsorption locations that maximize its coordination with surface Ru atoms (FIG. 26). Atomic O also prefers bridge and hollow sites on the rightmost ridge for many but not all surface compositions. However, O will also adsorb strongly in a hollow site if this site increases its coordination to Ru atoms.

NO₃⁻ adsorption free energies were predicted at 298.15 K using a thermodynamic cycle to avoid error in predicting ion energies using periodic DFT calculations. For NO₃ binding, only sites in which NO₃⁻ binds in an O,O-bidentate chelating fashion to two consecutive atoms on the same vertical FCC(211) ridge were considered. Such binding positions were tested only for the middle and rightmost ridges, as the binding on the leftmost (lowest) ridge was found to be unfavorable. For all surfaces, NO₃⁻ prefers to bind on the rightmost (highest) ridge and to as many Ru atoms on that ridge as possible at once (FIG. 27). For example, for s-Pt₇₅Ru₂₅, NO₃⁻ binds to a Pt—Ru pair of surface atoms even though a Pt—Pt pair of surface atoms is available. Similarly, for s-Pt₃₃Ru₆₇ and s-Pt₁₇Ru₈₃, NO₃⁻ binds to a Ru—Ru pair even though a Ru-Pt ensemble is available.

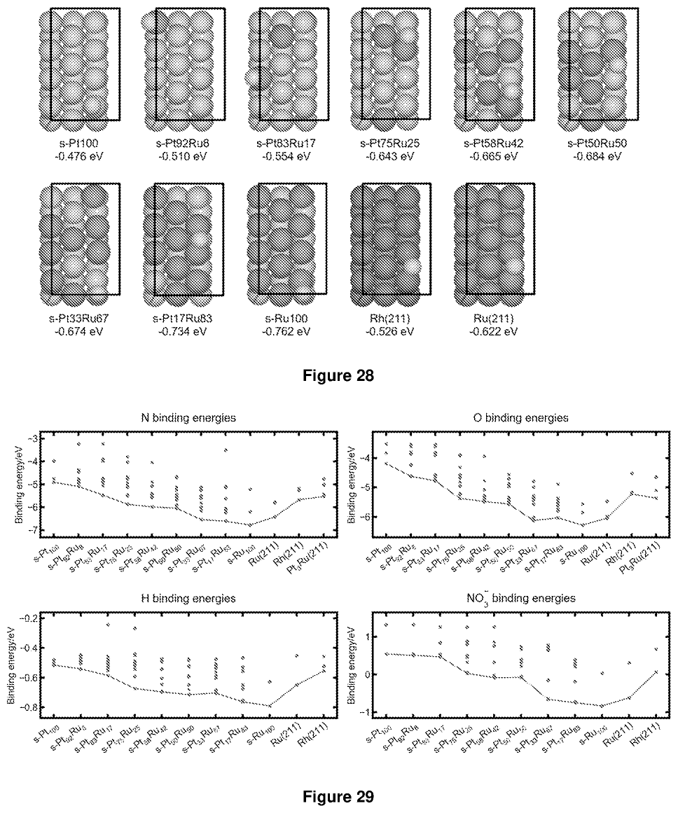

On pure Pt(211) facets (denoted as s-Pt₁₀₀), H prefers an atop site at the top ridge (FIG. 28Error!Reference source not found.). As Ru surface atoms become available, H prefers to adsorb at sites near the top ridge and which increase the coordination of H with Ru. For most sites, H adsorbs at a bridge position in the top ridge with at least one Ru atom in its first coordination sphere. For surfaces where Ru is available only in the bottom ridge (e.g., s-Pt₉₂Ru₈ and s-Pt₈₃Ru₁₇), H adsorbs at a position between the top ridge and the bottom ridge immediately next to it, such that it is as close to a Ru atom as possible.

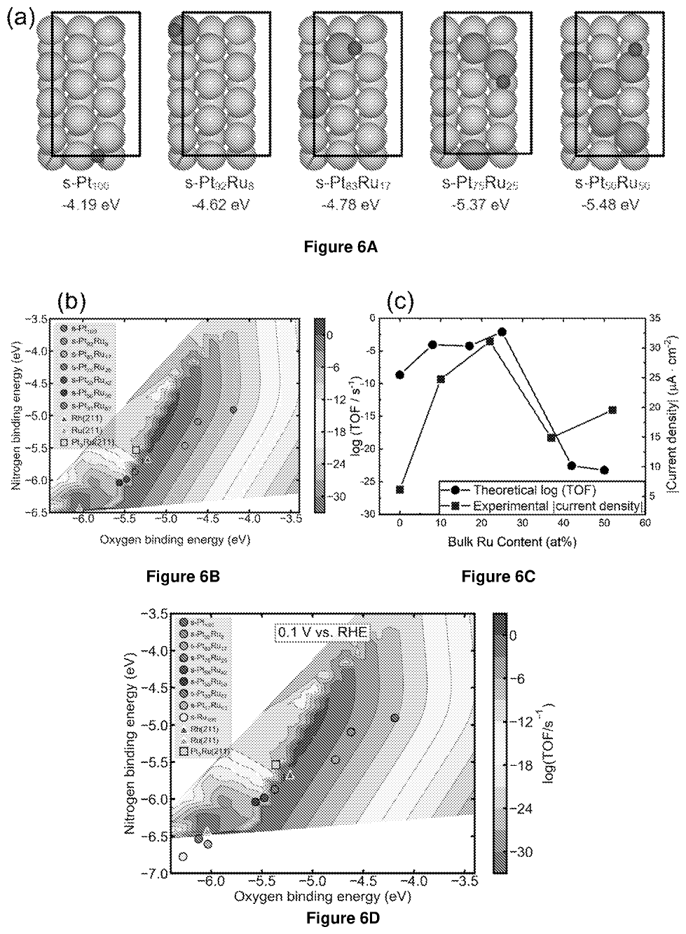

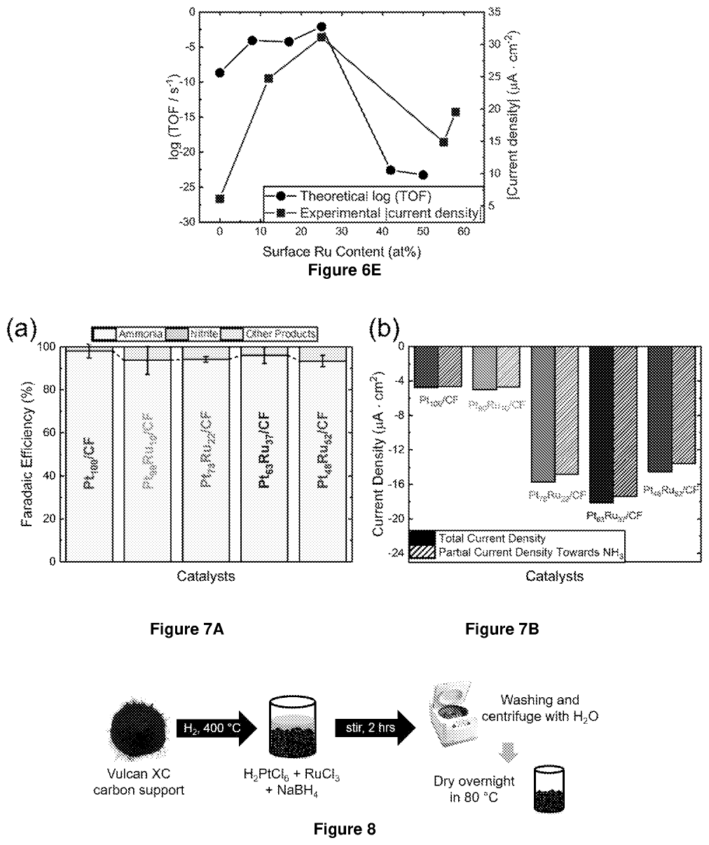

As the Ru content of the computational model alloy catalyst (denoted “s-PtₓRu_{y}”) increased, both N and O bind more strongly (FIG. 6A). For example, s-Pt₇₅Ru₂₅ binds N and O more strongly than Rh(211) by ˜0.15 and -0.20 eV, respectively. The effect of PtₓRu_{y} alloy composition on binding energies can be rationalized by the Nørskov-Hammer d-band model, which correlates an adsorbate's binding energy to the catalyst's d-band center. The d-band model predicted that a catalyst with higher d-band center energy relative to the Fermi level will result in adsorbate antibonding states that are also higher in energy, which increases the chemisorption binding energy. The d-band center of Ru is higher in energy than that of Pt. Consequently, alloying Pt with Ru was expected to increase the prevalence of sites that adsorb reactants and intermediates stronger than pure Pt. Ru(211) binds N and O more strongly than any of the PtₓRu_{y} alloys. The stronger adsorption on Ru(211) is consistent with its higher-energy d-band center.

In a related way, the O and N binding energies for PtₓRu_{y} alloys of intermediate compositions can also be rationalized by ensemble effects at the surface of each model slab. N, O, H, and NO₃⁻ usually prefer bridge binding positions between two atoms in the highest FCC(211) ridge or a hollow position inside three atoms on the catalyst surface (FIG. 25-28). The pair or trio of surface atoms locally bound to the adsorbate largely dictates the binding energy. For NO₃⁻, binding is weakest when bound to a Pt—Pt ensemble, significantly stronger for Pt—Ru ensembles, and strongest for Ru—Ru ensembles. As expected, binding energy varied more with the type of ensemble locally bound to NO₃⁻ than to nonlocal changes in surface composition (FIG. 30). The same trends hold for the other adsorbates. As the surface composition of Ru increases, the probability of finding a Pt—Ru, Ru—Ru, Pt—Ru—Ru, Ru—Ru—Ru, or other Ru-rich ensemble increases. Thus, PtₓRu_{y} alloys of intermediate macroscopic Ru compositions are likely to have many microscopic coordination environments that bind N and O with intermediate adsorption strengths. Based on the linear adsorbate and BEP relationships, it was predicted that these same surfaces will also bind NO₃⁻ and H⁺ with an intermediate strength that maximizes NO₃RR activity.

The data in FIG. 30 shows the strongest binding free energies for NO₃⁻ found on each PtₓRu_{y}(211) surface, as well as Rh(211) and Ru(211). For the PtₓRu_{y} alloys, the sites with strongest nitrate binding energies cluster into three groups based on how nitrate is bound: Group 1 containing s-Pt₁₀₀, s-Pt₉₂Ru₈, and s-Pt₈₃Ru₁₇ where nitrate binds to Pt—Pt sites; Group 2 containing s-Pt₇₅Ru₂₅, s-Pt₅₈Ru₄₂, and s-Pt₅₀Ru₅₀ where nitrate binds to Pt—Ru sites; and Group 3 containing s-Pt₃₃Ru₆₇, s-Pt₁₇Ru₈₃, and s-Ru₁₀₀ where nitrate binds to Ru-Ru sites. Although this grouping is artificial because in reality a distribution of Pt—Pt, Pt—Ru, and Ru—Ru sites are present on alloy surfaces, it displays the general trend that nitrate adsorption strength increases as the number of Ru atoms bound to nitrate increases. The Pt—Pt sites are most abundant at low Ru concentrations, whereas as Ru concentration increases the number of Ru-Pt and Ru—Ru sites on the surface is expected to increase. Thus, PtₓRu_{y} surfaces with more Ru should have stronger nitrate binding energies, on average.

Some of the model alloys (s-Pt₁₇Ru₈₃ and s-Ru₁₀₀) adsorb nitrate more strongly than Ru(211). Here, the Ru(211) surface was generated by optimizing the lattice constant of FCC Ru, whereas all the model alloys surfaces (including s-Pt₁₇Ru₈₃ and s-Ru₁₀₀) are FCC(211) surfaces constrained to the Pt lattice constant, which is slightly larger than that of Ru. Thus, the alloy surface atoms are under a slight biaxial tensile strain, which raises the average d-band center of the surface with respect to the Fermi level, increasing the overall adsorbate-surface bonding interaction. In reality an alloyed surface would have a different lattice constant between that of its constituent metals. Nonetheless, strain effects have a much smaller perturbation on the nitrate binding energy than change in adsorption site (i.e., from interacting directly with a Pt atom to a Ru atom) and the qualitative trends match with experiment.

Rationalizing Activity Trends with Alloy Composition by Microkinetic Modeling

The NO₃RR activity was rationalized as a function of surface composition (FIG. 6A) using a theoretical volcano plot at 0.1 V vs. RHE in FIG. 6B. The same figure is reproduced in FIG. 6D, but with additional surface alloys at higher Ru compositions shown. The calculated points for s-Ru₁₀₀, s-Pt₁₇Ru₈₃, and s-Pt₃₃Ru₆₇ fall outside the envelope for the volcano contours. This issue occurs because volcano contours are drawn only within the envelope of N and O binding energies for which adsorbate scaling and BEP relationships predict positive activation energies. The fact that some points fall outside of this envelope shows limitations of the adsorbate scaling and BEP relationships at very exothermic N and O binding energies. However, the trend shows that there is a certain level of Ru content in the surface that correlates to a high TOF, and levels of surface Ru that are too high or too low correspond to lower activities.

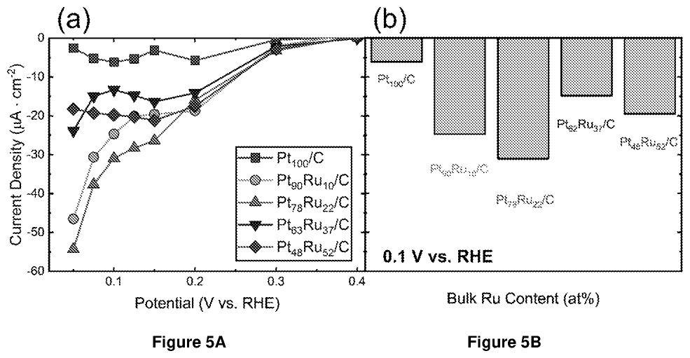

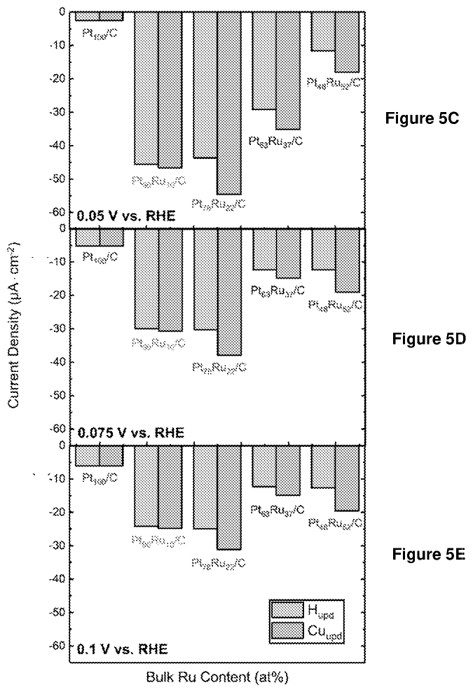

The contours in FIG. 6B indicate predicted catalyst turnover frequency (TOF) with respect to NO₃⁻ consumption as a function of N and O binding energy. Overlaid points indicate the O and N binding energies of the model catalysts considered. The points labeled “s-PtₓRu_{y}” represent the simulated random surface alloy model catalysts, and Rh(211), Ru(211), and Pt₃Ru(211) values are shown for comparison. The predictions in FIG. 6B suggested that NO₃RR activity should go through a maximum as Ru content is increased and the O and N adsorption strength is increased. s-Pt₁₀₀ corresponds to a relatively low turnover frequency (TOF), which initially increased as more Ru was added to the surface. The TOF reached a maximum for s-Pt₇₅Ru₂₅ and dropped as the Ru fraction increased further. The nitrate reduction current density on the synthesized PtₓRu_{y}/C alloys at 0.1 V vs. RHE increased with Ru content at low Ru compositions but decreased when more than 22 at % Ru is incorporated into the alloy. This trend also held at 0.075 and 0.05 V vs. RHE (FIGS. 5C-5D). The qualitative agreement of the computed TOF trend with the trend in steady-state current measurements (from FIG. 5B is shown in FIG. 6C.

The magnitude of the current density from FIG. 6B is replotted as a function of the surface Ru at % in FIG. 6E. Since the theoretical calculations only explored the change in surface composition of Pt and Ru, the experimental current densities from RDE measurements as a function of surface Ru at % aligned closer to the predicted TOFs. However, bulk Ru at % could be more accurately extracted from ICP-MS than surface Ru at % from XPS. Thus, the bulk at % was used as the naming convention and compositional structure of the alloys.

A volcano in activity with alloy composition occurred because alloying tunes the binding energies of reactants and key intermediates, and these binding energies are related to the barriers of individual elementary steps through free energy relations. The activity is maximized at some intermediate binding energy of O and N (FIG. 6B). This is an expression of the Sabatier principle, which posits that the most active PtₓRu_{y} alloy should adsorb NO₃⁻ and H⁺ neither too strongly nor too weakly. Regions of the volcano plot with lower TOFs usually imply that some elementary step in the reaction mechanism limits the total rate. Where the TOF is maximized (at the “peak” of the volcano), no single step limits the overall rate. The transition from one side of the volcano peak to the other often indicates where different elementary steps in the mechanism become rate-determining. For Pt, where nitrate binds weakly, the hypothesized rate-limiting step is nitrate dissociation (NO₃*+*→NO₂*+O*). Increasing the nitrate adsorption strength (described by the N and O binding energy) by alloying Pt with Ru increases the rate of overall reaction by increasing nitrate coverage and accelerating nitrate dissociation up to some maximum. I was expected that beyond the volcano peak, the adsorbed species start to bind too strongly, and another elementary step would become rate-determining. This new rate-determining step's rate would decrease as N and O adsorption strengths continue to increase. It is also possible that multiple steps have high degree of rate control as Ru content increases, including desorption or reaction of intermediates.

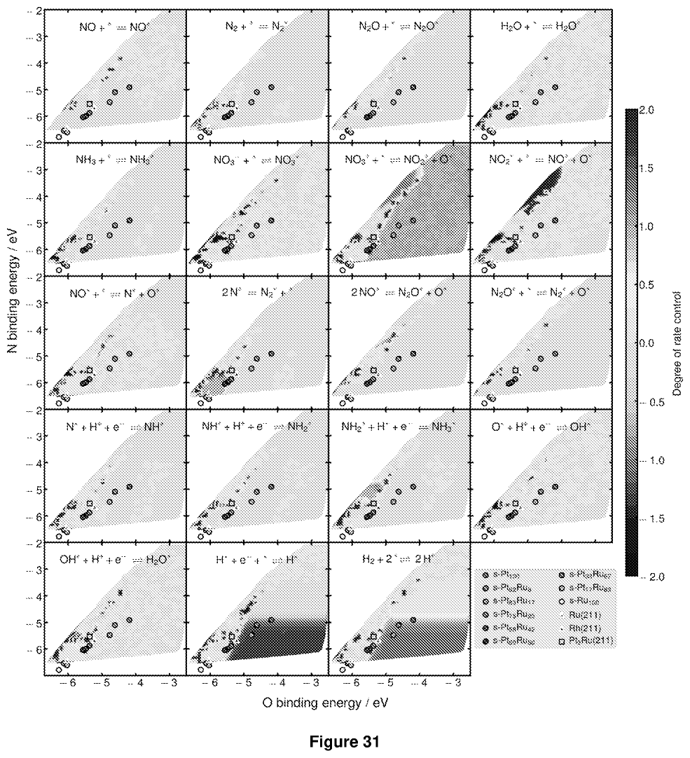

The degree to which any elementary step in the reaction mechanism determines the total activity can be estimated by computing the degree of rate control (DRC) for that reaction. DRC analysis in this work at 0.1 V vs. RHE predicted that for surfaces with low Ru content, nitrate dissociation is rate-limiting (DRC≈1), and increasing the adsorption strength of nitrate increases the rate (FIG. 31). But at higher Ru content, when the O and N (and consequently nitrate) binding energies are strong, the nitrate dissociation step was sufficiently fast, and increasing the rate of that elementary step no longer increased the overall rate. For Ru content greater than 25 at %, the DRC analysis predicted that the association of surface-bound N* (2 N*⇄N*) becomes the new rate-determining step (FIG. 31). Under these conditions, further strengthening the nitrate binding energy (as described by N and O binding energies) reduced activity.

In particular, FIG. 31 suggests that nitrate dissociation tends to dominate the overall reaction rate when O and N binding energies are both more positive than −4.5 eV. When O and N binding energies are both very negative, interconversion of N₂* and N* are predicted to control the overall rate. In another region, with very strong 0 binding energy but moderate N binding energy, NH₂* hydrogenation is predicted to control the overall rate. Although only the modeled bulk Pt₃Ru(211) alloy falls close to the boundary of this region, this step being rate-determining is more consistent with the ammonia production observed experimentally at higher Ru alloy content. At regions of very negative N binding energy and moderate or more positive 0 binding energy, the adsorption and desorption of aqueous H⁺ and gaseous H₂ dominate the rate. There also is a region in which NO₂* dissociation strongly controls the overall rate along the upper left edge of the contour envelope (high N binding energies at moderate 0 binding energies), but no modeled catalyst falls within this region.

Experiments show that maximum NO₃RR current density was achieved at 0.1 V vs. RHE when using a Pt₅Ru₂₅/C catalyst. For the five regions mentioned above in which a single elementary step controls the overall reaction rate, the s-Pt₇₅Ru₂₅ point lies at or very close to the boundary of each region. DRC analysis also predicts that none of the other elementary steps becomes rate-limiting at the N and O binding energies of s-Pt₇₅Ru₂₅. These results suggest that s-Pt₇₅Ru₂₅ exhibits near-optimal N and O binding energies for which no single elementary step in the mechanism is rate-limiting. Under these conditions, one would expect the overall reaction rate to reach a local maximum, which rationalizes the observation that Pt₂₅Ru₂₅/C produces the highest NO₃RR current density of all the PtₓRu_{y} catalysts.

Although the computational results predicted that N₂ is the dominant species forming at high Ru contents and strong O and N adsorption, experimental selectivity results showed that NH₃ is the dominant product for all the alloy catalysts tested. Therefore, it is unlikely that the new rate-determining step is the association of nitrogen, but rather another step on the ammonia production reaction pathway. It was observed that NH₂*+H⁺+e⁻⇄NH₃* was also rate-determining for surfaces with similar adsorption energies to s-Pt₇₅Ru₂₅ (, which is in line with the experimental observations and previous reports of this step being rate controlling for CuNi alloys. Without intending to be bound by theory, it is believed that this DRC discrepancy is attributable to uncertainties in the linear scaling relationships for alloys and to the fact that activity trends are easier to predict with microkinetic modeling compared to selectivity trends. Nevertheless, the switch from one rate-limiting step to another at the binding energies of s-Pt₇₅Ru₂₅ rationalizes the experimentally observed local maximum in activity at that composition.

Thermocatalytic Nitrate Reduction (TNO₃RR) and Electrocatalytic Nitrate Reduction (ENO₃RR)

FIG. 1B gives a comparative overview of the simplified reaction mechanisms for TNO₃RR¹⁰ and ENO₃RR.²² The rate-determining step (RDS) for both TNO₃RR and ENO₃RR is often the reduction of nitrate to nitrite. Additionally, under judicious control of the operating conditions and catalyst, both reactions produce N₂ and NH₃ as the major products and nitrogen oxide compounds as less abundant products.

Pt/C, PtRu/C, and Pt₂₅Ru₂₅/C for TNO₃RR and ENO₃RR under various operating conditions (i.e., pH, hydrogen partial pressure, nitrate concentration, applied potential) were analyzed to compare thermocatalytic and electrocatalytic approaches for nitrate reduction. It was observed that that increasing the hydrogen (electro)chemical potential (0.1 to 1 atm H₂ and 0.15 to 005 V vs. RHE) increases the rate of nitrate conversion and that the ranking of catalyst activity is the same for ENO₃RR and TNO₃RR, that is, Pt/C<<PtRu/C<Pt₇₈Ru₂₅/C. This change in activity from increasing Ru content in the alloy is believed to be attributed to increasing the adsorption strength of nitrate, hydrogen, and intermediates. Similarly, increasing the nitrate concentration increased reaction rates in ENO₃RR and TNO₃RR for PtRu/C. However, at concentrations above 0.5 M NO⁻, ENO₃RR activity decreased due to surface poisoning by nitrate. Unlike hydrogen driving force and nitrate concentration, which similarly affect catalyst activity, the effect of the pH and the apparent activation energies were different for ENO₃RR and TNO₃RR on the PtRu/C catalyst. This finding implies that pH has a more complex role in the nitrate reduction mechanism than previously developed microkinetic models based on Langmuir-Hinshelwood surface reactions might suggest, and that there are fundamental differences between the two reactions. Despite these differences, certain catalyst properties (such as stronger nitrate adsorption) or reaction conditions (more available adsorbed hydrogen) increase the TNO₃RR and ENO₃RR rates in a way that is qualitatively captured by the existing theoretical volcano plot. TNO₃RR and ENO₃RR performance were compared on PtRu/C to rates and operating costs for industrial ammonia synthesis to evaluate the feasibility of both systems. It has been shown that TNO₃RR on PtRu/C at pH 1 produces NH₃ at comparable rates to the Haber-Bosch process and, depending on the regional cost of H₂, can have lower operational costs than the USDA standard cost per tonne of NH₄NO₃.

### EXAMPLES

### Example 1: Catalyst Preparation

Referring to FIG. 8 catalyst in accordance with the disclosure was prepared using NaBH₄ reduction synthesis. A suspension of 25 mg of carbon black (Vulcan XC 72; Fuel Cell Store) was pretreated in H₂ at 400° C. for 2 hrs to remove impurities from the surface. After, the support was suspended in 15 mL of Millipore water (18.2 MΩcm, Millipore MilliQ system) and sonicated for 15 min. Measured concentrations of RuCl₃ (38% Ru; Alfa Aesar) and H₂PtCl₆ (38-40% Pt; Sigma Aldrich) in Millipore water were added to the solution and stirred. After, 40 mg of NaBH₄ (Sigma Aldrich) dissolved in 25 mL of Millipore water was introduced. This solution was stirred for 2 hrs before being centrifuged 3 times at 3000 rpm for 8 min and washed with Millipore water. The recovered solid was dried overnight in an oven at 80° C. in ambient air.

The final Pt and Ru loadings were determined by using a PerkinElmer NexION 2000 ICP-MS after digesting 1 mg of the catalyst in aqua regia (3:1 molar HCl:HNO₃). The sample solutions were co-fed along with a 20-ppb bismuth internal standard. X-ray diffraction (XRD) analysis indicated the presence of a separate Ru hexagonal phase instead of the bimetallic phase for Ru compositions above 60 at %. Therefore, PtₓRu_{y} alloys in the catalysts herein were limited to bulk Ru concentrations of 0-52 at %.

Commercial 30 wt % Pt/C, 30 wt % Pt₅₀Ru₅₀/C, and 20 wt % Rh/C were also purchased from Fuel Cell Store for comparison.

### Material Characterization:

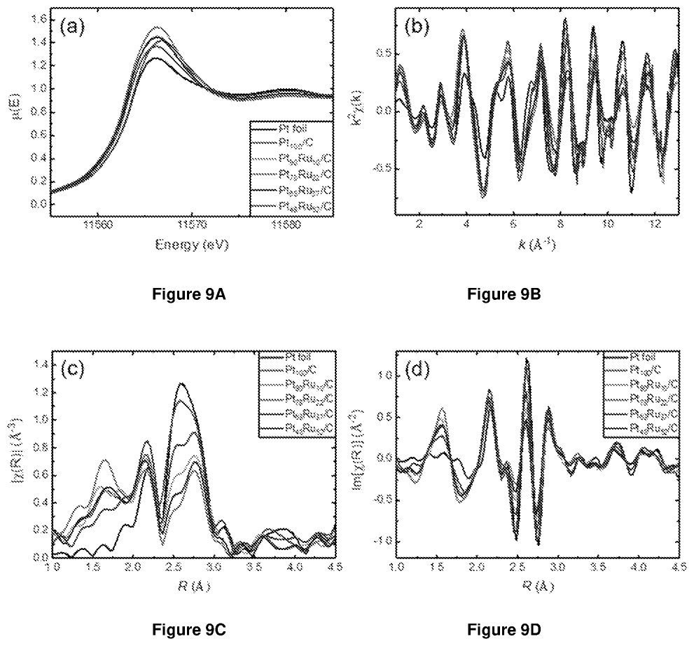

X-ray absorption near edge structure (XANES) and extended X-ray absorption fine structure (EXAFS) measurements were taken at the Sector 20 bending-magnet beamline of the Advanced Photon Source at Argonne National Laboratory. Catalyst samples were loaded into 1.5 mm glass capillaries for measurement in transmission mode at the Pt L₃-edge. To take the spectra at the Ru K-edge, the catalyst samples were also measured in the glass capillaries using transmission mode, except for the lowest Ru weight loading sample, for which the sample was filled into a Kapton tube to allow a longer path distance to increase the signal to noise ratio. All measurements were taken of samples exposed to air (ex-situ). For the Ru K-edge the harmonic rejection mirror was set to 3.9 mrad, whereas for Pt L₃-edge it was 4.1 mrad. Catalyst samples were measured in transmission mode at the Pt L₃-edge and Ru K-edge. The p(E) data was processed using the ATHENA software with a Fourier cutoff of R_{bkg}=1.0 Å and a k range from 3 to 16 Å⁻¹. Structural parameters were derived from the experimental data using FEFF9 theoretical standards as input to the ARTEMIS software. Two 14-min scans were taken for each sample at each edge and co-added to generate the spectrum. Pt and Ru reference foils were located downstream and taken concurrently with the sample for energy calibration and to verify monochromator stability. The data was processed using ATHENA software with a Fourier cutoff of R_{bkg}=1.0 Å and a k range of 3 to 16 Å⁻¹. Structural parameters were derived from the experimental data by fitting using FEFF9 theoretical standards as inputs to the ARTEMIS software package. Fits included first Pt—Pt or Pt—Ru and Pt-O paths including the 3^{rd} cumulant to account for asymmetry. The spectra were obtained by merging two scans of each catalyst. The raw data obtained at the Pt L₃-edge is presented in FIG. 9. Because the raw signal of the bulk Pt foil was much higher, the actual values have been scaled by a factor of 0.5 in the R and k space to aid visual comparison. Based on the XANES spectra at the Pt L₃-edge in FIG. 9A, the white line intensity for the PtₓRu_{y}/C catalysts compared to the bulk metallic Pt foil show that these samples were slightly oxidized. These surface oxides were expected and were reduced under electrochemical pretreatment conditions prior to catalyst use.

ICP-MS measurements determined the bulk weight and atomic loading of Pt and Ru in the alloys. The data in Table 3 shows that a smaller wt % (weight %) of Ru than intended was incorporated into the catalyst. The deviations between the target and actual composition are likely due to the precision of the weighing scale and different reactivities of the two types of precursors upon reduction with NaBH₄. The ICP-MS measured actual atomic percentage of Ru (with the balance Pt) were for the naming convention of the catalysts. In Table 3, atomic and weight percent loading of Ru in PtₓRu_{y}/C (x=48-100%) catalysts from ICP-MS. Target Ru wt % reflected the calculated amount of RuCl₃ precursor added during synthesis. All values were with respect to the total metal loading, not including carbon, such that the balance is Pt. The total target metal loading on carbon was 30 wt %.

TABLE 3

| Catalysts | Target Ru wt % | Actual Ru wt % | Actual Ru at % |
|---|---|---|---|
| Pt₁₀₀/C | 0 | 0 | 0 |
| Pt₉₀Ru₁₀/C | 12.5 | 6 | 10 |
| Pt₇₈Ru₂₂/C | 25 | 13 | 22 |
| Pt₆₃Ru₃₇/C | 37.5 | 23 | 37 |
| Pt₄₈Ru₅₂/C | 50 | 36 | 52 |

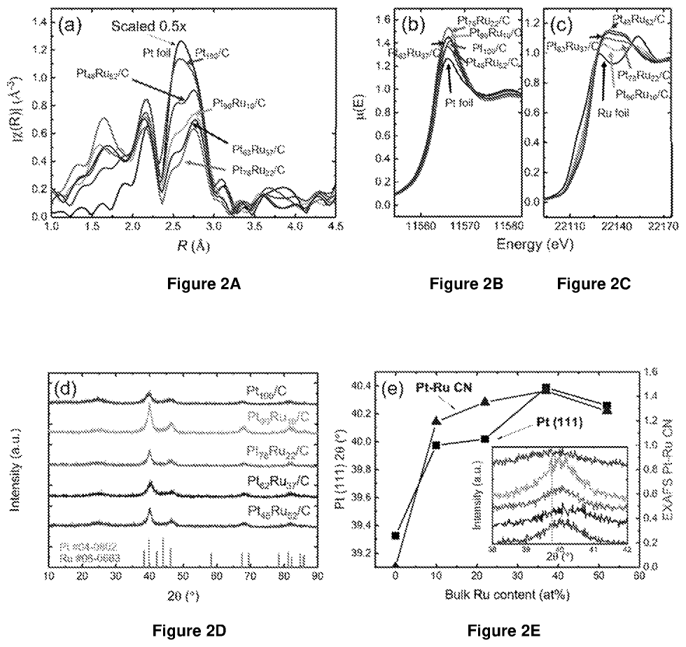

To confirm that PtₓRu_{y}/C alloys are synthesized, ex-situ EXAFS was employed to measure the local coordination of Pt and Ru atoms. The EXAFS spectra of the Pt L₃-edge for PtₓRu_{y}/C in real space are shown in FIG. 2A, and the corresponding Pt L₃-edge EXAFS in k-space and the imaginary components are shown in FIG. 9. Both the Pt foil and Pt₁₀₀/C showed a single peak between 2.5-3.0 Å (FIG. 2A), which can be attributed to first shell Pt—Pt scattering. The Pt foil was scaled by a factor of 0.5 to aid visual comparison to the spectra of the nanoparticle catalysts, where the Pt—Pt coordination numbers and thus EXAFS amplitudes were smaller. The larger peak amplitude at lower R for the Pt₁₀₀/C compared to Pt foil is attributed to Pt—O scattering. The inclusion of Ru during the catalyst synthesis caused a second peak to manifest between 2.5-3.0 Å, which corresponded to Pt—Ru scattering paths.

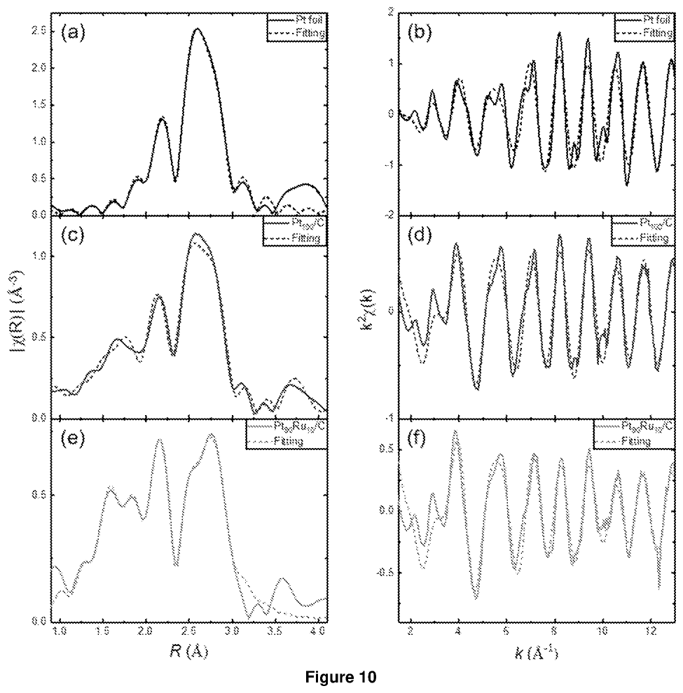

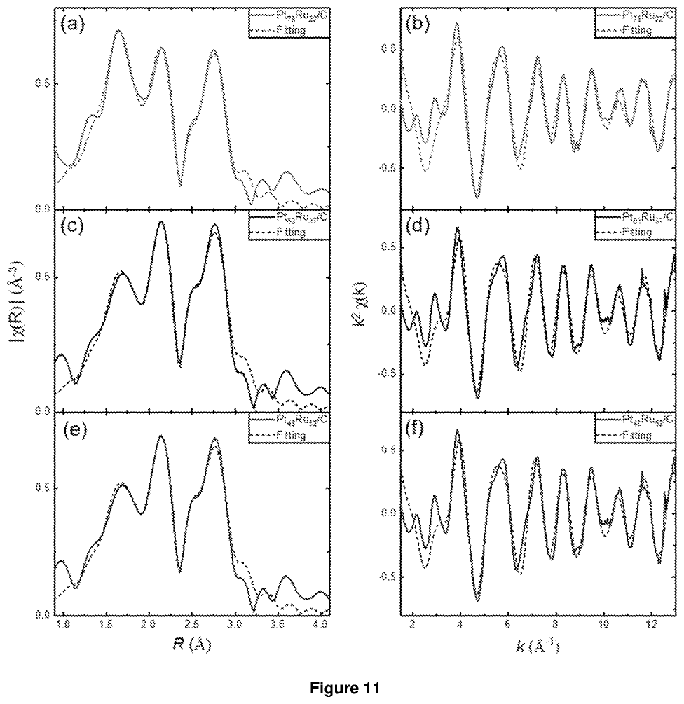

The measured spectra and fittings for the Pt foil and each of the five compositions of the PtₓRu_{y}/C are shown in FIGS. 10 and 11. First, the edge onset energy (E₀) was defined for the Pt foil and set accordingly for spectra of all alloys. Next, the background signal for the data was removed by fitting the pre-edge and post-edge data to a linear function and subtracting out. After processing the data, fitting paths were generated using FEFF9 software and structure coordinates from Materials Project. For improved convergence and optimization tests in FEFF9, the COREHOLE card was varied during XANES calculations. The default setting was based off the Final State Rule (FSR), which may over overestimate the strength of the core-hole interaction and exclude the core-hole mixing effect for L-shell metals. To overcome this problem, the random phase approximation (RPA) was used in the XANES calculations of the Pt—Pt, Pt—O, and Pt—Ru paths. The use of RPA over FSR improved the fit in the first shell and X error.

By fitting the EXAFS data using Pt—Pt, Pt—O, and Pt—Ru paths (FIGS. 10 and 11), the Pt—Pt and Pt—Ru coordination numbers and bond distances were extracted. EXAFS fittings were conducted with Pt—Pt, Pt—O, and Pt—Ru paths generated in FEFF9. First, the Pt foil was fitted by setting the coordination number to 12, which was the expected value of bulk Pt. The set amplitude and E₀ were found to be 0.915±0.02 and 5.55±0.2 eV, respectively. Tabulated fittings and errors for the bond distance, coordination number, and σ² values are presented in Table 4. For comparison, Pt₁₀₀/C was fitted with and without the Pt—Ru path. Although the coordination number of the Pt—Ru path on Pt₁₀₀/C was ˜0.5, it increased the X error compared to fitting Pt₁₀₀/C without the Pt—Ru path. When fitting the Pt foil, the Pt coordination number was set to 12 (bolded) to obtain the set amplitude and E₀ values that were used in the PtₓRu_{y}/C fittings. The results of the fittings and errors for R, CN, and σ² are given in Table 4. The 3^{rd} cumulant had no effect on the fit, and thus the results are not reported in the table.

TABLE 4
Tabulated fitting results for Pt foil and PtₓRu_{y}/C catalysts.

| | Material | Pt foil | Pt₁₀₀/C | Pt₉₀ Ru₁₀/C | Pt₇₈Ru₂₂/C | Pt₆₃Ru₃₇/C | Pt₄₈Ru₅₂/C |
|---|---|---|---|---|---|---|---|
| Pt-Pt | R (Å) | 2.756 ± 0.01 | 2.743 ± 0.03 | 2.740 ± 0.03 | 2.735 ± 0.04 | 2.738 ± 0.04 | 2.745 ± 0.03 |
| Path | CN | 12 | 7.5 ± 0.5 | 5.8 ± 0.6 | 4.4 ± 0.6 | 5.6 ± 0.1 | 7.3 ± 0.6 |
| | σ² (Å²) | 0.005 ± 0.0001 | 0.006 ± 0.0004 | 0.007 ± 0.0007 | 0.006 ± 0.0010 | 0.007 ± 0.0007 | 0.006 ± 0.0006 |
| Pt-O | R (Å) | | 1.995 ± 0.04 | 1.995 ± 0.03 | 1.992 ± 0.05 | 1.987 ± 0.05 | 1.983 ± 0.05 |
| Path | CN | | 1.28 ± 0.18 | 1.34 ± 0.20 | 1.77 ± 0.21 | 1.22 ± 0.18 | 0.79 ± 0.19 |
| | σ² (Å²) | | 0.006 ± 0.0026 | 0.005 ± 0.0026 | 0.004 ± 0.0020 | 0.004 ± 0.0024 | 0.005 ± 0.0043 |
| Pt-Ru | R (Å) | | | 2.792 ± 0.03 | 2.785 ± 0.03 | 2.776 ± 0.02 | 2.758 ± 0.00 |
| Path | CN | | | 1.19 ± 0.51 | 1.35 ± 0.55 | 1.44 ± 0.44 | 1.28 ± 0.42 |
| | σ² (Å²) | | | 0.009 ± 0.0038 | 0.008 ± 0.0034 | 0.008 ± 0.0025 | 0.007 ± 0.0028 |

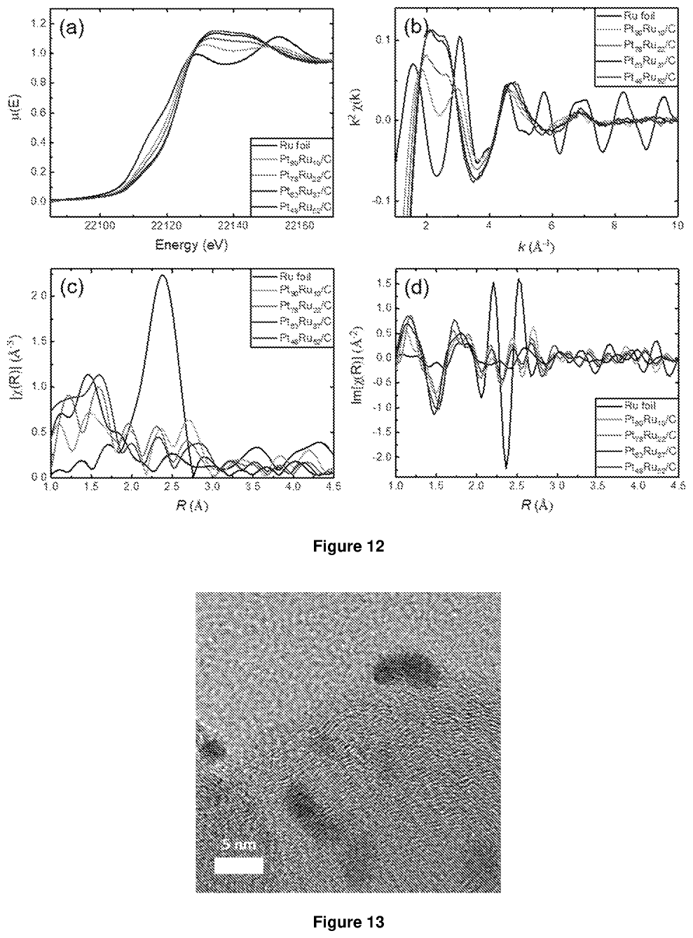

The presence of Pt—Ru first-shell coordination by EXAFS indicates these materials are alloys, rather than separate phases of Pt and Ru. Because there was less Ru than Pt in the alloys, the Ru K-edge EXAFS data had low signal and was too noisy to accurately fit (FIG. 12). The data in FIGS. 2B and 2C show the XANES of Pt L₃- and Ru K-edges for the catalyst samples, respectively. The increase in the white line intensity for the PtₓRu_{y}/C samples compared to bulk metallic Pt and Ru foils reveal that these samples were slightly oxidized ex-situ. This slight oxidation was expected for small metal nanoparticles and typically is attributed to surface oxides that will be reduced electrochemically during pretreatment prior to reaction. The oxidized nature of the PtₓRu_{y}/C samples from XANES is consistent with the observation of Pt—O scattering from EXAFS in FIG. 2A

The XRD patterns for different compositions of the PtₓRu_{y}/C displayed a shift in the Pt(111) diffraction patterns to higher 29 as the Ru at % increased (FIG. 2D). The shift indicates a change in lattice constants that corresponds to alloying Ru atoms into the Pt lattice, as expected from Vegard's Law (FIG. 2E). At higher atomic Ru content (>50 at %), there was a deviation from the linear shift predicted by Vegard's Law, possibly because of a limit to the amount of Ru that can be incorporated into Pt without phase segregation. The Pt-Ru coordination number determined from EXAFS and the diffraction location from XRD are correlated, FIG. 2E. The EXAFS and XRD distances were not directly compared because the EXAFS gave Pt—Pt and Pt—Ru bond distances from fitting and XRD gave an averaged shift of the metal lattice constant. Taken together, the Pt—Ru coordination from EXAFS and the lattice shift from XRD support the formation of different compositions of PtₓRu_{y}/C alloys. The broadening of the four main Pt diffraction peaks between 30-90 2θ° in the XRD was also used to calculate the diameters (3-6 nm from the Scherrer equation) of the nanoparticles (Table 5). These particle sizes are consistent with the expected particle sizes from the combined coordination number of Pt—Pt and Pt—Ru from EXAFS.

XRD analysis was conducted using a Rigaku Miniflex XRD with Cu Kα radiation and a Ni filter (λ=1.5418 Å). The 26 range (10°<2θ<90°) was scanned at a rate of 5°/min with a 0.02° step size. Crystallite sizes were estimated using the Scherrer equation. The average size of the synthesized nanoparticles was calculated using Scherrer's equation:

$$τ = \frac{K λ}{β cos θ}$$

where τ is the average size of the crystalline particles, K is the shape factor (0.89), λ is the wavelength of the X-ray (1.54056 Å), β is the full width of the peak at half maximum, and e is the Bragg angle of the peak. Error bars were determined by using the standard deviation across four different Pt diffraction peaks. The average particle sizes from XRD were compared with the average particle sizes measured from TEM images (Table 5). The particle sizes from both characterization techniques agreed within error for all studied catalysts.

The total coordination number (CN) from the Pt—Pt and Pt—Ru paths ranged from 6-9 for all the samples. From established relationships between metal nanoparticle size and first shell CN, these values correspond to nanoparticles between 1.5-5 nm, which is within the range of XRD calculations and TEM imaging (Table 5Error!Reference source not found.). Nanoparticle sizes estimated from CN were lower than sizes extracted from TEM images, which may arise because the CN from EXAFS fittings estimates of size exclude the oxide layer around each nanoparticle, as only the metal-metal bonds of the metallic core were counted.

The raw data obtained at the Ru K-edge is presented in FIG. 12A. Because the raw signal of the Ru foil was much higher than that of the alloy catalysts, the values have been scaled by a factor of 0.5 in the R-space to aid visual comparison. The spectral measurements taken at the Ru K-edge have low signal, thus Ru—Ru and Ru-O information was not extracted from ARTEMIS. Based on the XANES spectra at the Ru K-edge in FIG. 12A, the white line intensity of the PtₓRu_{y}/C catalysts suggests oxidation compared with the bulk Ru foil. These surface oxides were expected for metallic nanoparticles because the experiment was conducted ex-situ. The amount of oxidation increased as the bulk Ru alloy content increased, which was attributed to Ru being more easily oxidized than Pt.

TABLE 5
Particle sizes from XRD using Scherrer equation, TEM, and
EXAFS from first shell Pt-metal coordination number.

| | XRD particle | TEM particle | EXAFS particle |
|---|---|---|---|
| Catalyst | size (nm) | size (nm) | size (nm) |
| Pt₁₀₀/C | 3.5 ± 0.6 | — | 1.5-5.0 for all catalysts |
| Pt₉₀Ru₁₀/C | 5.0 ± 1.0 | 4.3 ± 1.4 | |
| Pt₇₈Ru₂₂/C | 5.7 ± 1.0 | 4.0 ± 1.1 | |
| Pt₆₂Ru₃₇/C | 3.2 ± 0.7 | 3.9 ± 1.0 | |
| Pt₄₈Ru₅₂/C | 4.7 ± 1.3 | 3.6 ± 0.9 | |

Pt and Ru peaks were referenced to #04-0802 and #06-0663, respectively.

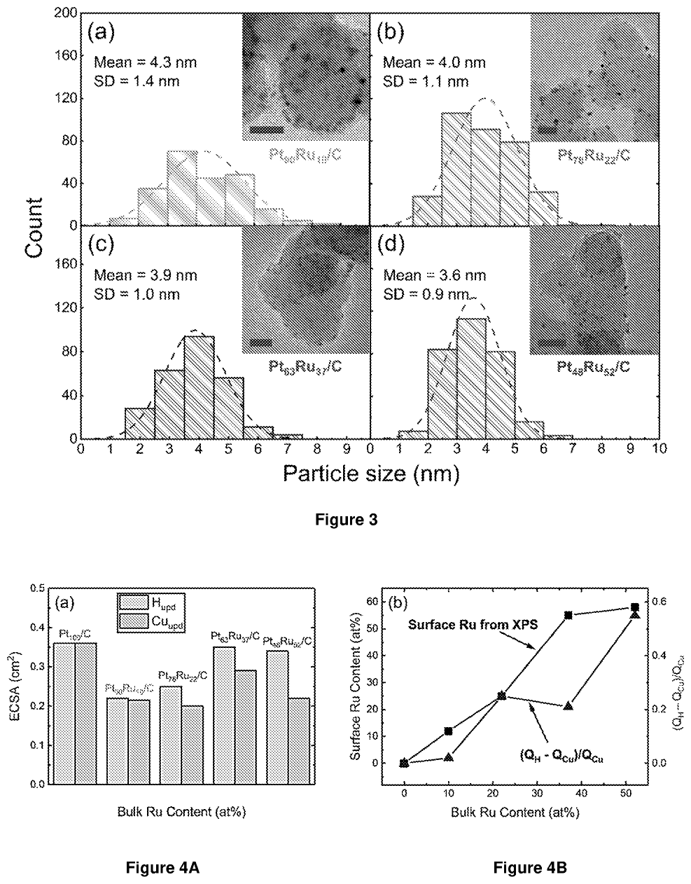

Transmission electron microscopy (TEM) was performed on a JEOL 201OF electron microscope operating with 200 kV accelerating voltage. The samples were made by adding 1 mg of catalyst into isopropanol. One drop of this suspension was deposited on a gold grid. The isopropanol was dried before imaging of the sample. The TEM images in FIG. 3 revealed that the synthesis resulted in PtₓRu_{y} nanoparticles on the Vulcan carbon support that range from 3-5 nm in size, which agreed with XRD calculations and EXAFS analysis (Table 5). Under 1.5 M magnification, the crystal lattice of the nanoparticles was observed (FIG. 13). The amorphous gray shape in the lower half of FIG. 13 is the carbon support and the lighter gray top half is the Cu grid used for the microscopy experiment. The black spheres and ovals are the alloy nanoparticles, which had a diameter ranging from 3-5 nm. Alloying with Ru could change the fractional exposure between different PtₓRu_{y} catalysts. Thus, measuring the ECSA and surface composition was important to obtain area-normalized intrinsic activities for the alloy.

X-ray photoelectron spectroscopy (XPS) was conducted using a Kratos Axis Ultra X-ray photoelectron spectrometer. While keeping the analysis chamber at 1×10⁻⁹ Torr, a monochromatic Al X-ray source (10 mA and 12 kV) was used with a pass energy of 12 eV and step size of 1 eV. Collected spectra were calibrated by positioning the C(1s) peak at 248.8 eV. The resulting Pt 4d and Ru 3p peaks were fitted with the Shirley-type background with the CasaXPS software.

### Example 2—Rotating Disk Electrode Preparation

The catalyst ink was prepared by adding 3 mg of the supported catalyst in 5 mL of water and isopropanol (1:1 molar ratio). 17.5 μL of Nafion (5% in 95% isopropanol, Sigma Aldrich) was added to the solution to act as a binder and sonicated for at least 120 min. A glassy carbon rotating disk electrode (5 mm in diameter) was polished with 0.05 μm alumina suspensions before sonication in Millipore water to remove trace surface contaminants. The catalyst ink was sonicated for at least 30 min before depositing 8 μL of the ink onto the surface of the clean glassy carbon electrode. The deposition was kept in closed containment as the ink dried and repeated once more. The total loading was 9.6 pg of catalyst, including carbon.

The prepared electrodes were placed into the electrolyte solution and cycled from hydrogen evolution to Pt oxidation potentials (−0.17 to 1.23 V vs. RHE) at least 50 times at 100 mV s⁻¹ before conducting electrochemical measurements. ICP-MS experiments of the solution before and after the electrocatalyst pretreatment process for a commercial PtRu/C showed ˜8% of Pt and Ru in the electrolyte solution. It is believed that presence of Pt and Ru in the electrolyte solution was attributable to catalyst powder that was not adequately bound to the surface of the glassy carbon. Following this pretreatment, stable CVs for all reported PtₓRu_{y}/C was obtained, implying no further loss of catalyst.

### Example 3—Electrochemical Measurements

The electrochemical experiments were conducted in either a single compartment, three-electrode glass electrochemical cell (for steady-state activity measurements) or a two-compartment, three-electrode cell (to enable product quantification for selectivity measurements) using a VSP potentiostat (Bio-Logic Science Inst.). All measurements were taken at room temperature (23.3° C.). A graphite rod (AGKSP grade, ultra “F” purity, Alfa Aesar) and Ag/AgCl (4 M KCl, Pine Research Inst., Inc.) were used as the counter and the reference electrode, respectively. Before electrochemical experiments, the Ag/AgCl reference electrode was calibrated against a Pt wire with 1 bar H₂ in the electrolyte solution. All reported potentials were referenced to RHE. The sulfuric acid electrolyte was prepared by adding concentrated H₂SO₄ (99.999%, Sigma Aldrich) to Millipore water. Before electrochemical measurements, N₂ gas (Ultra-high purity grade, 99.999%, Cryogenic Gases) was sparged through the electrolyte for at least 45 min to remove dissolved O₂ from the solution. Throughout the experiment, N₂ also blanketed the electrolyte solution to prevent O₂ from reaching the electrolyte.

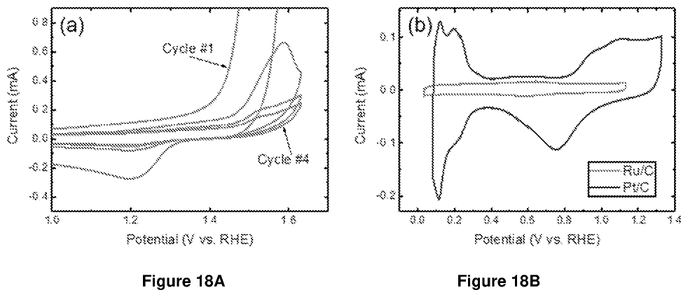

The data in FIG. 5A shows the steady-state nitrate reduction current densities normalized to the ECSA from Cu_{upd} for five different compositions of PtₓRu_{y}/C catalysts at 0.05 to 0.4 V vs. RHE in 1 M H₂SO₄+1 M NaNO₃. There was no observable reduction current at the potentials specified in FIG. 5A in the absence of nitrate. Therefore, the current density reported was attributed solely to nitrate reduction. Pt₁₀₀/C and Pt₄₈Ru₅₂/C were compared to commercial catalysts of the same composition (FIG. 17) to confirm that the synthesized materials have similar intrinsic activities as their commercial counterparts when the rates were normalized to the number of available surface sites.

The intrinsic activities of commercial Pt/C and PtRu/C were comparable to those of the synthesized Pt₁₀₀/C and Pt₄₈Ru₅₂/C samples, respectively (FIG. 17). These experiments show that catalysts synthesized under different conditions yielded similar intrinsic activities and that the method of normalization accounted for different size particles that resulted from different batches of catalyst. For comparison between catalysts of similar compositions, using either H_{upd} or Cu_{upd} for site normalization would yield similar comparative results between the commercial and synthesized catalyst. This is because the ratio to convert H_{upd} to Cu_{upd} active sites are approximately the same. In FIG. 17, the commercial catalysts had higher ECSA despite having the same bulk metal loading wt % as the synthesized material, which likely results from higher dispersion and lower particle size. However, normalization using H_{upd} accounts for these differences, thus yielding similar intrinsic normalized current densities between commercial and synthesized catalysts. These commercial catalysts were not explicitly used in the kinetic studies to avoid comparison between catalysts of significantly different particle sizes, due to the reported structure sensitivity of nitrate reduction.

The steady-state current densities for Pt₁₀₀/C were comparable with other Pt/C reports and reach a maximum activity at 0.1 V vs. RHE. This maximum in activity arose from the competition between adsorbed nitrate and hydrogen, with 0.1 V vs. RHE being the potential when both species were considerably present on the surface. Below 0.1 V, the reaction rate decreased because there was a low coverage of nitrate on the Pt, and surface sites were blocked by adsorbed hydrogen. Above 0.1 V, the reaction rate decreased because there was not enough hydrogen available on the surface. Unlike the Pt₁₀₀/C, none of the PtₓRu_{y}/C alloys exhibited a maximum activity at 0.1 V vs. RHE. Without intending to be bound by theory, it is believed that this is because, similar to Rh, these PtₓRu_{y} alloys bind nitrate more strongly than pure Pt, which shifts the maximum activity to a more negative potential. The stronger adsorption of nitrate and shift in potential of maximum activity of the PtₓRu_{y} alloys was expected because Ru is less noble than Pt and was supported by the DFT calculations. Importantly, the PtₓRu_{y}/C alloys were more active than Pt₁₀₀/C at all eight applied potentials, confirming DFT modeling predictions that Pt₃Ru would be more active than Pt for NO₃RR.

In FIG. 5B, the current density for the alloys at 0.1 V vs. RHE, normalized to ECSA from Cu_{upd}, is shown as a function of Ru content. The general trends of the intrinsic activity of the alloys indicate a maximum (“volcano”) behavior where Pt₇₈Ru₂₂/C has six times the activity than that of Pt₁₀₀/C when normalized by the ECSA from Cu_{upd}. The activities of Pt₄₈Ru₅₂ and Pt₆₂Ru₃₇ were similar because the two materials displayed comparable surface compositions from XPS. However, bulk Ru at % was extracted from ICP-MS than surface Ru at % from XPS. Thus, the bulk at % was used as the naming convention of the alloys. Ru/C was also tested, but Ru leached into the acidic electrolyte solution throughout the experiment, making it impossible to accurately obtain steady-state measurements or determine active surface areas (FIG. 18). The CV scans did not show Ru redox peaks due to the low loading of Ru on the support. Instead, there was substantial Ru leaching into the solution during pretreatment in 1 M H₂SO₄. From FIG. 18A, the onset potential for oxygen evolution occurred at ˜1.4 V vs. RHE in the first cycle. Continued cycling slowly stripped away Ru from the catalyst into the acidic electrolyte solution leading to an increase in the oxidation onset potential. Unlike the Pt/C (FIG. 18B), which displayed H_{upd} peaks that are indicative of hydrogen adsorbing and desorbing from the surface of the metal after 50 pretreatment cycles, Ru/C displayed no metal peaks and all of the current is attributed to the carbon support.

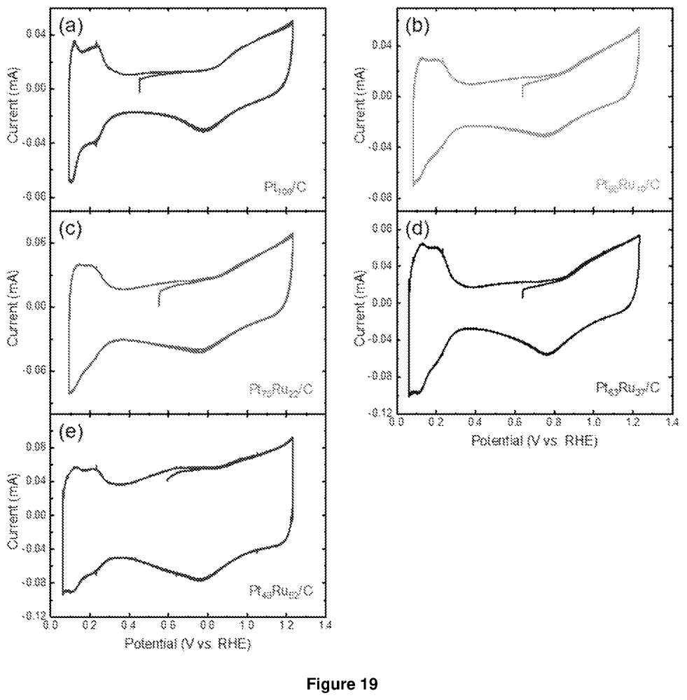

Cyclic voltammograms of the alloy catalysts remained consistent after multiple cycles, suggesting that the alloy catalysts were stable prior to steady-state measurements. For comparison, the last three H_{upd} CVs of PtₓRu_{y}/C catalyst after 50 cycles of pretreatment are included in FIG. 19, which show the stability of the material before steady-state experiments. No CVs were performed after the experiment because the presence of nitrate in the solution alters the CV scans.

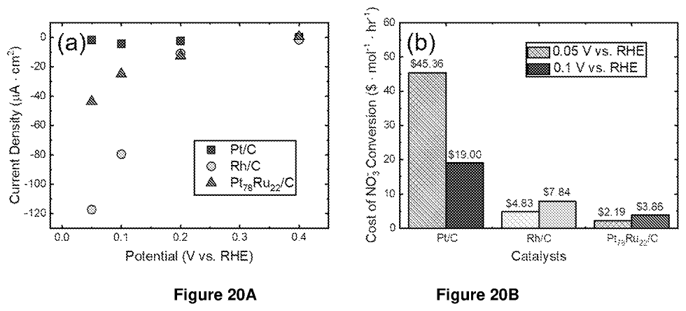

Rh/C, the most active pure metal standard, was four times more active than Pt₇₈Ru₂₂/C (FIG. 20A) at 0.1 V vs. RHE. However, because Rh is currently the most expensive noble metal, the catalyst cost is twice as much to convert one mole of nitrate in an hour using Rh/C compared with Pt₇₈Ru₂₂/C (FIG. 20B). Pt/C on the other hand would be the most expensive of the considered catalysts, costing almost three times more than Rh/C to have the same total NO₃RR conversion. This high cost is largely due to the low NO₃RR activity of Pt/C.

### Underpotential Deposition

After compensating for 85% of the solution resistance using electrochemical impedance spectroscopy (EIS), H_{upd} in the hydrogen desorption region was used as one method to determine the ECSA of the PtₓRu_{y}/C alloys. The average charge density of Pt (210 μC cm⁻²) was employed to calculate the ECSA. A slanted baseline, representing the double-layer charging current, was taken by subtracting half of the double-layer charging current measured at 0.35 V vs. RHE.

All Cu_{upd} experiments were conducted in 0.1 M H₂SO₄ for an initial H_{upd} baseline before adding 2 mM CuSO₄ into the solution. The electrodes were polarized at 1.0 V vs. RHE for 2 min to ensure no Cu ions adsorbed to the surface of the electrode. Deposition potentials from 0.28-0.48 V vs. RHE were applied for 100 s to deposit a monolayer of Cu²⁺ on the surface of the catalyst. After, a linear voltammetric scan was performed at 100 mV s⁻¹ from the applied potential to 1.0 V vs. RHE, in which all the underpotential-deposited copper has been oxidized. Charges obtained from the copper stripping were corrected by subtracting the double-layer charge obtained in the absence of cupric ions in the solution.

### Steady-State Current Measurements for Nitrate Reduction

H_{upd} and baseline chronoamperometric measurements were performed in 100 mL of 1 M H₂SO₄ solution. The rotating disk electrode (RDE) was held at each potential for 5 min while rotating at 2500 rpm to eliminate mass transfer limitations. The absence of external mass transfer limitations was confirmed by verifying that the current densities were independent of rotation rate at 2500 rpm or above. The film drop-cast method was used to deposit a thin layer of catalyst onto the glassy carbon electrode to avoid sources of internal diffusion limitations. The measured currents in the last 20 s were averaged and reported accordingly. After adding 20 mL of 6 M NaNO₃ (Sigma Aldrich, 99.0%) to reach 1 M nitrate, the electrolyte solution was sparged with N₂ for 15 min to remove trace oxygen. The chronoamperometric measurements were repeated with nitrate in the solution.

### Example 4—Selectivity Measurements

A working electrode having a catalyst disposed thereon was prepared by depositing Pt and Ru precursors via the same NaBH₄ reduction method as described in Example 1, on 2.5×2.5 cm² pieces of carbon felt (6.35 mm thick, 99.0%, Alfa Aesar). The carbon felts (CFs) were attached to a graphite rod (AGKSP grade, ultra “F” purity, Alfa Aesar) for use as the working electrode.

Before electrochemical measurements, N₂ (Ultra-high purity grade, 99.999%, Cryogenic Gases) was sparged through the electrolyte for at least 45 min to remove O₂ from the solution. Throughout the experiment, N₂ blanketed the electrolyte solution to prevent O₂ from reaching the electrolyte. The carbon felt was treated in 1 M H₂SO₄ solution by cycling from hydrogen evolution to Pt oxidation (−0.17 to 1.23 V vs. RHE) at least 35 times at 100 mV s⁻¹ to remove oxygenated species from the surface of the metal nanoparticles. H_{upd} experiments were conducted after compensating for 85% of the solution resistance.

The PtₓRu_{y}/CF (Pt and Ru alloys supported on carbon felt) was transferred to a two-compartment, three-electrode glass electrochemical cell with 150 mL of 0.1 M HNO₃ (sparged with N₂) as the electrolyte solution in the cathodic compartment. The electrolyte for selectivity measurements was 0.1 M HNO₃ (rather than 1 M H₂SO₄ and 1 M NaNO₃) to avoid possible sodium and sulfate interference in the ion chromatograph used for product quantification. Again, 85% of the solution resistance was compensated using EIS before running a 4-hr steady-state measurement at 0.1 V vs. RHE. Only 85% was directly compensated to avoid instability of the potentiostat controller.

An ion chromatography (Agilent), equipped with AS9-HC column (Dionex) with 9 mM sodium carbonate eluent, was used to quantify the amount of nitrate and nitrite in the electrolyte solution. For anion measurements, sodium nitrate (Sigma Aldrich, 99.0%) and sodium nitrite (Sigma Aldrich, 99.999% trace metal basis) were used to prepare the standard solutions for the calibration curve. To prevent oversaturating the system with anions, 0.1 mL of the electrolyte solution was extracted every hour and diluted by a factor of ten with Millipore water to measure the change in nitrate concentration. Separately, 0.5 mL of the electrolyte solution was extracted and neutralized with 0.1 M NaOH (Sigma Aldrich, 99.99%) to inhibit the decomposition of nitrite in acidic media. However, the measured values of the nitrite concentration may be lower than the actual values due to the decomposition of nitrite during the extraction of the reactor aliquots.

NH₃ was quantified by using the indophenol blue test. An aliquot of 1 mL of electrolyte solution was extracted from the cathodic side of the two-compartment cell every hour. 1 M NaOH (Sigma Aldrich, 99.99%) was added to the electrolyte solution to neutralize the acid to a pH of 12. After, 122 μL of sodium salicylate (Sigma Aldrich, >99.5%), 27.3 μL of sodium nitroprusside dihydrate (Sigma Aldrich, >99%), and 40 μL of sodium hypochlorite solution (Sigma Aldrich, 4.00-4.99%) were sequentially added to the electrolyte solution and manually stirred together. The solution was covered and left for 40 min. Afterward, a UV-vis spectrometer (Thermo Fischer, Evolution 350) was used to obtain spectra between 400-1000 nm. The indophenol peak was identified as the maximum absorbance between 650-700 nm. A fresh 0.1 M HNO₃ electrolyte solution prepared with the indophenol blue method was used as the background and subtracted from the sample spectra. If the concentration of NH₃ was too high and oversaturated the detector, the solution was diluted and retested. A calibration curve was created using known concentrations of NH₄Cl (Sigma Aldrich) in 0.1 M HNO₃, and unknown NH₃ concentrations were calculated using the Beer-Lambert law. The faradaic efficiency (FE) was calculated by dividing the charge required to form the total NH₃ measured by the total charge passed during the steady-state experiments. The total charge passed was calculated by integrating the reduction current over the duration of the experiment and the charge required from NH₃ was calculated by assuming that eight electrons are required to form one molecule of NH₃ from one molecule of nitrate.

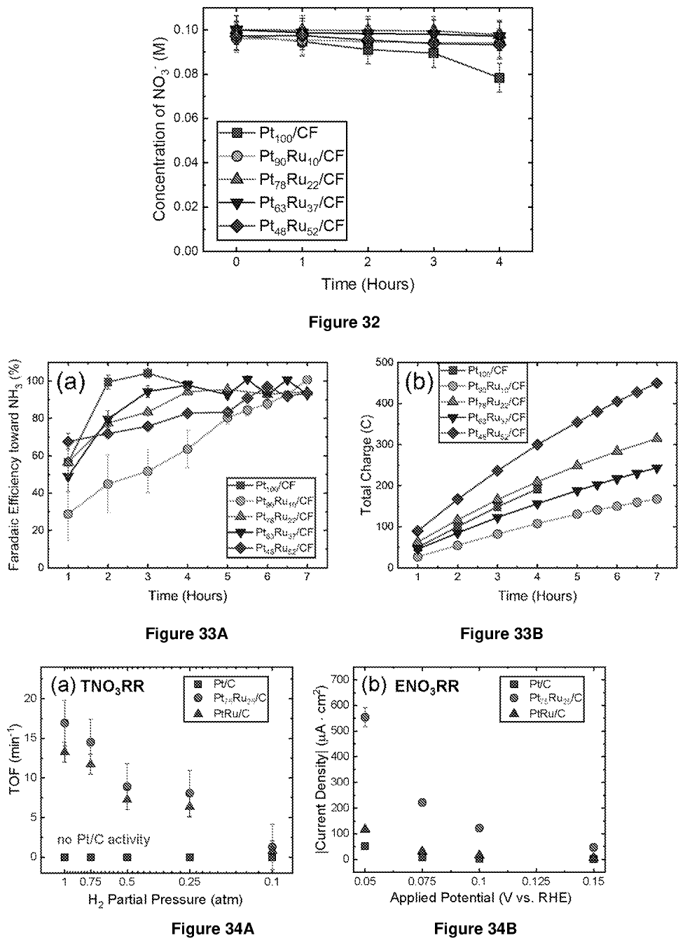

FIG. 7A displays the catalyst FE towards nitrite, ammonia, and other potential gas-phase products after applying a potential of 0.1 V vs. RHE for seven hours. At this operating potential, hydrogen was not thermodynamically favorable to form, and there was no significant change in the concentration of nitrate due to the large volume of the electrolyte solution (FIG. 32). The FE towards NH₃ production was calculated by averaging the last three time points (FIG. 33). Most of the current was attributed to NH₃ production and nitrite is not detected, though it was possible that nitrite in the solution has formed NO on the surface of the electrode. The pure Pt has nearly 100% FE to NH₃, as has been previously reported at low overpotentials, and the alloy materials all display above 93% FE towards NH₃.

The faradaic efficiencies (FE) and total charge (in C) of the PtₓRu_{y}/CF towards NH₄⁺ over seven hours at an applied potential of 0.1 V vs. RHE are shown in FIGS. 33A and 33B respectively. Two hours into the reaction, Pt₁₀₀/CF has consistently reached above 98% FE. The FE of the PtₓPt_{y}/CF seems to plateau at above 90% after five hours. The increase in the measured faradaic efficiency over time can be attributed to different possible factors. Because the measurements were performed in a batch reactor with a porous electrode surface, diffusion limitations may have delayed the transport of the products to the bulk solution such that it takes time for steady state to be reached. Additionally, it is possible that some intermediates are forming on the surface but reacting slowly, which resulted in high faradaic efficiency towards ammonia only once the intermediates have sufficient time to react. To calculate the FE, the last three timepoints in the experiment were averaged when the FE towards NH₃ was consistent over time.

The total current density for the PtₓRu_{y}/CF shown in FIG. 7B followed a similar trend in Ru content as observed on the RDE (FIG. 5). The partial current density towards ammonia is also depicted, with the alloy catalysts containing Ru having greater activity towards ammonia production than pure Pt. The rates on catalysts on the carbon felts may have been limited by internal diffusion because of the porosity and greater thickness of the carbon felt compared to the RDE, which would explain the slight differences between the activity trends of the two setups. Regardless, the inclusion of Ru into the Pt catalyst increased the rate of nitrate reduction up to a certain composition, after which further addition of Ru decreases the normalized catalytic activity.

### Example 5—H_{upd} and Cu_{upd} Experiments

To perform the H_{upd} experiments, the PtₓRu_{y}/C catalysts were first pretreated by cycling from hydrogen evolution to Pt oxidation (−0.17 to 1.23 V vs. RHE) at least 50 times or until the CVs were stable. This pretreatment ensured that surface oxides were reduced before taking measurements. CV scans between 0.08 and 1.23 V vs. RHE were used to obtain H_{upd} peaks (FIG. 14A) after compensating for 85% of the solution resistance (blue). Only 85% compensation was used to avoid oscillations in the potentiostat controller often seen when using higher compensation percentages. A slanted baseline double layer charge from the carbon support was measured at 0.35 V vs. RHE and subtracted from the total charge from the hydrogen desorption region. The estimated charge density of desorbing a monolayer of H from a Pt surface (210 μC cm⁻²) was used to calculate the ECSA. Additional baseline experiments were performed on the carbon support without metal present (FIG. 14) to show that no Cu desorbed from the carbon upon operating under the same conditions used for Cu_{upd} for the supported catalysts.

For the Cu_{upd} measurements, the scan ranges were kept the same as H_{upd} and 2 mM CuSO₄ was added into the solution. The first Cu desorption peak at ˜0.3 V vs. RHE corresponded to bulk Cu stripping, and the smaller peaks that follow from 0.3-0.8 V vs. RHE corresponded to a monolayer of Cu stripping from the catalyst surface. The charges obtained from Cu stripping were subtracted by the double layer baseline obtained in the H_{upd} experiments in the absence of Cu²⁺ ions in the solution. To further ensure that the Cu_{upd} total charge was only from the stripping of a monolayer of Cu, experiments were performed to determine the appropriate deposition potential. The electrodes were first polarized at 1.0 V vs. RHE for two minutes so that no Cu ions remained on the surface. Deposition potentials from 0.28-0.48 V vs. RHE were applied for 100 seconds to deposit a monolayer of Cu²⁺ on the surface before applying a linear voltammetric scan (LSV) at 100 mV s⁻¹ from the deposition potential to 1.0 V vs. RHE. The ratio of copper to hydrogen stripping charge as a function of the deposition potential is shown for Pt₁₀₀/C in FIG. 14C. Baseline LSVs conducted at the same starting potential with different scan rates on commercial PtRu/C showed minimal effect on the H_{upd} and Cu_{upd} ECSA (FIG. 14D).

### Example 6—Thermocatalytic and Electrocatalytic Reduction Experiments

A NaBH₄ reduction synthesis was used to synthesize Pt₂₅Ru₂₅/C. The carbon black (Vulcan XC 72; Fuel Cell Store) was pretreated at 400° C. for 2 hrs to remove surface impurities. Afterwards, the support was suspended and sonicated in Millipore water (18.2 MΩcm, Millipore MilliQ system) for 15 min. Measured concentrations of RuCl₃ (38% Ru; Alfa Aesar) and H₂PtClₑ(38-40% Pt; Sigma Aldrich) in Millipore water were added to the solution and stirred for another 15 min before 40 mg of NaBH₄ (Sigma Aldrich) dissolved in 25 mL of Millipore water were added to accelerate the reaction. The final solution was stirred for 2 hrs before centrifuging three times at 3000 rpm for 8 min each and washed with Millipore water. The recovered solid was dried overnight in an oven at 80° C. in air. All commercial catalysts (Pt/C and PtRu/C) were purchased from Fuel Cell Store. For the nitrate concentration and pH effect studies, the commercial PtRu/C was used instead of the most active synthesized Pt₂₅Ru₂₅/C because a single batch of commercial PtRu/C was sufficient to perform all studies. Using Pt₂₅Ru₂₅/C for these studies would require multiple batch syntheses and introduce batch-to-batch variations in the measurements.

The final metal loadings were determined by using thermogravimetric analysis (TGA) on a Shimadzu TGA-50H in a quartz pan. All catalyst samples were pretreated under He at 100° C. for 30 min to remove surface contaminants and adsorbed water. Samples were heated to 700° C. at 10° C./min in air to oxidize all the carbon. The metal weight loading was determined by dividing the final weight by the initial weight prior to the temperature ramp. X-ray diffraction (XRD) analysis was conducted using a Rigaku Miniflex XRD with Cu Kα radiation and a Ni filter (λ=1.5418 Å). The 2e range (10°<2θ<90°) was scanned at 5°/min with a 0.02° step size. Crystallite sizes were estimated using the Scherrer equation and the Pt and Ru peaks were referenced to #04-0802 and #06-0663, respectively, from JADE XRD processing software. Imaging and chemical characterization of the catalysts were performed with scanning electron microscopy (Nova 200 Nanolab; Thermo Fisher) coupled with energy-dispersive X-ray spectroscopy (SEM/EDX).

### Thermocatalytic Nitrate Reduction Experiments

Thermocatalytic nitrate reduction activity was measured in a 125 mL 3-neck jacketed flask (ChemGlass) at atmospheric pressure. For all experiments, 10 mg of catalyst was suspended in 100 mL of Millipore water and stirred at 500 rpm. The solution was sparged with H₂ (Cryogenic Gases) for at least 30 min to remove dissolved oxygen and reduce the catalyst. The H₂ partial pressure (0.1-1 atm) was adjusted accordingly by co-feeding Ar (Cryogenic Gases) while keeping the total flow rate consistent at 250 mL/min. The temperature (20-50° C.) of the reactor was controlled via a refrigerated/heated bath circulator (Fisher Scientific). Desired concentrations of nitrate (1-100 mM NaNO₃) were added to the reactor at the beginning of the reaction after H₂ pretreatment. For lower concentrations of nitrate (510 mM NaNO₃), a sample was collected every 3 min for the first 15 min. At higher nitrate concentrations (>10 mM NaNO₃), a sample was collected every 15 min to ensure accurate rate quantifications under differential conditions. In all cases, a 1 mL syringe was used to extract the sample from the reactor before centrifuging at 3000 rpm for 5 min to separate the aliquot solution and catalyst particles. Nitrate, nitrite, and ammonia concentrations were measured using a UV-Vis spectrometer (Thermo Fischer, Evolution 350). The activity is reported as a turnover frequency (TOF) in moles of aqueous products (e.g., ammonia, nitrite) per mole of surface metal per minute.

### Electrocatalytic Reduction Experiments

A single-compartment, 3-electrode, glass electrochemical cell (Pine Research) was used for electrochemical measurements with a clean graphite rod (Alfa Aesar, Ultra “F” purity) as the counter electrode. A single junction reference electrode (Pine Research, in 4 M KCl) was used in solutions with pH less than or equal to 7, and a double-junction reference electrode (Pine Research, in 10% KNO₃) was used in pH 10. Both reference electrodes were calibrated at 1 atm of H₂ (Cryogenic Gases) in different pH solutions. The cell initially contained 100 mL of electrolyte solution (pH 0: 1 M sulfuric acid; pH 1: 0.1 M sulfuric acid; pH 3: 0.1 M sodium citrate+0.1 M citric acid; pH 5: 0.2 M sodium acetate+0.2 M acetic acid; pH 7: 0.2 M sodium phosphate+0.1 M citric acid; pH 10: 0.1 M sodium carbonate+0.1 M sodium bicarbonate; Sigma Aldrich) with all anions in the solution confirmed to not react at the operating potentials. The selected buffers were chosen from those that have previously been used to study pH effects for electrochemical reactions where anion adsorption was not reported to significantly impact the results. Prior to electrochemical experiments, N₂ (Cryogenic Gases) was sparged through the solution with a stir bar for at least 45 min to remove traces of dissolved O₂. Cyclic voltammogram (CV) scans after sparging confirmed the absence of dissolved O₂ from the solution and stability of the working electrode.

The working electrode was prepared and tested as described previously. Briefly, a catalyst ink was prepared with a Nafion binder and deposited onto a glassy carbon rotating disk insert (Pine Research) to result in a total loading of 9.6 μg of catalyst, including carbon. The prepared electrodes were cleaned by cycling 50 times between hydrogen evolution and oxidation potentials (from −0.1 to 1.2 V vs. RHE) at 100 mV s⁻¹. Both hydrogen underpotential deposition (H_{upd}) and copper underpotential deposition (Cu_{upd}) were used to accurately evaluate the electrochemically active surface area (ECSA) of the catalysts as described previously. After an 85% compensation for internal solution resistance as measured by electrochemical impedance spectroscopy, H_{upd} was determined by cycling between the onset of HER to Pt oxidation (pH 0: 0.06-1.3, pH 1: 0.07-1.3, pH 3: 0.05-1.3, pH 5: 0.05-0.8, pH 7: 0.06-1.3, and pH 10: 0.04-1.3 V vs. RHE), at a scan rate of 100 mV s⁻¹ until the cyclic voltammograms were stable. The background-corrected hydrogen desorption charge and the average charge density of Pt (210 μC cm⁻²) were used to determine the ECSA.

All chronoamperometry measurements were taken after an 85% compensation for internal solution resistance as measured by electrochemical impedance spectroscopy. The rotating disk electrode (RDE) was held at a rotation rate of 2500 rpm to eliminate mass transfer limitations and minimize differences in the pH between the bulk solution and at the electrode surface. A rotation rate of 2500 rpm was selected, as it was sufficiently high where the reaction rates did not change with further increase in rotation rate. During the measurements, the bulk pH of the solution did not vary by more than a pH of 0.1. Currents were measured at four different applied potentials (0.05, 0.075, 0.1, 0.15 V vs. RHE) and recorded as the average current in the final 20 s. A baseline current was recorded in the electrolyte solution at each applied potential without the presence of nitrate. For ENO₃RR experiments, 20 mL of dissolved sodium nitrate in electrolyte solution was added to reach the desired concentration (0.01, 0.03, 0.1, 0.5, 1 M NaNO₃) before measuring the current at each applied potential.

### Apparent Activation Energy Measurements

For ENO₃RR measurements, reduction currents were recorded for 10 min at two applied potentials (0.05 V and 0.1 V vs. RHE) and four different temperatures (T=10, 20, 25, 30° C.) after compensating for 85% of the internal solution resistance. The TNO₃RR experiments were prepared using similar methods as previously described and operated at four different temperatures (T=20, 30, 40, 50° C.). A heating/cooling jacket was used with a refrigerated/heated bath circulator (Fischer Scientific) to maintain the desired temperature. The difference in the temperature ranges selected were due to limitations of the experimental setup. For ENO₃RR experiments above 30° C., thermal expansion caused the glassy carbon electrode to pop out of the Teflon holder. A wider range of temperatures was used for thermocatalytic measurements to reduce the influence of experimental error on the results. The apparent activation energy (Eₐ) was evaluated from an Arrhenius plot of the current density or TOF.

### Selectivity Measurements

ENO₃RR measurements from depositing catalysts onto glassy carbon did not generate high enough currents to allow for product quantification. Thus, 10 mg of powder PtₓRu_{y}/C catalysts were directly deposited on 2.5×2.5 cm² pieces of carbon felt (6.35 mm thick, 99.0%, Alfa Aesar) in 40 mL of 1 M H₂SO₄. To ensure all of the catalyst was deposited onto the carbon felt, the solution was mixed for 30 min with bubbling H₂ at 80° C. In a two-compartment electrochemical cell separated by a Nafion 117 membrane, these carbon felts (CFs) were attached to a graphite rod (AGKSP grade, ultra “F” purity, Alfa Aesar) for use as the working electrode for ENO₃RR selectivity experiments.

Nitrate and select liquid-phase products (i.e., NO₂⁻ and NH₃) were measured using UV-vis spectrometer (Thermo Fischer, Evolution 350). Nitrate was quantified using standard spectrometry techniques. 10 μL from the sample aliquot was acquired and diluted to 2 mL using Millipore water. 1 mL of this resulting, well-mixed solution was further diluted to 3 mL in a quartz cuvette (Fisher Scientific, Azzota Corp 10 mm). UV-Vis measurements were taken between 190-300 nm, and the nitrate concentrations were calculated via the adsorption peak at 220 nm. Millipore water was used as the background and subtracted from the sample spectra, and a calibration curve was created using known concentrations of NaNO₃ in solution.

Nitrite (NO₂⁻) was quantified via a modified Griess diazotization reaction. 0.3 mL of the extracted sample aliquot was diluted to 1 mL and neutralized with 1 M NaOH. 40 μL of the Griess color reagent, which consisted of 2% sulfanilamide (Fischer Scientific, >98%) and 0.2% N-(1-napthyl)-ethylenediamine (Sigma Aldrich, >98%) in phosphoric acid (Acros Organics; 85%) diluted to 0.1 M, was added. The resulting solution was left in the dark for 30 min before measuring absorbances at 543 nm. Known concentration of calibration standards were made from NaNO₂ (>99.0%, Sigma Aldrich).

Ammonia was quantified by using the indophenol blue test with 1 mL of the sample aliquot. 1 M NaOH (Sigma Aldrich, 99.99%) was added to the electrolyte solution to neutralize the acid to a pH of 12. This was followed by sequentially adding 122 μL of sodium salicylate (Sigma Aldrich, >99.5%), 27.3 μL of sodium nitroprusside dihydrate (Sigma Aldrich, >99%), and 40 μL of sodium hypochlorite solution (Sigma Aldrich, 4.00-4.99%) to the electrolyte solution and manually stirred together. The solution was covered and left for 40 min. The indophenol peak was identified as the maximum absorbance between 600-700 nm. A fresh 0.1 M HNO₃ electrolyte solution prepared with the indophenol blue method was used as the background and subtracted from the sample spectra. If the concentration of NH₃ was too high and oversaturated the detector, the solution was diluted and retested. A calibration curve was created using known concentrations of NH₄Cl (99.99%, Sigma Aldrich) and unknown NH₃ concentrations were calculated using the Beer-Lambert law.

The faradaic efficiency (FE) for ENO₃RR was calculated by dividing the charge required to form the total NH₃ measured by the total charge passed during the steady-state experiments. The total charge passed was calculated by integrating the reduction current over the duration of the experiment and the charge required from NH₃ was calculated by assuming that eight electrons are required to form one molecule of NH₃ from one molecule of nitrate.

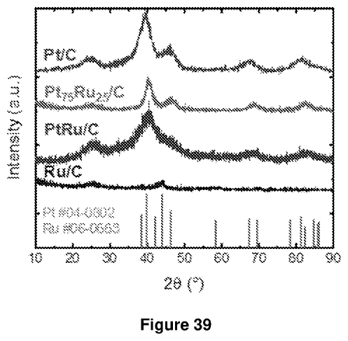

The weight loading of the catalysts was determined by TGA (FIG. 38), and corresponding crystallite sizes were calculated by applying the Scherrer equation to the XRD results (FIG. 39). FIG. 38 shows the results from thermal gravimetric analysis (TGA) of the Vulcan carbon supported catalysts. Both the Pt/C and PtRu/C showed total metal loading around 30 wt %, as expected. The synthesized Pt₇₅Ru₂₅/C had 5 wt % lower loading than targeted, indicating that not all the precursor was deposited on the supported during synthesis. The manufacturing company claimed a 20 wt % loading for Ru/C, but the TGA results show loadings closer to 30 wt %.

X-ray diffraction (XRD) spectra for PtₓRu_{y}/C catalysts and the corresponding Pt and Ru powder diffraction files are provided in FIG. 39. Increasing Ru composition in the material increased the 2θ angle of the Pt peaks. There were no separate Pt and Ru peaks present in the alloys, indicating no phase segregation in the material.

The average nanoparticle sizes of Pt/C, PtRu/C and Pt₇₅Ru₂₅/C were 2.6, 2.4, and 3.7 nm, respectively (Table 6). The crystallite sizes and weight loading of the catalysts were calculated by applying the Scherrer equation (Table 6). The different catalysts have roughly the same average particle sizes. Additionally, the particle size of Pt₇₅Ru₂₅/C matched previously synthesized materials.

TABLE 6
Crystallite sizes and metal weight
percent loading for platinum-ruthenium catalysts.

| Catalysts | Crystallite Size (nm) | Weight Loading (%) |
|---|---|---|
| Pt/C | 2.6 ± 0.6 | 27.3 |
| PtRu/C | 2.4 ± 0.3 | 32.2 |
| Pt₇₅Ru₂₅/C | 3.7 ± 1.0 | 25.1 |
| Ru/C | 2.9 ± 0.5 | 28.7 |

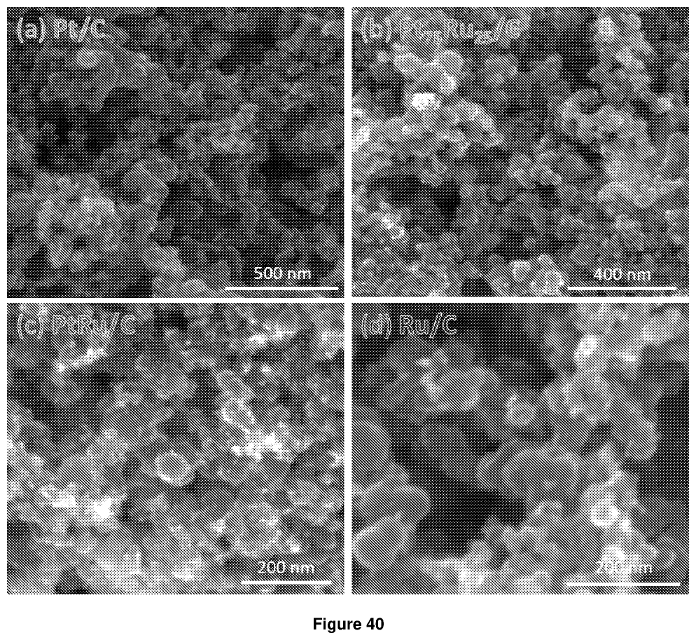

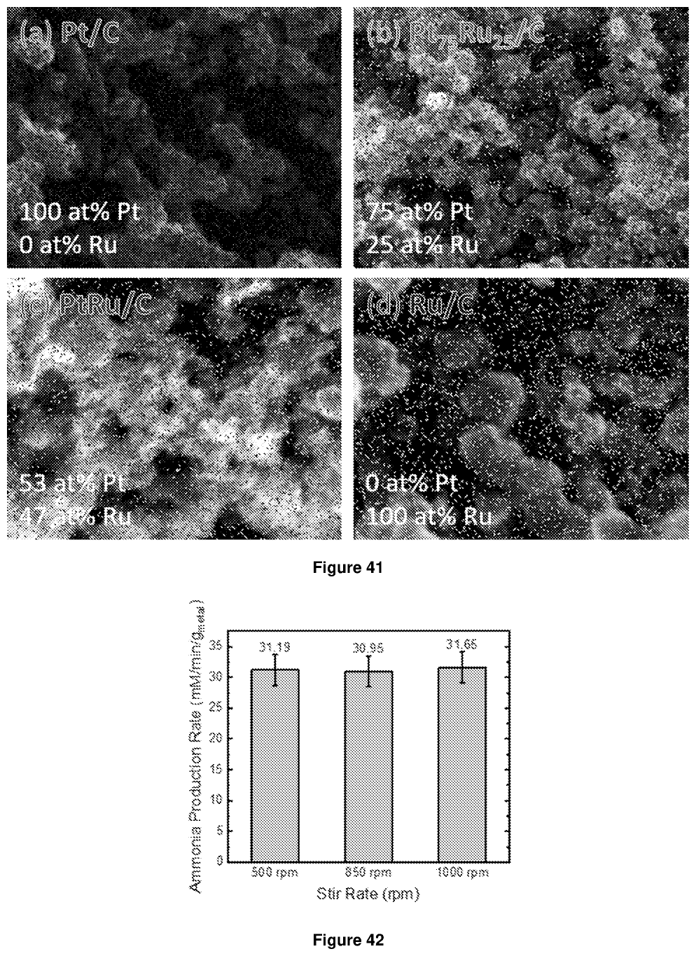

Scanning electron microscopy (SEM) images and elemental analysis from energy dispersive spectroscopy (EDX) are shown in FIGS. 40 and 41, respectively. EDX analysis reveal that the metal nanoparticles are dispersed on the surface of the support and confirms that the Ru at % increases as the Ru content in the alloy increases. Also, the at % of the metal averaged over three different areas in the EDX analysis shows that the surface composition of metals is similar to the target composition from synthesis.

SEM images of the PtₓRu_{y}/C catalysts are provided in FIG. 40, and subsequent elemental analysis from EDX is shown in FIG. 41. No change in ammonia production rates was observed at rotation rates beyond 500 rpm (FIG. 42). To ensure that no mass diffusion limitations occurred throughout TNO₃RR experiments, the ammonia production rate throughout the course of the reaction was measured for PtRu/C at three different stir rates (FIG. 42). As the catalysts were non-porous (and thus there are no internal diffusion limitations), these results indicate a lack of transport limitations here.

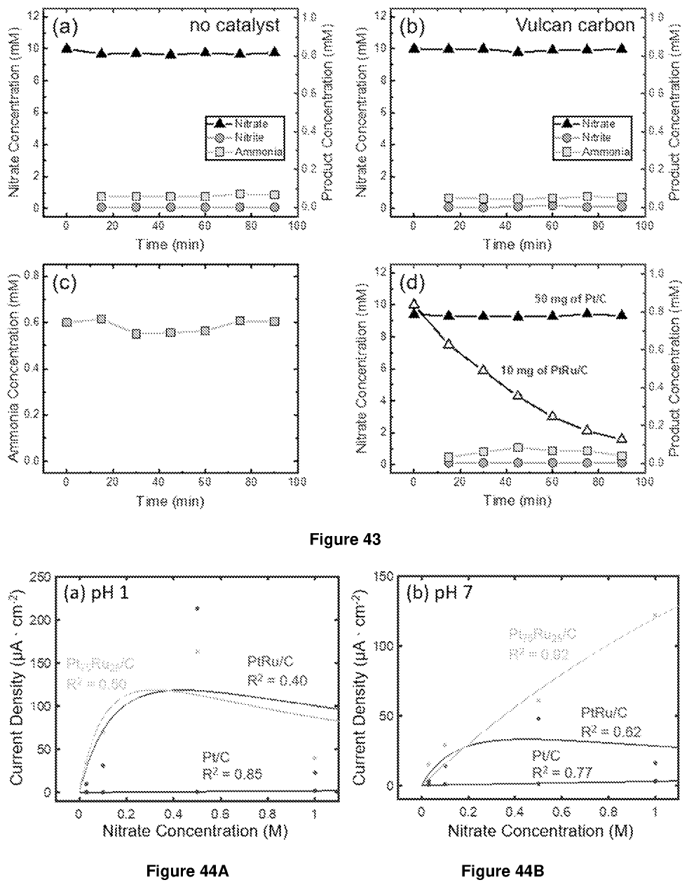

As a result, a 500-rpm stir rate was used throughout TNO₃RR experiments to ensure no external mass transport limitations. Without the presence of metals on the Vulcan carbon support, no catalytic activity is recorded (FIG. 43). Additional baseline experiments were performed to ensure that the catalytic effects observed are due to the metal alloy. FIGS. 43A and 43B display the nitrate and product (i.e., ammonia, nitrite) concentrations over the course of a standard 90 min reaction using no catalyst and Vulcan carbon, respectively. Without the presence of metals on the Vulcan carbon support, no catalytic activity was recorded. The miniscule amount of ammonia shown in these figures (˜0.02 mM) was subtracted as a baseline for analysis. A known concentration of ammonia was recorded over the course of the reaction in FIG. 43C. The consistent level of ammonia concentration indicates that aqueous ammonia does not evaporate with continuous H₂ bubbling through the system.

For TNO₃RR measurements for Pt/C, there was no observed nitrate conversion and ammonia production activity. To ensure that this result was due to a catalytic effect rather than experimental design issue, the amount of Pt/C was increased in the reactor from 10 mg to 50 mg. FIG. 43D shows no significant change in catalytic activity with increasing the amount of catalyst in the reactor. For comparison, the nitrate concentration for PtRu/C was provided, where a drastic drop in nitrate is recorded over the course of 90 min.

Assuming ENO₃RR follows a Langmuir-Hinshelwood model, both a single site model (SSM) and multisite model (MSM) were considered to model the reaction. SSM assumes a homogeneous electrode surface, the rate r can be derived as shown is Eq. S1 by inserting expressions for the coverages into Eq. 1. Both nitrate and H⁺ adsorb onto this single site and competitively inhibit the other species. The adsorption equilibrium constants K_{N} and K_{H} refer to the adsorption of nitrate and H⁺, respectively; C; refers to the bulk concentration of species i; k_{SSM} denotes the rate constant of the surface reaction between adsorbed nitrate and hydrogen for the SSM.

$$r = {k}_{SSM} \frac{{K}_{N} {K}_{H} {C}_{N} {C}_{H}}{{( 1 + {K}_{N} {C}_{N} + {K}_{H} {C}_{H} )}^{2}} [ M {s}^{- 1} {m}^{- 2} ] \qquad ( S1 )$$

If TNO₃RR follows a surface reaction RDS, it will obey the same rate equation.

The main assumptions of the proposed multisite kinetic model (MSM) were as follows: 1) There are two adsorption sites on the catalyst surface, *₁,*₂; 2) The reaction only occurs between NO₃*₁ and H*₂ and thus each species competitively inhibits the other on the opposite site. Adsorption equilibrium constants K₁, K₂, K₃, K₄, refer to Eqs. S2-5, respectively.

$${NO}_{3}^{-} + {*}_{1} ⇌ {NO}_{3}^{{*}_{1}} + {e}^{-} \qquad ( S2 )$$

$${NO}_{3}^{-} + {*}_{2} ⇌ {NO}_{3}^{{*}_{2}} + {e}^{-} \qquad ( S3 )$$

$${H}^{+} + {*}_{1} + {e}^{-} ⇌ {H}^{{*}_{1}} \qquad ( S4 )$$

$${H}^{+} + {*}_{2} + {e}^{-} ⇌ {H}^{{*}_{2}} \qquad ( S5 )$$

The rate determining step is seen in Eq. S6, resulting in the corresponding rate law shown in Eq. S7.

$${NO}_{3}^{{*}_{1}} + {H}^{{*}_{2}} \to {NO}_{2}^{*} + {OH}^{*} \qquad ( S6 )$$

$$r = {k}_{MSM} {θ}_{{N}^{{*}_{1}}} {θ}_{{H}^{{*}_{2}}} \qquad ( S7 )$$

In Eq. S7, θ_{i*j}; refers to the surface coverage of the species i on site j. From these assumptions, and assuming quasi-equilibrium in the adsorption reactions in Eqs. S2-S5, a rate law (Eq. S8) is derived relating reaction rate with bulk concentration of nitrate (C_{N}) and H⁺ (C_{H}), a constant of proportionality k_{MSM} [M s⁻¹ m⁻²], and using a site balance in Eq S9.

$$r = {k}_{MSM} \frac{{C}_{N} {C}_{H}}{{K}_{1} {K}_{4} ( \frac{{C}_{N}}{{K}_{1}} + \frac{{C}_{H}}{{K}_{3}} + 1 ) ( \frac{{C}_{N}}{{K}_{2}} + \frac{{C}_{H}}{{K}_{4}} + 1 )} \qquad ( S8 )$$

$$1 = {θ}_{{N}^{{*}_{1}}} + {θ}_{{H}^{{*}_{1}}} + {θ}_{* 1} = {θ}_{{N}^{{*}_{2}}} + {θ}_{{H}^{{*}_{2}}} + {θ}_{* 2} \qquad ( S9 )$$

θ_{*1} and θ_{*2} are the coverage of open sites on site 1 and 2, respectively. This MSM rate law is compared to that of the SSM for accuracy in predicting the nitrate reduction reaction rate. A nonlinear least-square regression was performed on MATLAB version R2020b, relating current density to concentration of H⁺. The SSM can be reduced to a two-parameter fit (Eqs. S10, S11), and the MSM to a three-parameter fit (Eqs. S12, S13). The independent variable, x, may refer to C_{H}, or 10^{-pH} depending on context.

$$r = \frac{α x}{{( β + x )}^{2}} \qquad ( S10 )$$

$$\begin{matrix}α = {k}_{SSM} \frac{{K}_{N} {C}_{N}}{{K}_{H}} [ {M}^{2} {s}^{- 1} {m}^{- 2} ] , \\ β = \frac{1}{{K}_{H}} + \frac{{K}_{N} {C}_{H}}{{K}_{H}} [ M ]\end{matrix} \qquad ( S11 )$$

$$r = \frac{A x}{( x + B ) ( x + C )} \qquad ( S12 )$$

$$\begin{matrix}A = {k}_{MSM} \frac{{C}_{N} {K}_{3}}{{K}_{1}} [ {M}^{2} {s}^{- 1} {m}^{- 2} ] , \\ B = \frac{{C}_{N} {K}_{3}}{{K}_{1}} + {K}_{4} [ M ] , \\ C = \frac{{C}_{N} {K}_{4}}{{K}_{2}} + {K}_{4} [ M ]\end{matrix} \qquad ( S13 )$$

The nitrate conversion TOF (for TNO₃RR) and current density (for ENO₃RR) was studied as a function of H₂ pressure and applied potential, respectively, for the Pt/C, PtRu/C, and Pt₇₅Ru₂₅/C materials in FIG. 34. These applied potentials and partial pressure ranges were chosen because (1) appreciable ENO₃RR activity is typically observed between 0.05 to 0.15 V vs. RHE and (2) typical TNO₃RR experiments are conducted with varying hydrogen partial pressures up to 1 atm. For all catalysts that showed activity, increasing the hydrogen driving force for reduction increases the rate of nitrate conversion. For TNO₃RR, the TOF on Pt₇₅Ru₂₅/C and PtRu/C increases as H₂ partial pressure increases. Likewise, the current density magnitudes from ENO₃RR for all PtₓRu_{y}/C catalysts increase as the applied potential becomes more negative and approaches 0 V vs. RHE (the standard thermodynamic potential for 1 bar H₂). Because the H₂ partial pressure and potential are related via the Nernst equation, this finding implies that the driving force to form adsorbed hydrogen plays a similar and important role in both TNO₃RR and ENO₃RR, which is corroborated by prior studies. It was also noted that a change in potential can bring different interactions between charged species and change the electronic energy of the metallic surface affecting both HER and ENO₃RR. However, this observation also supports the method of using the computational hydrogen electrode (where applied potential is equated to the chemical potential of hydrogen) to qualitatively model ENO₃RR.

The activity of the catalysts followed the order Pt₇₅Ru₂₅/C>PtRu/C>Pt/C for both TNO₃RR (FIG. 34A) and ENO₃RR (FIG. 34B) at pH 7. These measurements demonstrated that the enhancement previously reported,³³ where PtRu/C and Pt₇₅Ru₂₅/C were more active than Pt for ENO₃RR at pH 0, also holds at pH 7. This was previously attributed the higher ENO₃RR activity of PtₓRu_{y} compared with pure Pt to increased adsorption strength of nitrate. PtₓRu_{y} alloys have ensembles of sites (e.g., Pt—Ru—Ru, Pt—Pt—Ru) that adsorb reactants and intermediates stronger than Pt. The results here show similar activity trends hold for PtₓRu_{y}/C towards TNO₃RR, suggesting that catalyst design metrics, such as the nitrate adsorption energy, are related for TNO₃RR and ENO₃RR under this set of conditions. The reason that PtRu/C is less active than Pt₇₅Ru₂₅/C, despite having more Ru and thus more sites with stronger adsorption, is rationalized by a theoretical volcano plot, where the nitrate adsorption is too strong and decreases the rate.³³ The decrease in activity for PtRu/C compared to Pt₇₅Ru₂₅/C is also observed for TNO₃RR, but to a lesser extent.

While the behavior of TNO₃RR and ENO₃RR with hydrogen pressure/applied potential and catalyst alloying are qualitatively the same, there were differences in the reactions when considering the quantitative activity of the catalysts. One difference in the behavior was that for Pt/C there was no measured activity during TNO₃RR, even with increasing the amount of catalyst in the reactor (FIG. 43D), whereas some catalytic activity was observed for ENO₃RR. More specifically, while Pt/C was entirely inactive for TNO₃RR compared to PtRu/C or Pt₇₅Ru₂₅/C (FIG. 34A), a current density of 52 μA cm⁻² was recorded for Pt/C at 0.05 V vs. RHE during ENO₃RR (only 55% lower than PtRu/C, FIG. 34B). These results agree with previous studies that showed no activity for Pt in TNO₃RR.⁴⁰ However, the Pt catalyst has been demonstrated to be active for the thermocatalytic hydrogenation of nitrite. Without intending to be bound by theory, it is believed that Ru was responsible for hydrogenation of nitrate to nitrite and both Ru and Pt sites participate in further hydrogenation of nitrite to ammonia. These results pointed to potential differences in the hydrogenation mechanism between electrocatalytic and thermocatalytic reduction on the surface of Pt.

### Nitrate Concentration on PtRu/C

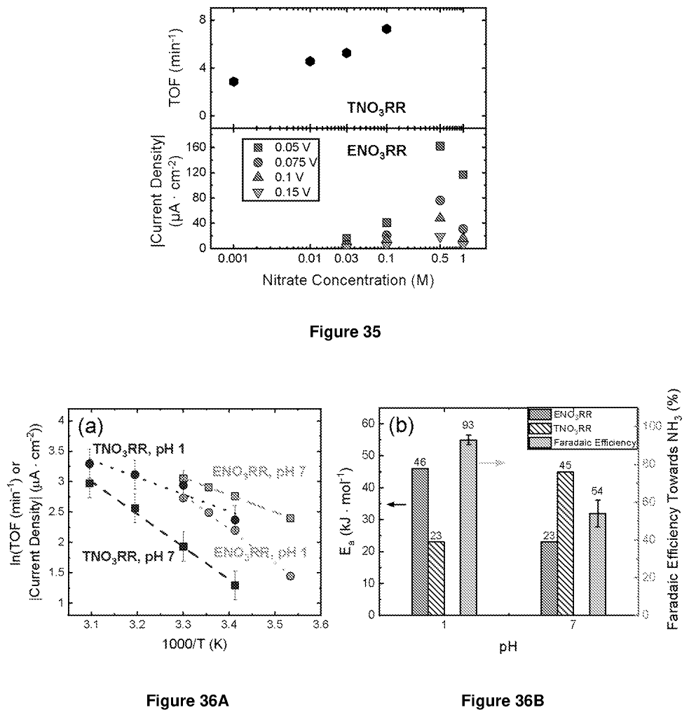

The data in FIG. 35 shows that both TNO₃RR and ENO₃RR have a positive rate order in nitrate on PtRu/C at low concentrations (<0.5 M NaNO₃) and a negative rate order in nitrate at higher concentrations (>0.5 M NaNO₃) for ENO₃RR. A positive rate order at low nitrate concentrations for TNO₃RR has been previously observed for kinetic studies on PdCu alloys. For all applied potentials, ENO₃RR on PtRu/C follows the same qualitative trend and is the most active at 0.5 M NO₃⁻ in pH 7 solution. The trends observed for ENO₃RR showed the RDS was a surface reaction, which qualitatively agrees with a prior report that explores nitrate concentration effects on Pt. A simple rate law for this reaction is:

$$rate = k {θ}_{H} {θ}_{N} \qquad ( 1 )$$

where k is the rate constant of the surface reaction and θ_{H} and θ_{N} represent the hydrogen and nitrate coverages, respectively, and are controlled by their corresponding equilibrium adsorption constants and concentrations for those species. At low nitrate concentrations, both θ_{N} and the current densities are directly proportional to the concentration of nitrate in solution. There is a decrease in reaction rate at high nitrate concentrations for ENO₃RR, suggesting that the nitrate is blocking surface sites for H⁺ adsorption and inhibiting reduction. This hypothesis is supported by previous X-ray absorption near edge spectra measurements on Pt/C, where addition of nitrate to solution caused a decrease in hydrogen coverage, implying competitive adsorption between nitrate and hydrogen. TNO₃RR ammonia production rates could not be accurately quantified using UV-Vis spectroscopy for nitrate concentrations greater than 0.1 M NO₃⁻, so activities above that concentration are not included in FIG. 35. The ENO₃RR rates were measurable at these concentrations because the activity is based on the current density, rather than direct quantification of ammonia at short time scales. Selectivities for the alloys ranged from 93% to 98% at 0.1 V vs. RHE and pH=1, and assumed 100% selectivity to ammonia under these conditions.

The ENO₃RR activity as a function of nitrate concentration is rationalized using the Langmuir-Hinshelwood model used to generate the rate law in Eq. 1 (FIG. 44).

When fitting the LH models to nitrate concentration and experimental data, the B and C fit parameters become equivalent, rendering the MSM mathematically identical to the SSM. The data in FIG. 44 showed the fit of this LH model to the experimental ENO₃RR activity at pH 1 and 7 for the considered catalysts. The nitrate concentration has little effect on the activity of Pt/C. The rate of reaction on PtₓRu_{y}/C at pH 1 and pH 7 had a positive order with respect to nitrate concentration until 0.5 M, where it became negative order. Pt₂₅Ru₂₅/C in pH 7 was the exception to this trend. The model qualitatively agreed with the experimental data and helped to explain that increasing in nitrate concentration was associated with increasing nitrate reduction activity up until concentrations between 0.2-0.4 M NO₃⁻ as the nitrate coverage increased, whereas at higher nitrate coverages the surface sites were blocked by nitrate and caused the rate to decrease.

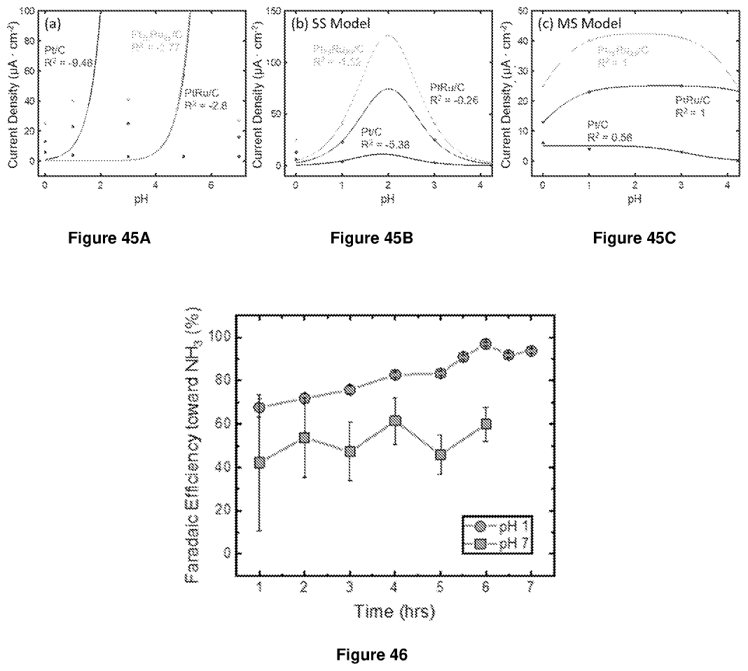

Initially, both the SSM and MSM were fit to a pH range of 0-7 to describe the C_{H} effect on rate (FIG. 45A). Similar to fitting the data to nitrate concentration, B and C fit parameters become equivalent, rendering the MSM mathematically identical to the SSM. In this analysis, pH 10 data was omitted due to potential oxide formation skewing the measured reduction currents. Results of the fitting show negative R² values, which indicate that a simple Langmuir-Hinshelwood model does not capture all the pH effects on nitrate reduction activity. Previous experiments showed that catalyst activity is dependent on C_{H} at pH<4. Thus, additional fittings were conducted between pH 0-4 for the SSM (FIG. 45B) and MSM (FIG. 45C). Although there are only three data points for each catalyst at this pH range, the MSM shows a superior fit over the SSM fit.

The kinetic models explored were simplistic and only capture direct effects of C_{H} and C_{N}, and thus cannot provide a comprehensive understanding for the effect of pH on reaction rate. For example, pH affects the adsorption equilibria of both nitrate and protons while the model assumes these equilibria to be fixed.

The fitted rate law captures that the activity for PtRu/C in pH 7 increased with nitrate concentration up to 0.4 M, but decreased at higher nitrate concentrations. For a surface reaction involving adsorbed hydrogen and adsorbed nitrate, increasing the nitrate concentration had a similar effect as increasing the nitrate adsorption strength, as both lead to higher nitrate coverages. The model provided a qualitative description of the relationship between ENO₃RR activity, nitrate adsorption energy, and nitrate concentration. Although, there was the possibility of a bifunctional (multi-site) mechanism on alloys, there was no conclusive evidence that this was the case from the kinetic modeling and thus it was postulated that only the simplest model that qualitatively describes the data.

The results in FIGS. 34 and 35 imply that the computational volcano plots and a simple Langmuir-Hinshelwood model apply qualitatively to both TNO₃RR and ENO₃RR, where the rate was related to the amount of available hydrogen and the coverage of nitrate on the surface. This similarity may be due to the two reactions sharing a common RDS or catalyst properties that control their respective RDS. However, as observed for the contrast between activity for Pt/C in ENO₃RR and TNO₃RR, there were quantitative differences in TNO₃RR and ENO₃RR.

### pH Effects on Rate and Apparent Activation Energy of PtRu/C

Despite the similar effect of hydrogen chemical potential, alloying, and nitrate concentration between TNO₃RR and ENO₃RR, there were distinct differences when considering the effect of pH and apparent activation energies (E₃), FIG. 36. TNO₃RR showed higher activity at pH 1 than pH 7 (FIG. 36A). In contrast, the ENO₃RR rates were higher at pH 7 than pH 1. These rates were consistent with the order of the E, for TNO₃RR and ENO₃RR, where the Eₐ for TNO₃RR was lower at pH 1 and the Eₐ for ENO₃RR was lower at pH 7 (FIG. 36B). The previously used volcano plots and the Langmuir-Hinshelwood models did not incorporate the effect of pH (all calculations implicitly assume pH=0).

Without intending to be bound by theory, it is believed that the higher activity and lower Eₐ observed for TNO₃RR at lower pH was most likely because it is easier for nitrite to either decompose or hydrogenate to other products in acidic conditions. At low pH, literature has indicated higher nitrite hydrogenation TOF rates through increased surface coverage of reaction intermediates, such as *NO and *HNO.⁴⁵ The Eₐ for TNO₃RR at pH 7 was 45 kJ mol⁻¹, similar to that of measurements of Pt group metals in neutral solution. The lower Eₐ at pH 1 than pH 7 may arise from more favorable intermediate conversion to ammonia at low pH. It is also possible that the pH (and corresponding changes in the electrochemical double layer) affects the adsorption of nitrate, which would influence the rate.

The shift in activity and Eₐ for ENO₃RR with pH was more challenging to deconvolute than for TNO₃RR. This change in activity may either be due to a different RDS entirely at the different pH values or the same RDS, but with different coverages of the intermediates. Although the pH may affect nitrate adsorption energy and thus the reaction rate because the effect of pH is opposite for TNO₃RR than ENO₃RR, other pH effects likely play a role in the reaction. Similarly, the conversion of nitrite being faster at lower pH values (as described above for TNO₃RR) does not explain the trend in pH for ENO₃RR.

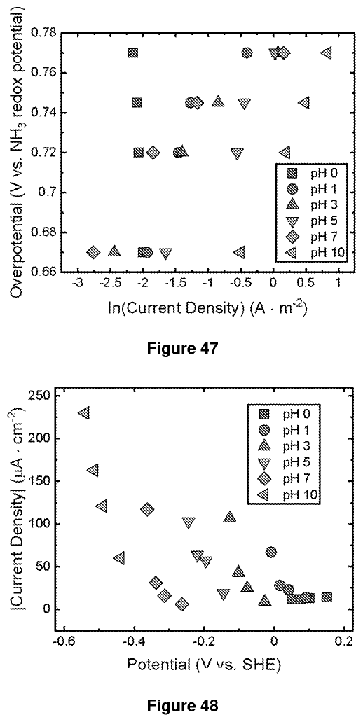

Previous reports hypothesize a mechanistic shift occurs with an increase in the pH of the electrolyte solution for ENO₃RR. In acidic media, the concentration of H⁺ correlated to the nitrate reduction activity. As the pH increased, the reaction stopped being dependent on H⁺, and the hydrogen source was provided from H₂O. Similarly, in the results, the FE for ENO₃RR changed from 93% at pH 1 to 54% at pH 7 (FIG. 36B and FIG. 46). Additional Tafel analysis provided limited insights on the mechanism due to the limited range of testing potentials (FIG. 47). However, previous literature indicated that this change is likely due to the reaction favoring an ammonia production mechanism at pH 1 and favoring a nitrogen production mechanism at more basic pH.

The FE of PtRu/C towards NH₃ at pH 1 and pH 7 are shown in FIG. 46. The reactions were performed at 0.1 V vs. RHE for at least 6 hrs. The FE reaches ˜93% at pH 1 after 5.5 hrs, whereas the FE reaches ˜54% at pH 7 after 3 hrs. The increase in the measured FE over time can be attributed to many factors. Because the measurements were performed in a batch reactor on a porous carbon felt, diffusion limitations may have delayed the transport of the products to the bulk solution. It is also possible that some intermediates were forming on the surface of the felt but reacting slowing, which resulted in high FE towards ammonia once the intermediates react. The reported FE was the averaged last four time points in each experiment. A Tafel analysis for the pH effect for PtRu/C was performed (FIG. 47). This analysis showed that there were significant differences between all the pH tested, but the results were inconclusive regarding the mechanism. This is possibly due to the narrow range of tested potentials.

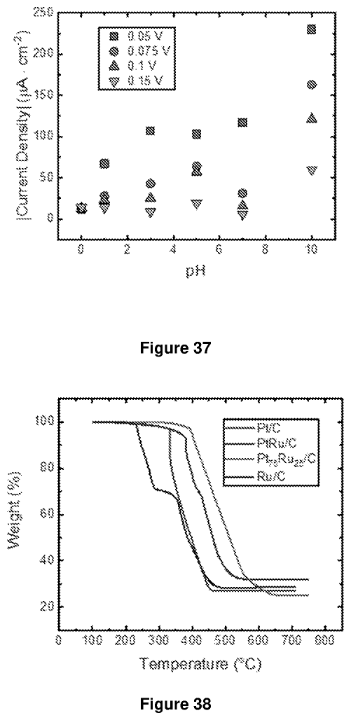

The PtRu/C current densities for ENO₃RR for pH 0-10 at four different operating potentials vs. RHE are shown in FIG. 37. These results show that as the electrolyte pH increases, the ENO₃RR activity of PtRu/C increases, with a slight decrease or plateau at pH 7, which may be due to effects from the reaction environment or changes in the catalyst due to pH. By examining the absolute current densities as a function of the potential vs. SHE, similar trends were observed that as the pH increased, the current densities for nitrate reduction increased (FIG. 48). Without intending to be bound by theory, it is believed that at pH 10, where the current densities are the highest, the catalyst may be forming Ru oxides above pH 9 that are artificially inflating the reduction currents. It is also possible that the high activity results from favorable Ru lattice strains from subsurface oxide formation. While XPS surface characterization of the catalyst before and after an extended 8-hour steady-state electrochemical experiment at 0.1 V vs. RHE and pH 10 showed marginally lower amounts of surface Ru, the low intensity of the spectra makes it difficult to deconvolute for Ru oxidation peaks (FIG. 49). After normalization, the spectra from FIG. 49 show that both surface Pt and Ru content marginally decreased after an extended run. The low intensity of the peaks from the measurements also makes it difficult to deconvolute Ru 3p for the oxidation states. A previous study of ENO₃RR on Rh and Pt reported that the reduction rate decreases with the concentration of hydronium ions decreasing from pH 0 to 4, which is opposite to what was observed for PtRu/C. In that work, NaCl was added as the pH increased to maintain a constant ionic strength of the electrolyte. Because chloride is known to inhibit both Pt and Rh for ENO₃RR, the previously reported decrease in activity may be due to increasing chloride inhibition of catalyst sites, not the change in pH. It is possible that the ionic strength of the solution in the present response was affecting the reduction currents and needs to be accounted for to obtain an accurate pH effect analysis. FIG. 47 provides the ionic strength of the buffer solutions at each pH, ranging from 0.25 (pH 1) up to 2.5 M (pH 0). The ionic strengths vary from different pH solutions, but do not match the activity trends observed in FIG. 37, and so were not the sole cause of the pH effect.

The effect of pH on other electrocatalytic reactions has been studied extensively, and some of the findings for other reactions may be applied to ENO₃RR. Hydrogen binding energy is one proposed factor in which pH influences catalytic activity, but other effects, such as the ionic strength of the buffer, hydrogen equilibrium potential, point of zero free charge (pzfc), and water orientation and reorganization energy, can also influence the activity. For hydrogen evolution, the activities for Pt group metals are much higher at lower pH values, but the reason is debated in several recent reviews and publications. This enhancement is the opposite direction of what was observed for ENO₃RR. Oxygen reduction reaction (ORR) is more complicated, with ORR activity on Pt(111) increasing as the pH increases from 1 to 6 and decreasing with increasing pH past 11 and a predicted maximum at pH 9. This trend is attributed to the ORR onset potential being positive and negative with respect to the pzfc of the electrode in acidic and basic solution, respectively, causing the switch in pH dependence. For ENO₃RR on PtRu/C, there seems to be a maximum with pH similar to ORR, but the ENO₃RR maximum occurs at pH 5 (excluding potential oxide effects at pH 10). Thus, one possible cause of the pH dependence of ENO₃RR could be differences in the surface charge of the electrode.

Although a Langmuir-Hinshelwood model describes some of the reaction data, it does not adequately capture the effects of pH and the buffer solutions on the activity (FIG. 45), indicating a lack of mechanistic understanding of these effects. In addition, in-situ spectroscopy to detect surface intermediates and computational simulations that include the influence of pH are necessary to understand this reaction better. Particularly, electrochemical-specific considerations need to be addressed to accurately model the effect of pH for ENO₃RR, as the effect of pH is different from what is observed for TNO₃RR.

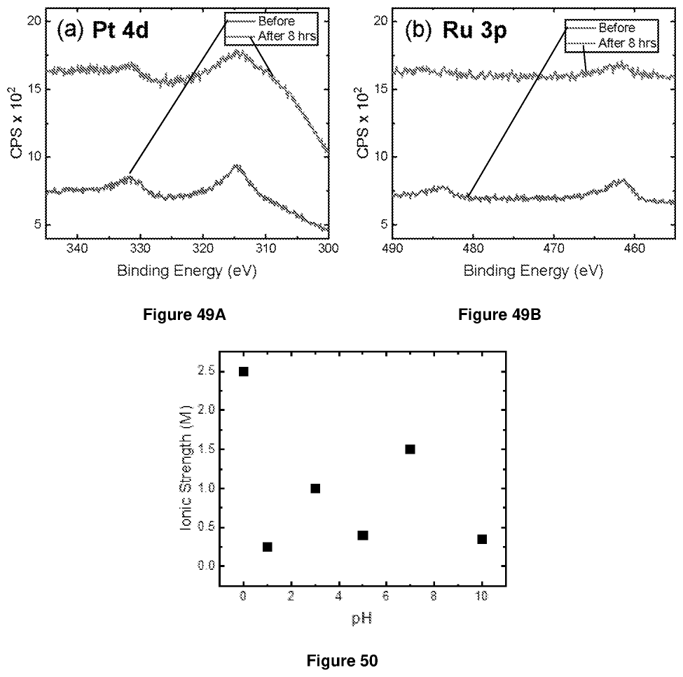

For all the ENO₃RR measurements in different pH, different buffer solutions were prepared to ensure that the pH of the solution remains constant throughout the reaction. However, the ionic strength of the solution can also influence the reduction currents. FIG. 50 displays the calculated ionic strength of all the buffer solutions prepared for the pH experiments, and shows a large variation between 0.25-2.5 M for different electrolytes. However, the pH trends do not match the ionic strengths of the solution, implying that other effects, such as hydrogen equilibrium potential,⁶ the point of zero free charge (pzfc),⁷⁻⁹ and water orientation and interfacial solvent reorganization energy, may also influence the current measurements with varying pH.

### Net Changes in PH During Reaction

The balanced full-cell nitrate to ammonia reaction for ENO₃RR is:

$${NO}_{3 ( aq )}^{-} + 9 {H}^{+} + 8 {e}^{-} ⇌ {NH}_{3 ( aq )} + 3 {H}_{2} {O}_{( l )} ; {E}^{o} = 0.82 V vs . RHE \\ 4 {H}_{2} {O}_{( l )} \to 2 {O}_{2 ( g )} + 8 {e}^{-} + 8 {H}^{+} ; {E}^{o} = 1.23 V vs . RHE$$

Here it is assumed that oxygen evolution is the anodic reaction. The net reaction is:

$${NO}_{3 ( aq )}^{-} + {H}^{+} + {H}_{2} {O}_{( l )} \to {NH}_{3 ( aq )} + 2 {O}_{2 ( g )}$$

For TNO₃RR, if the hydrogen is produced from water electrolysis the reaction is:

$$8 {e}^{-} + 8 {H}^{+} ⇌ 4 {H}_{2 ( g )} ; {E}^{o} = 0 V vs . RHE \\ 4 {H}_{2} {O}_{( l )} \to 2 {O}_{2 ( g )} + 8 {e}^{-} + 8 {H}^{+} ; {E}^{o} = 1.23 V vs . RHE$$

The TNO₃RR using this hydrogen is:

$${H}^{+} + {NO}_{3 ( aq )}^{-} + 4 {H}_{2 ( g )} ⇌ {NH}_{3 ( aq )} + 3 {H}_{2} {O}_{( l )}$$

Thus, the net reaction is the same as ENO₃RR if H₂ comes from water electrolysis:

$${NO}_{3 ( aq )}^{-} + {H}^{+} + {H}_{2} {O}_{( l )} ⇌ {NH}_{3 ( a q )} + 2 {O}_{2 ( g )}$$

Therefore, in both cases one net proton would be consumed per ammonia produced, requiring a balancing to maintain a constant pH. Although more than one proton is required for ENO₃RR half-cell reaction, all but one proton is provided from the anodic reaction, which in a commercial system would be via a proton conducting membrane. Without a sufficiently conductive or selective membrane, a local pH gradient may build up at the cathode compartment in a commercial system.

Many modifications and other embodiments disclosed herein will come to mind to one skilled in the art to which the disclosed compositions and methods pertain having the benefit of the teachings presented in the foregoing descriptions. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation.

It is also to be understood that the terminology used herein is for the purpose of describing particular aspects only and is not intended to be limiting. As used in the specification and in the claims, the term “comprising” can include the aspect of “consisting of.” Unless defined otherwise, all technical and scientific terms used herein have the same meaning as commonly understood by one of ordinary skill in the art to which the disclosed compositions and methods belong. In this specification and in the claims which follow, reference will be made to a number of terms which shall be defined herein.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

The use of the terms “a,” “an,” “the,” and similar referents in the context of the disclosure herein (especially in the context of the claims) are to be construed to cover both the singular and the plural, unless otherwise indicated. Recitation of ranges of values herein merely are intended to serve as a shorthand method of referring individually to each separate value falling within the range, unless otherwise indicated herein, and each separate value is incorporated into the specification as if it were individually recited herein. The use of any and all examples, or exemplary language (e.g., “such as”) provided herein, is intended to better illustrate the disclosure herein and is not a limitation on the scope of the disclosure herein unless otherwise indicated. No language in the specification should be construed as indicating any non-claimed element as essential to the practice of the disclosure herein.

### Example 7—Electrochemical Reactor

### Electrocatalyst Preparation.

Supported nanoparticle catalysts were prepared as inks and deposited on a glassy carbon rotating disk electrode (RDE, Pine Research Inst., Inc) or a carbon felt (6.35 mm thick, 99.0%, Alfa Aesar). 30 wt % Pt/C, 20 wt % Rh/C, and 30 wt % PtRu/C were used as catalysts. For all inks, a 5 wt % Nafion in alcohol solution (Sigma Aldrich) was used as the binder. The catalyst was pre-treated before being used for flow cell measurements.

### Electrochemically Active Surface Area.

The electrochemically active surface area (ECSA) was measured using hydrogen underpotential deposition (H_{upd}) on Pt/C, Rh/C, and PtRu/C. Copper underpotential deposition (Cu_{upd}) was only measured on PtRu/C in the batch cell configuration. The ECSA for normalizing current was measured prior to each electrochemical measurement (each current density has an ECSA value). The potential range was 0.05 to 0.8 V vs. RHE for Rh/C and 0.05 V to 1.0 V vs. RHE for Pt/C and PtRu/C.

### Electrocatalytic Nitrate Reduction Reaction Measurements.

Nitrate reduction measurements were taken at a constant potential for 20 minutes on a VSP or SP 150 potentiostat using EC-Lab software (BioLogic, Inc.). In the both the batch and flow cell, the current density reported was from the average current during the last 5 minutes of the measurement. In the batch cell with the catalysts deposited on a RDE, 85% iR compensation was applied during the measurement and the correction was less than 1 mV. iR correction for the flow cell measurements was applied after measurement; the series resistance was ˜0.05Ω for all catalysts in 0.1 M H₂SO₄ and 0.1 M HNO₃. For the flow cell, a sample of the outlet solution was taken during the last 5 minutes of the measurement. The electrolytes for the working and counter electrode compartments were held in 60 mL plastic syringes and flowed through the electrochemical cell using a syringe pump (LongerPump® model LSP02-1B). The electrolyte was sparged with N₂ for 1 hour prior to being drawn into the syringe. The electrolyte in the syringe was degassed by drawing a slight vacuum by pulling the plunger, tapping on the side of the syringe, and releasing the gases that accumulated at the opening of the syringe. Degassing was performed until the amount of gas at the opening of the syringe was negligible. The solution in the syringes was degassed to prevent formation of gas pockets (of O₂ or H₂) within the electrochemical cell or carbon felt during operation which could lower the available surface area for reaction or increase the cell potential.

### Product Quantification and Faradaic Efficiency Towards Ammonium.

The samples for constant potential measurements were collected in a scintillation vial at the outlet of the flow cell over the last 5 minutes of the measurement. For Faradaic efficiency analysis, the currents from one residence time prior to sample collection time were used. UV-Vis spectroscopy was used for ammonium (NH₄⁺) quantification. Ammonium itself is not active in the UV-Vis range, therefore the salicylate colorimetric method was used.

### Flow Reactor Setup and Testing

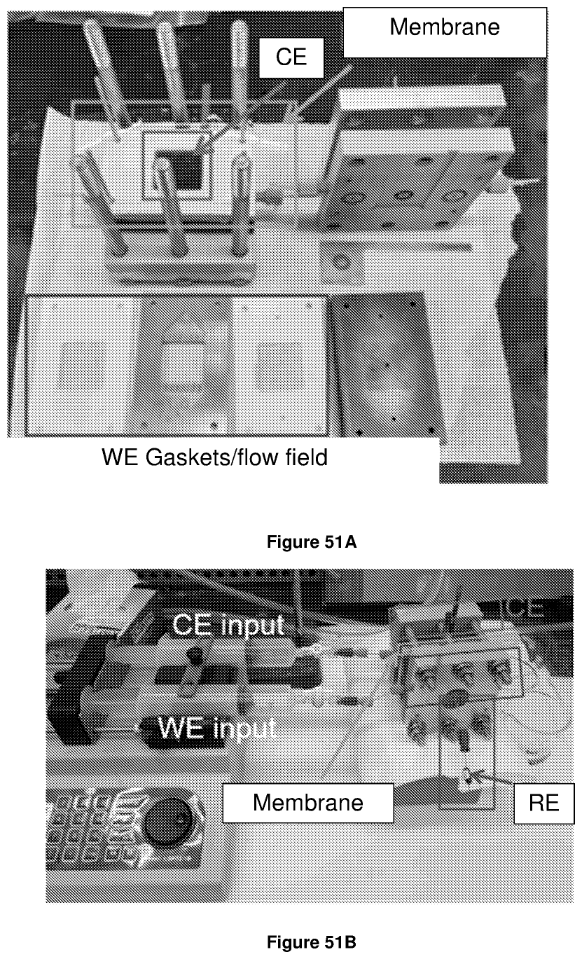

The electrochemical flow reactor had two compartments (working and counter/cathode and anode) and a connection for a reference electrode (RE) (working electrode (WE) compartment) as shown in FIGS. 51A and 51B. The flow cell comprises of two end plates, two PEEK plates with O-rings, two current collectors, two Cu flags to establish connection to the potentiostat from the electrode each compartment, two gaskets with holes for fluid flow, two flow fields, and two gaskets without holes (listed from the outside of the flow cell to the center, the flow cell is symmetric). The compartments were designed for carbon felt as electrodes due to its high surface areas and conductivity. In both compartments, flow channels were provided to help direct the electrolyte and encourage equal distribution across the compartment. The membrane prevented product crossover from one compartment to another and provided a physical separation between the WE and CE that prevented short circuiting.

A IrO₂ paper was also used as a CE alongside the unmodified carbon felt to lower the overpotential for oxygen evolution (and total cell potential). The carbon felt and IrO₂ paper CE was loaded into the counter electrode compartment and then covered with a Nafion 117 membrane which had been stored in Millipore water for at least 24 hours prior. The working electrode compartment was then constructed similarly using the prepared WE felt. The electrolyte was flowed through the flow cell for twice the residence time prior to electrochemical measurements. From open circuit voltage (˜700 mV vs. RHE for Pt/C and Rh/C in 0.1 M H₂SO₄), for the first measurement, the potentiostat had difficulty applying a potential or performing a cyclic voltammogram. To avoid this, the catalyst was pre-conditioned before use.

Load PtRu Catalyst onto High Surface Carbon Felt

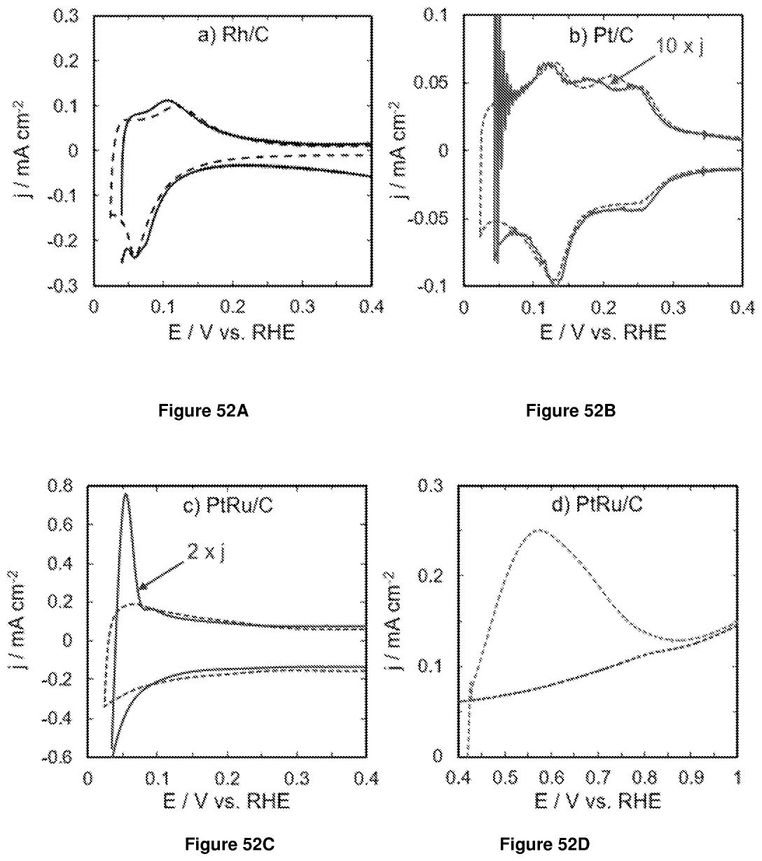

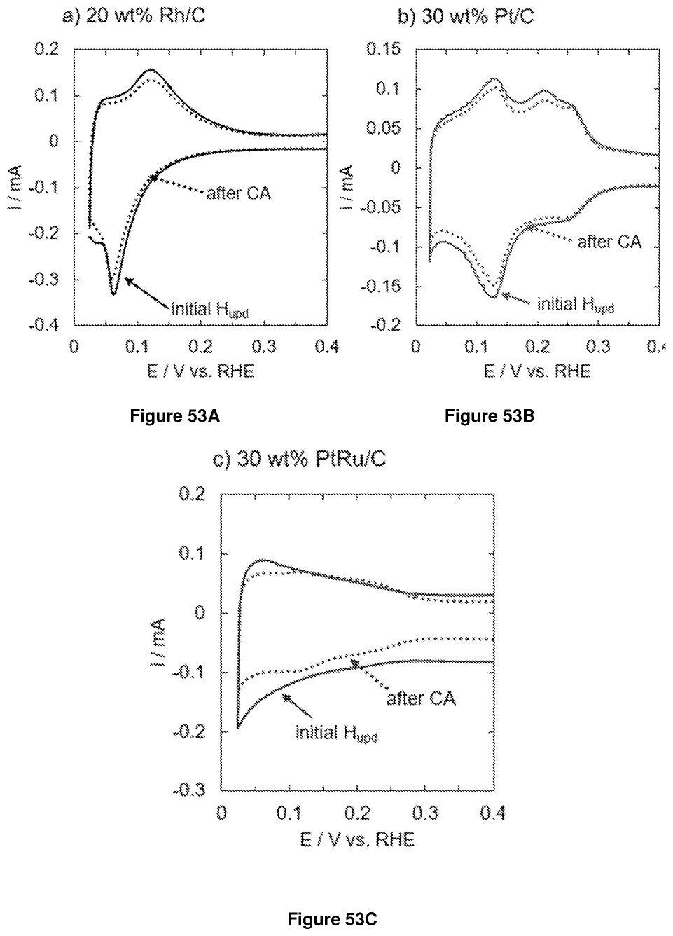

Measuring the electrochemical surface area is imperative to compare the catalyst performance in the batch RDE system and the carbon felt flow cell system. ECSAs were determined for catalysts in the batch RDE system and the flow cell system while loaded on a carbon felt using the method developed here. FIGS. 53A-52C show typical H_{upd} and FIG. 52D shows a Cu_{upd} obtained when estimating the ECSAs of Rh/C, Pt/C, and PtRu/C catalysts. After normalization to the ECSA and adjusting for differences in scan rate, the current densities from H_{upd} were on the same order of magnitude between the two systems. For Rh/C and Pt/C, the characteristic hydrogen underpotential peaks were visible on both the carbon felt and RDE, even though the mass loading on the carbon felt was two to three orders of magnitude greater on the carbon felts compared to the H_{upd} region when measured in the flow cell.

The fraction of catalyst that is electrochemically active was higher on the RDE than on the carbon felt for all catalysts tested (Table 7). The catalysts deposited onto the felt have lower ECSA per mass loaded when deposited due to catalyst loss on the felts, parts of the catalyst may not be accessible to the electrolyte due to packing of the catalyst on the felt, and underestimation of ECSA using H_{upd} for catalyst in the felts. The felt loading is estimated by subtracting the mass of catalyst that does not adhere to the felt (collected after deposition) by the total mass of catalyst attempted to be deposited onto the felt. Though an ionomer binder was used during catalyst deposition on to the carbon felts, the catalyst nanoparticles can be knocked loose from the felt during the reaction and were observed in the outlet collection reservoir after the experiment. Catalyst loss on the felts would underestimate the ECSA per mass for the carbon felts with catalyst. Additionally, over-packing electrocatalyst ink on the carbon felt could reduce the active material available to the solution by creating catalyst ink layers, where the bottom layer does not contact the solution.

TABLE 7
Catalyst loading (metal only) onto RDE and felt, electrochemically
active surface area from H_{upd} or Cu_{upd}, and ECSA per mass loaded.
RDE geometric area is 0.196 cm² and felt geometric area is 5.52 cm².

| | RDE | | ECSA | | ECSA | | Felt | | ECSA | | ECSA | |
|---|---|---|---|---|---|---|---|---|---|---|---|---|
| Catalyst | loading | | from RDE | | per mass | | loading | | from felt | | per mass | |
| 20 wt % Rh/C | 2.9 | μg | 2.3 | cm² | 78.1 | m²/g | 2.0 | mg | 142 | cm² | 34.6 | m²/g |
| 30 wt % Pt/C | 1.9 | μg | 2.0 | cm² | 105.3 | m²/g | 5.5 | mg | 1012 | cm² | 60.6 | m²/g |
| 30 wt % PtRu/C | 1.9 | μg | 1.2 | cm² | 63.7 | m²/g | 3.3 | mg | 374 | cm² | 37.8 | m²/g |

All three catalysts lose ECSA during nitrate reduction, but PtRu/C was observed to especially undergo preferential Ru dissolution. FIG. 53 shows the H_{upd} currents observed on each catalysts before and after 20 minutes of chronoamperometry at 0.1 V vs. RHE in the batch RDE system. The Rh/C and Pt/C begin with ECSAs of 2.26 cm² and 2.00 cm² but decrease by 7-18% (to 1.84 cm² for Rh/C and 1.86 cm² for Pt/C) after 20 minutes of measurements. Using H_{upd} to estimate the ECSA, the PtRu/C begins with 0.76 cm² and increases to 0.95 cm² after nitrate reduction. In FIG. 53C, the H_{upd} currents decrease at the adsorption potentials (0-0.3 V vs. RHE) and the overall increase in ECSA is due to the decrease of charge in the double-layer (measured at 0.4 V vs. RHE) and changing of the electrode surface.

Without intending to be bound by theory, it is believed that the ECSA loss may be related to poisoning of intermediates, surface restructuring, or mechanical loss. To address the issue of varying ECSA for kinetic measurements, the ECSA was measured before and after kinetic measurements to account for the decrease in available surface area. Between prior to and between sequential nitrate reduction measurements, the electrodes were cycled between oxidative and reductive potentials to clean the electrode surface, which for PtRu/C would cause Ru dissolution during the cleaning procedure.

### Initial Ammonia Production Quantification as a Function of Potential in Flow Conditions

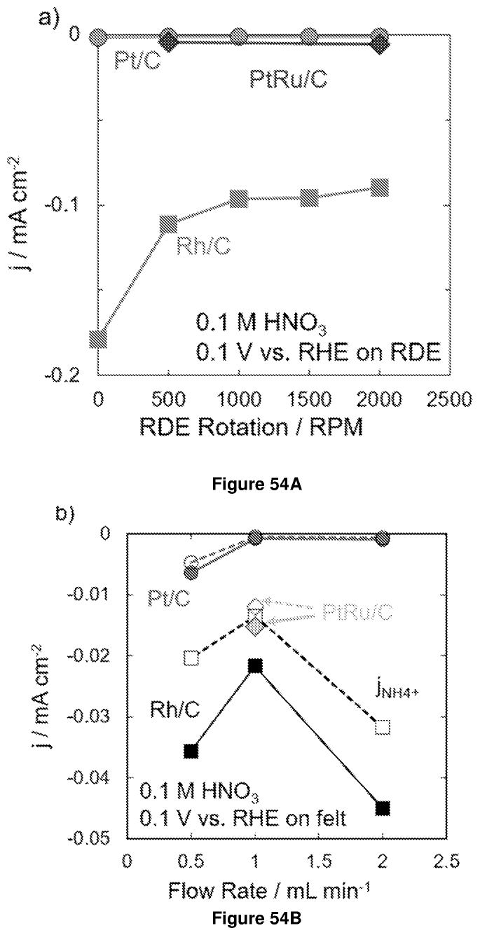

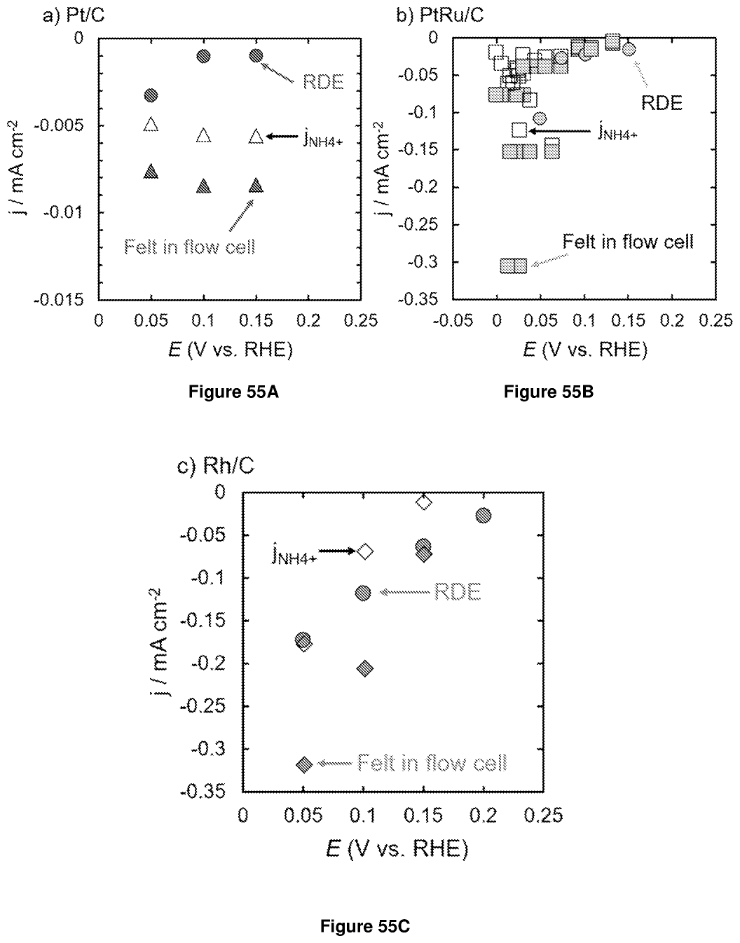

The current densities at a given potential did not match for all catalysts between those in the RDE and those in the flow cell. Within the flow cell activity sets, there was large uncertainty in the value reported (e.g., Rh/C at 0.1 V vs. RHE at 2 mL/min is 4-5 times greater in FIG. 54 compared to what is reported in FIG. 55) even though the data was collected and analyzed similarly. For RDE experiments, the currents densities for each catalyst measured at the same conditions were closer (less 25% of their total value different). The current density on Pt/C on the RDE in FIG. 54A ranged from −0.002 to −0.001 mA cm⁻², with higher rates at lower rotation rates, while the current density in the flow cell ranged from −0.006 to −0.001 mA cm⁻², with higher rates at slower flow rates. Slower mass transport could result in a concentration gradient near the electrode surface, e.g., depletion of nitrate and protons. Without intending to be bound by theory, it is believed that the local pH increase and nitrate concentration decrease may cause the differences in the reduction rate on the different catalysts. For PtRu/C, on the RDE the current densities were approximately −0.005 mA cm⁻², while in the flow cell the current densities are approximately −0.015 mA cm⁻². This is attributable to the normalization of the activity, since the RDE measurements were normalized based on the H_{upd} ECSA, while the flow cell was normalized based on the dispersion. On Rh/C, the current densities in the RDE were higher than in the flow cell at 0.1 V vs. RHE. Similar to Pt/C, the higher current densities for Rh/C on the RDE may be due to mass transport at the electrode in the different cell configurations. Ultimately, the difference in magnitude between the RDE and the flow cell current densities could be attributed to the ECSA normalization for the measurements in the flow cell.

The activity trends on an RDE (Pt/C<PtRu/C<Rh/C) match those in the flow cell. In FIG. 54A, under all rotation conditions Rh/C was the most active, followed by PtRu/C, then Pt/C. The same trends were seen in the flow cell in FIG. 54B. The effect of potential was qualitatively similar in the RDE as in the flow cell on PtRu/C and Rh/C, but different on Pt/C. On Pt/C, with the RDE as the potential became more negative the activity increased, but in the flow cell as the potential became more negative the activity decreased slightly. The difference in the potential dependence on Pt/C implies that one or both of the observed activity measurements are not intrinsic kinetics (i.e., one or both are limited by mass transport). Without intending to be bound by theory, it is believed that RDE measurements are at sufficiently high transport that they are not mass transfer limited. The flow cell may be transport limited due to the low flow rates achievable with the syringe pump.

### Results for Ammonia Production

The highest rate of ammonia production in the flow cell was with Rh/C at 0.05 V vs. RHE with a flow rate of 2 mL/min with a nitrate reduction current density to ammonia of −0.18 mA/cm² normalized to the Rh surface area and −105 mA/cm² normalized to the geometric surface area (electrolyzer area).

The foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In the case of conflict, the present description, including definitions, will control.

Throughout the specification, where the compounds, compositions, methods, and/or processes are described as including components, steps, or materials, it is contemplated that the compounds, compositions, methods, and/or processes can also comprise, consist essentially of, or consist of any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

### REFERENCES

[1] S. Garcia-Segura, M. Lanzarini-Lopes, K. Hristovski, P. Westerhoff, Electrocatalytic reduction of nitrate: Fundamentals to full-scale water treatment applications, Appl. Catal. B Environ. 236 (2018) 546-568. https://doi.org/10.1016/j.apcatb.2018.05.041.
[2] N. Lehnert, H. T. Dong, J. B. Harland, A. P. Hunt, C. J. White, Reversing nitrogen fixation, Nat. Rev. Chem. 2 (2018) 278-289. https://doi.org/10.1038/s41570-018-0041-7.
[3] J. J. Schoeman, A. Steyn, Nitrate removal with reverse osmosis in a rural area in South Africa, Desalination. 155 (2003) 15-26. https://doi.org/10.1016/SO011-9164(03)00235-2.
[4] O. Primo, M. J. Rivero, A. M. Urtiaga, I. Ortiz, Nitrate removal from electro-oxidized landfill leachate by ion exchange, J. Hazard. Mater. 164 (2009) 389-393. https://doi.org/10.1016/j.jhazmat.2008.08.012.
[5] H. Chen, D. Wang, X. Li, Q. Yang, G. Zeng, Enhancement of post-anoxic denitrification for biological nutrient removal: effect of different carbon sources, Environ. Sci. Pollut. Res. 22 (2015) 5887-5894. https://doi.org/i0.1007/s11356-014-3755-1.
[6] Y. Zhong, X. Li, Q. Yang, D. Wang, F. Yao, X. Li, J. Zhao, Q. Xu, C. Zhang, G. Zeng, Complete bromate and nitrate reduction using hydrogen as the sole electron donor in a rotating biofilm-electrode reactor, J. Hazard. Mater. 307 (2016) 82-90. https://doi.org/10.1016/j.jhazmat.2015.12.053.
[7] X. Li, H. Chen, Q. Yang, D. Wang, K. Luo, G. Zeng, Biological nutrient removal in a sequencing batch reactor operated as oxic/anoxic/extended-idle regime, Chemosphere. 105 (2014) 75-81. https://doi.org/10.1016/j.chemosphere.2013.12.043.
[8] Z. Bao, Q. Hu, W. Qi, Y. Tang, W. Wang, P. Wan, J. Chao, X. J. Yang, Nitrate reduction in water by aluminum alloys particles, J. Environ. Manage. 196 (2017) 666-673. https://doi.org/10.1016/j.jenvman.2017.03.080.
[9] D. P. Durkin, T. Ye, J. Choi, K. J. T. Livi, H. C. D. Long, P. C. Trulove, D. H. Fairbrother, L. M. Haverhals, D. Shuai, Sustainable and scalable natural fiber welded palladium-indium catalysts for nitrate reduction, Appl. Catal. B Environ. 221 (2018) 290-301. https://doi.org/10.1016/j.apcatb.2017.09.029.
[10] T. Ye, D. P. Durkin, N. A. Banek, M. J. Wagner, D. Shuai, Graphitic Carbon Nitride Supported Ultrafine Pd and Pd-Cu Catalysts: Enhanced Reactivity, Selectivity, and Longevity for Nitrite and Nitrate Hydrogenation, ACS Appl. Mater. Interfaces. 9 (2017) 27421-27426. https://doi.org/10.1021/acsami.7b09192.
[11] L. Su, K. Li, H. Zhang, M. Fan, D. Ying, T. Sun, Y. Wang, J. Jia, Electrochemical nitrate reduction by using a novel Co3O4/Ti cathode, Water Res. 120 (2017) 1-11. https://doi.org/10.1016/j.watres.2017.04.069.
[12] K. Shimazu, R. Goto, K. Tada, Electrochemical Reduction of Nitrate Ions on Tin-Modified Platinum and Palladium Electrodes, Chem. Lett. 31 (2002) 204-205. https://doi.org/10.1246/cl.2002.204.
[13] S. Ghafari, M. Hasan, M. K. Aroua, Bio-electrochemical removal of nitrate from water and wastewater-A review, Bioresour. Technol. 99 (2008) 3965-3974. https://doi.org/10.1016/j.biortech.2007.05.026.
[14] F. Rezvani, M.-H. Sarrafzadeh, S. Ebrahimi, H.-M. Oh, Nitrate removal from drinking water with a focus on biological methods: a review, Environ. Sci. Pollut. Res. 26 (2019) 1124-1141. https://doi.org/10.1007/s11356-017-9185-0.
[15] T. Osaka, K. Shirotani, S. Yoshie, S. Tsuneda, Effects of carbon source on denitrification efficiency and microbial community structure in a saline wastewater treatment process, Water Res. 42 (2008) 3709-3718. https://doi.org/10.1016/j.watres.2008.06.007.
[16] D. Xu, Y. Li, L. Yin, Y. Ji, J. Niu, Y. Yu, Electrochemical removal of nitrate in industrial wastewater, Front. Environ. Sci. Eng. 12 (2018) 9. https://doi.org/10.1007/s11783-018-1033-z.
[17] F. Yao, Q. Yang, Y. Zhong, X. Shu, F. Chen, J. Sun, Y. Ma, Z. Fu, D. Wang, X. Li, Indirect electrochemical reduction of nitrate in water using zero-valent titanium anode: Factors, kinetics, and mechanism, Water Res. 157 (2019) 191-200. https://doi.org/10.1016/j.watres.2019.03.078.
[18] M. Duca, M. T. M. Koper, Powering denitrification: the perspectives of electrocatalytic nitrate reduction, Energy Environ. Sci. 5 (2012) 9726-9742. https://doi.org/10.1039/C2EE23062C.
[19] N. Singh, B. R. Goldsmith, Role of Electrocatalysis in the Remediation of Water Pollutants, ACS Catal. (2020) 3365-3371. https://doi.org/10.1021/acscatal.9b04167.
[20] I. Sanjuán, L. Garcia-Cruz, J. Solla-Gullón, E. Expósito, V. Montiel, Bi-Sn nanoparticles for electrochemical denitrification: activity and selectivity towards N2 formation, Electrochimica Acta. 340 (2020) 135914. https://doi.org/10.1016/j.electacta.2020.135914.
[21] J. M. McEnaney, S. J. Blair, A. C. Nielander, J. A. Schwalbe, D. M. Koshy, M. Cargnello, T. F. Jaramillo, Electrolyte Engineering for Efficient Electrochemical Nitrate Reduction to Ammonia on a Titanium Electrode, ACS Sustain. Chem. Eng. 8 (2020) 2672-2681. https://doi.org/10.1021/acssuschemeng.9b05983.
[22] J. Li, G. Zhan, J. Yang, F. Quan, C. Mao, Y. Liu, B. Wang, F. Lei, L. Li, A. W. M. Chan, L. Xu, Y. Shi, Y. Du, W. Hao, P. K. Wong, J. Wang, S.-X. Dou, L. Zhang, J. C. Yu, Efficient Ammonia Electrosynthesis from Nitrate on Strained Ruthenium Nanoclusters, J. Am. Chem. Soc. (2020) jacs.0c00418. https://doi.org/10.1021/jacs.0c00418.
[23] A. S. Fajardo, P. Westerhoff, C. M. Sanchez-Sanchez, S. Garcia-Segura, Earth-abundant elements a sustainable solution for electrocatalytic reduction of nitrate, Appl. Catal. B Environ. 281 (2021) 119465. https://doi.org/10.1016/j.apcatb.2020.119465.
[24] G. E. Dima, A. C. A. de Vooys, M. T. M. Koper, Electrocatalytic reduction of nitrate at low concentration on coinage and transition-metal electrodes in acid solutions, J. Electroanal. Chem. 554-555 (2003) 15-23. https://doi.org/10.1016/S0022-0728(02)01443-2.
[25] J.-X. Liu, D. Richards, N. Singh, B. R. Goldsmith, Activity and Selectivity Trends in Electrocatalytic Nitrate Reduction on Transition Metals, ACS Catal. 9 (2019) 7052-7064. https://doi.org/10.1021/acscatal.9b02179.
[26] 1 Year Rhodium Prices and Price Charts, InfoMine. (n.d.). http://www.infomine.com/investment/metal-prices/rhodium/1-year/(accessed Jan. 14, 2020).
[27] T. F. Fuller, J. N. Harb, Electrochemical Engineering, John Wiley & Sons, 2018.
[28] Md. M. Hossain, T. Kawaguchi, K. Shimazu, K. Nakata, Reduction of nitrate on tin-modified palladium-platinum electrodes, J. Electroanal. Chem. (2020) 114041. https://doi.org/10.1016/j.jelechem.2020.114041.
[29] Y.-J. Shih, Z.-L. Wu, Y.-H. Huang, C.-P. Huang, Electrochemical nitrate reduction as affected by the crystal morphology and facet of copper nanoparticles supported on nickel foam electrodes (Cu/Ni), Chem. Eng. J. 383 (2020) 123157. https://doi.org/10.1016/j.cej.2019.123157.
[30] R. Jia, Y. Wang, C. Wang, Y. Ling, Y. Yu, B. Zhang, Boosting Selective Nitrate Electroreduction to Ammonium by Constructing Oxygen Vacancies in TiO2, ACS Catal. (2020). https://doi.org/10.1021/acscatal.9b05260.
[31] Z. A. Jonoush, A. Rezaee, A. Ghaffarinejad, Electrocatalytic nitrate reduction using Fe0/Fe3O4 nanoparticles immobilized on nickel foam: Selectivity and energy consumption studies, J. Clean. Prod. 242 (2020) 118569. https://doi.org/10.1016/j.jclepro.2019.118569.
[32] Z. Shen, D. Liu, G. Peng, Y. Ma, J. Li, J. Shi, J. Peng, L. Ding, Electrocatalytic reduction of nitrate in water using Cu/Pd modified Ni foam cathode: High nitrate removal efficiency and N2-selectivity, Sep. Purif. Technol. 241 (2020) 116743. https://doi.org/10.1016/j.seppur.2020.116743.
[33] Y. Wang, A. Xu, Z. Wang, L. Huang, J. Li, F. Li, J. Wicks, M. Luo, D.-H. Nam, C.-S. Tan, Y. Ding, J. Wu, Y. Lum, C.-T. Dinh, D. Sinton, G. Zheng, E. H. Sargent, Enhanced Nitrate-to-Ammonia Activity on Copper-Nickel Alloys via Tuning of Intermediate Adsorption, J. Am. Chem. Soc. 142 (2020) 5702-5708. https://doi.org/10.1021/jacs.9b13347.
[34] J. Yang, Y. Kwon, M. Duca, M. T. M. Koper, Combining Voltammetry and Ion Chromatography: Application to the Selective Reduction of Nitrate on Pt and PtSn Electrodes, Anal. Chem. 85 (2013) 7645-7649. https://doi.org/10.1021/ac40l571w.
[35] S. Garcia-Segura, X. Qu, P. J. J. Alvarez, B. P. Chaplin, W. Chen, J. C. Crittenden, Y. Feng, G. Gao, Z. He, C.-H. Hou, X. Hu, G. Jiang, J.-H. Kim, J. Li, Q. Li, J. Ma, J. Ma, A. B. Nienhauser, J. Niu, B. Pan, X. Quan, F. Ronzani, D. Villagran, T. D. Waite, W. S. Walker, C. Wang, M. S. Wong, P. Westerhoff, Opportunities for nanotechnology to enhance electrochemical treatment of pollutants in potable water and industrial wastewater—a perspective, Environ. Sci. Nano. 7 (2020) 2178-2194. https://doi.org/10.1039/DOEN00194E.
[36] A. S. Arico, P. L. Antonucci, E. Modica, V. Baglio, H. Kim, V. Antonucci, Effect of PtRu alloy composition on high-temperature methanol electro-oxidation, Electrochimica Acta. 47 (2002) 3723-3732. https://doi.org/10.1016/S0013-4686(02)00342-0.
[37] B. Ravel, M. Newville, ATHENA, ARTEMIS, HEPHAESTUS: data analysis for X-ray absorption spectroscopy using IFEFFIT, J. Synchrotron Radiat. 12 (2005) 537-541. https://doi.org/10.1107/SO909049505012719.
[38] J. J. Rehr, J. J. Kas, F. D. Vila, M. P. Prange, K. Jorissen, Parameter-free calculations of X-ray spectra with FEFF9, Phys. Chem. Chem. Phys. 12 (2010) 5503-5513. https://doi.org/10.1039/B926434E.
[39] M. Newville, IFEFFIT: interactive XAFS analysis and FEFF fitting, J. Synchrotron Radiat. 8 (2001) 322-324. https://doi.org/10.1107/S0909049500016964.
[40] J. V6gh, The analytical form of the Shirley-type background, J. Electron Spectrosc. Relat. Phenom. 46 (1988) 411-417. https://doi.org/10.1016/0368-2048(88)85038-2.
[41] S. Moniri, T. Van Cleve, S. Linic, Pitfalls and best practices in measurements of the electrochemical surface area of platinum-based nanostructured electro-catalysts, J. Catal. 345 (2017) 1-10. https://doi.org/10.1016/j.jcat.2016.11.018.
[42] G. Kresse, J. Hafner, Ab initio molecular-dynamics simulation of the liquid-metal-amorphous-semiconductor transition in germanium, Phys. Rev. B. 49 (1994) 14251-14269. https://doi.org/10.1103/PhysRevB.49.14251.
[43] G. Kresse, J. Furthmuller, Efficient iterative schemes for ab initio total-energy calculations using a plane-wave basis set, Phys. Rev. B. 54 (1996) 11169-11186. https://doi.org/10.1103/PhysRevB.54.11169.
[44] G. Kresse, D. Joubert, From ultrasoft pseudopotentials to the projector augmented-wave method, Phys. Rev. B. 59 (1999) 1758-1775. https://doi.org/10.1103/PhysRevB.59.1758.
[45] J. P. Perdew, K. Burke, M. Ernzerhof, Generalized Gradient Approximation Made Simple, Phys. Rev. Lett. 77 (1996) 3865-3868. https://doi.org/10.1103/PhysRevLett.77.3865.
[46] H. J. Monkhorst, J. D. Pack, Special points for Brillouin-zone integrations, Phys. Rev. B. 13 (1976) 5188-5192. https://doi.org/10.1103/PhysRevB.13.5188.
[47] A. Hjorth Larsen, J. Jorgen Mortensen, J. Blomqvist, I. E. Castelli, R. Christensen, M. Dulak, J. Friis, M. N. Groves, B. Hammer, C. Hargus, E. D. Hermes, P. C. Jennings, P. Bjerre Jensen, J. Kermode, J. R. Kitchin, E. Leonhard Kolsbjerg, J. Kubal, K. Kaasbjerg, S. Lysgaard, J. Bergmann Maronsson, T. Maxson, T. Olsen, L. Pastewka, A. Peterson, C. Rostgaard, J. Schiotz, O. SchQtt, M. Strange, K. S. Thygesen, T. Vegge, L. Vilhelmsen, M. Walter, Z. Zeng, K. W. Jacobsen, The atomic simulation environment-a Python library for working with atoms, J. Phys. Condens. Matter Inst. Phys. J. 29 (2017) 273002. https://doi.org/10.1088/1361-648X/aa680e.
[48] S. P. Ong, W. D. Richards, A. Jain, G. Hautier, M. Kocher, S. Cholia, D. Gunter, V. L. Chevrier, K. A. Persson, G. Ceder, Python Materials Genomics (pymatgen): A robust, open-source python library for materials analysis, Comput. Mater. Sci. 68 (2012) 314-319.
[49] F. Calle-Vallejo, M. Huang, J. B. Henry, M. T. M. Koper, A. S. Bandarenka, Theoretical design and experimental implementation of Ag/Au electrodes for the electrochemical reduction of nitrate, Phys. Chem. Chem. Phys. 15 (2013) 3196-3202. https://doi.org/10.1039/C2CP44620K.
[50] G. Henkelman, B. P. Uberuaga, H. Jónsson, A climbing image nudged elastic band method for finding saddle points and minimum energy paths, J. Chem. Phys. 113 (2000) 9901-9904. https://doi.org/10.1063/1.1329672.
[51] L. Xu, H. Y. Xiao, X. T. Zu, First-principles study on the geometry and stability of CO and hydrogen coadsorption on the Ni(111)2×2 surface, Chem. Phys. 323 (2006) 334-340. https://doi.org/10.1016/j.chemphys.2005.09.041.
[52] D. Zhu, L. Zhang, R. E. Ruther, R. J. Hamers, Photo-illuminated diamond as a solid-state source of solvated electrons in water for nitrogen reduction, Nat. Mater. 12 (2013) 836-841. https://doi.org/10.1038/nmat3696.
[53] T. C. Deivaraj, J. Y. Lee, Preparation of carbon-supported PtRu nanoparticles for direct methanol fuel cell applications—a comparative study, J. Power Sources. 142 (2005) 43-49. https://doi.org/10.1016/j.jpowsour.2004.10.010.
[54] A. Jentys, Estimation of mean size and shape of small metal particles by EXAFS, Phys. Chem. Chem. Phys. 1 (1999) 4059-4063. https://doi.org/10.1039/A904654B.
[55] A. I. Frenkel, C. W. Hills, R. G. Nuzzo, A View from the Inside: Complexity in the Atomic Scale Ordering of Supported Metal Nanoparticles, J. Phys. Chem. B. 105 (2001) 12689-12703. https://doi.org/10.1021/jp012769j.
[56] H. A. Gasteiger, P. N. Ross, E. J. Cairns, LEIS and AES on sputtered and annealed polycrystalline Pt—Ru bulk alloys, Surf. Sci. 293 (1993) 67-80. https://doi.org/10.1016/0039-6028(93)90244-E.
[57] T. J. Schmidt, H. A. Gasteiger, G. D. Stab, P. M. Urban, D. M. Kolb, R. J. Behm, Characterization of High-Surface-Area Electrocatalysts Using a Rotating Disk Electrode Configuration, J. Electrochem. Soc. 145 (1998) 2354. https://doi.org/10.1149/1.1838642.
[58] R. S. Weber, Normalizing Hetereogeneous Electrocatalytic and Photocatalytic Rates, ACS Omega. 4 (2019) 4109-4112. https://doi.org/10.1021/acsomega.8b03377.
[59] K. Kinoshita, P. N. Ross, Oxide Stability and Chemisorption Properties of Supported Ruthenium Electrocatalysts, J. Electroanal. Chem. 78 (1977) 313. https://doi.org/10.1016/S0022-0728(77)80125-3.
[60] C. L. Green, A. Kucernak, Determination of the Platinum and Ruthenium Surface Areas in Platinum-Ruthenium Alloy Electrocatalysts by Underpotential Deposition of Copper. I. Unsupported Catalysts, J. Phys. Chem. B. 106 (2002) 1036-1047. https://doi.org/10.1021/jp0131931.
[61] G. E. Dima, G. L. Beltramo, M. T. M. Koper, Nitrate reduction on single-crystal platinum electrodes, Electrochimica Acta. 50 (2005) 4318-4326. https://doi.org/10.1016/j.electacta.2005.02.093.
[62] O. A. Petrii, T.Ya. Safonova, Electroreduction of nitrate and nitrite anions on platinum metals: A model process for elucidating the nature of the passivation by hydrogen adsorption, J. Electroanal. Chem. 331 (1992) 897-912. https://doi.org/10.1016/0022-0728(92)85013-S.
[63] K. S. Exner, Does a Thermoneutral Electrocatalyst Correspond to the Apex of a Volcano Plot for a Simple Two-Electron Process?, Angew. Chem. Int. Ed. 59 (2020) 10236-10240. https://doi.org/10.1002/anie.202003688.
[64] B. Hammer, J. K. Nørskov, Why gold is the noblest of all the metals, Nature. 376 (1995) 238-240. https://doi.org/10.1038/376238a0.
[65] C. T. Campbell, The Degree of Rate Control: A Powerful Tool for Catalysis Research, ACS Catal. 7 (2017) 2770-2779. https://doi.org/10.1021/acscatal.7b00115.
[66] J. F. Su, I. Ruzybayev, I. Shah, C. P. Huang, The electrochemical reduction of nitrate over micro-architectured metal electrodes with stainless steel scaffold, Appl. Catal. B Environ. 180 (2016) 199-209. https://doi.org/10.1016/j.apcatb.2015.06.028.
[67] T. Yoshioka, K. Iwase, S. Nakanishi, K. Hashimoto, K. Kamiya, Electrocatalytic Reduction of Nitrate to Nitrous Oxide by a Copper-Modified Covalent Triazine Framework, J. Phys. Chem. C. 120 (2016) 15729-15734. https://doi.org/10.1021/acs.jpcc.5b10962.
[68] M. T. de Groot, M. T. M. Koper, The influence of nitrate concentration and acidity on the electrocatalytic reduction of nitrate on platinum, J. Electroanal. Chem. 562 (2004) 81-94. https://doi.org/10.1016/j.jelechem.2003.08.011.
[1] T. C. Deivaraj, J. Y. Lee, Preparation of carbon-supported PtRu nanoparticles for direct methanol fuel cell applications—a comparative study, J. Power Sources. 142 (2005) 43-49. https://doi.org/10.1016/j.jpowsour.2004.10.010.
[2] B. Ravel, M. Newville, ATHENA, ARTEMIS, HEPHAESTUS: data analysis for X-ray absorption spectroscopy using IFEFFIT, J. Synchrotron Radiat. 12 (2005) 537-541. https://doi.org/10.1107/SO909049505012719.
[3] M. Newville, IFEFFIT: interactive XAFS analysis and FEFF fitting, J. Synchrotron Radiat. 8 (2001) 322-324. https://doi.org/10.1107/SO909049500016964.
[4] J. J. Rehr, J. J. Kas, F. D. Vila, M. P. Prange, K. Jorissen, Parameter-free calculations of X-ray spectra with FEFF9, Phys. Chem. Chem. Phys. 12 (2010) 5503-5513. https://doi.org/10.1039/B926434E.
[5] J. J. Rehr, J. A. Soininen, E. L. Shirley, Final-state rule vs the Bethe-Salpeter equation for deep-core x-ray absorption spectra, Phys. Scr. 2005 (2005) 207. https://doi.org/10.1238/Physica.Topical.115a00207.
[6] K. Mathew, C. Zheng, D. Winston, C. Chen, A. Dozier, J. J. Rehr, S. P. Ong, K. A. Persson, High-throughput computational X-ray absorption spectroscopy, Sci. Data. 5 (2018) 1-8. https://doi.org/10.1038/sdata.2018.151.
[7] A. Jentys, Estimation of mean size and shape of small metal particles by EXAFS, Phys. Chem. Chem. Phys. 1 (1999) 4059-4063. https://doi.org/10.1039/A904654B.
[8] A. I. Frenkel, C. W. Hills, R. G. Nuzzo, A View from the Inside: Complexity in the Atomic Scale Ordering of Supported Metal Nanoparticles, J. Phys. Chem. B. 105 (2001) 12689-12703. https://doi.org/10.1021/jp012769j.
[9] S. Moniri, T. Van Cleve, S. Linic, Pitfalls and best practices in measurements of the electrochemical surface area of platinum-based nanostructured electro-catalysts, J. Catal. 345 (2017) 1-10. https://doi.org/10.1016/j.jcat.2016.11.018.
[10] C. L. Green, A. Kucernak, Determination of the Platinum and Ruthenium Surface Areas in Platinum-Ruthenium Alloy Electrocatalysts by Underpotential Deposition of Copper. I. Unsupported Catalysts, J. Phys. Chem. B. 106 (2002) 1036-1047. https://doi.org/10.1021/jp0131931.
[11] J. Vé\ddot{g}h, The analytical form of the Shirley-type background, J. Electron Spectrosc. Relat. Phenom. 46 (1988) 411-417. https://doi.org/10.1016/0368-2048(88)85038-2.
[12] M. Duca, M. T. M. Koper, Powering denitrification: the perspectives of electrocatalytic nitrate reduction, Energy Environ. Sci. 5 (2012) 9726-9742. https://doi.org/10.1039/C2EE23062C.
[13] G. E. Dima, A. C. A. de Vooys, M. T. M. Koper, Electrocatalytic reduction of nitrate at low concentration on coinage and transition-metal electrodes in acid solutions, J. Electroanal. Chem. 554-555 (2003) 15-23. https://doi.org/10.1016/S0022-0728(02)01443-2.
[14] 1 Year Platinum Prices and Price Charts, InfoMine. (n.d.). http://www.infomine.com/investment/metal-prices/platinum/1-year/ (accessed Jan. 14, 2020).
[15] 1 Year Rhodium Prices and Price Charts, InfoMine. (n.d.). http://www.infomine.com/investment/metal-prices/rhodium/1-year/ (accessed Jan. 14, 2020).
[16] 1 Year Ruthenium Prices and Price Charts, InfoMine. (n.d.). http://www.infomine.com/investment/metal-prices/ruthenium/1-year/ (accessed Jan. 14, 2020).
[17] N. Singh, B. R. Goldsmith, Role of Electrocatalysis in the Remediation of Water Pollutants, ACS Catal. (2020) 3365-3371. https://doi.org/10.1021/acscatal.9b04167.
[18] USDA ERS—Fertilizer Use and Price, (n.d.). https://www.ers.usda.gov/data-products/fertilizer-use-and-price.aspx (accessed Jul. 20, 2020).
[19] J. M. McEnaney, S. J. Blair, A. C. Nielander, J. A. Schwalbe, D. M. Koshy, M. Cargnello, T. F. Jaramillo, Electrolyte Engineering for Efficient Electrochemical Nitrate Reduction to Ammonia on a Titanium Electrode, ACS Sustain. Chem. Eng. 8 (2020) 2672-2681. https://doi.org/10.1021/acssuschemeng.9b05983.
[20] J. M. Sanchez, F. Ducastelle, D. Gratias, Generalized cluster description of multicomponent systems, Phys. Stat. Mech. Its Appl. 128 (1984) 334-350. https://doi.org/10.1016/0378-4371(84)90096-7.
[21] D. Lerch, O. Wieckhorst, G. L. W. Hart, R. W. Forcade, S. Muller, UNCLE: a code for constructing cluster expansions for arbitrary lattices with minimal user-input, Model. Simul. Mater. Sci. Eng. 17 (2009) 055003. https://doi.org/10.1088/0965-0393/17/5/055003.
[22] J.-X. Liu, D. Richards, N. Singh, B. R. Goldsmith, Activity and Selectivity Trends in Electrocatalytic Nitrate Reduction on Transition Metals, ACS Catal. 9 (2019) 7052-7064. https://doi.org/10.1021/acscatal.9b02179.
[23] F. Calle-Vallejo, M. Huang, J. B. Henry, M. T. M. Koper, A. S. Bandarenka, Theoretical design and experimental implementation of Ag/Au electrodes for the electrochemical reduction of nitrate, Phys. Chem. Chem. Phys. 15 (2013) 3196. https://doi.org/10.1039/c2cp44620k.
[24] J. R. Kitchin, J. K. Nørskov, M. A. Barteau, J. G. Chen, Role of Strain and Ligand Effects in the Modification of the Electronic and Chemical Properties of Bimetallic Surfaces, Phys. Rev. Lett. 93 (2004) 156801. https://doi.org/10.1103/PhysRevLett.93.156801.
[25] I. A. W. Filot, R. A. van Santen, E. J. M. Hensen, The Optimally Performing Fischer-Tropsch Catalyst, Angew. Chem. Int. Ed. 53 (2014) 12746-12750. https://doi.org/10.1002/anie.201406521.
[26] J. K. Nørskov, J. Rossmeisl, A. Logadottir, L. Lindqvist, J. R. Kitchin, T. Bligaard, H. Jónsson, Origin of the Overpotential for Oxygen Reduction at a Fuel-Cell Cathode, J. Phys. Chem. B. 108 (2004) 17886-17892. https://doi.org/10.1021/jp047349j.
[27] D. Bessarabov, P. Millet, Chapter 3—Fundamentals of Water Electrolysis, in: D. Bessarabov, P. Millet (Eds.), PEM Water Electrolysis, Academic Press, 2018: pp. 43-73. https://doi.org/10.1016/B978-O-12-811145-1.00003-4.
[28] C. T. Campbell, The Degree of Rate Control: A Powerful Tool for Catalysis Research, ACS Catal. 7 (2017) 2770-2779. https://doi.org/10.1021/acscatal.7b00115.
(1) Baturina, O. A.; Aubuchon, S. R.; Wynne, K. J. Thermal Stability in Air of Pt/C Catalysts and PEM Fuel Cell Catalyst Layers. Chem. Mater. 2006, 18 (6), 1498-1504. https://doi.org/10.1021/cm052660e.
(2) Pinchuk, O. A.; Aubuchon, S. R.; Marks, C.; Dominey, R.; Dundar, F.; Deniz, O. F.; Ata, A.; Wynne, K. J. Thermally Pretreated 46% Pt/Vulcan XC72: Characterisation by TGA/DSC/TEM and Cyclic Voltammetry. Fuel Cells 2009, 9 (5), 554-561. https://doi.org/10.1002/fuce.200800183.
(3) Wang, Z.; Young, S. D.; Goldsmith, B. R.; Singh, N. Increasing Electrocatalytic Nitrate Reduction Activity by Controlling Adsorption through PtRu Alloying. Journal of Catalysis 2021, 395, 143-154. https://doi.org/10.1016/j.jcat.2020.12.031.
(4) Dortsiou, M.; Katsounaros, I.; Polatides, C.; Kyriacou, G. Influence of the Electrode and the PH on the Rate and the Product Distribution of the Electrochemical Removal of Nitrate. Environmental Technology 2013, 34 (3), 373-381. https://doi.org/10.1080/09593330.2012.696722.
(5) Yang, J.; Sebastian, P.; Duca, M.; Hoogenboom, T.; M. Koper, M. T. PH Dependence of the Electroreduction of Nitrate on Rh and Pt Polycrystalline Electrodes. Chemical Communications 2014, 50 (17), 2148-2151. https://doi.org/i0.1039/C3CC49224 Å.
(6) Jerkiewicz, G. Standard and Reversible Hydrogen Electrodes: Theory, Design, Operation, and Applications. ACS Catal. 2020, 10 (15), 8409-8417. https://doi.org/10.1021/acscatal.0c02046.
(7) Silva, F.; Sottomayor, M. J.; Hamelin, A. The Temperature Coefficient of the Potential of Zero Charge of the Gold Single-Crystal Electrode/Aqueous Solution Interface: Possible Relevance to Gold-Water Interactions. Journal of Electroanalytical Chemistry and Interfacial Electrochemistry 1990, 294 (1), 239-251. https://doi.org/i0.1016/0022-0728(90)87148-D.
(8) Rizo, R.; Sitta, E.; Herrero, E.; Climent, V.; Feliu, J. M. Towards the Understanding of the Interfacial PH Scale at Pt(111) Electrodes. Electrochimica Acta 2015, 162, 138-145. https://doi.org/10.1016/j.electacta.2015.01.069.
(9) Ganassin, A.; Sebastien, P.; Climent, V.; Schuhmann, W.; Bandarenka, A. S.; Feliu, J. On the PH Dependence of the Potential of Maximum Entropy of Ir(111) Electrodes. Scientific Reports 2017, 7 (1), 1246. https://doi.org/10.1038/s41598-017-01295-1.
(10) Garcia-Areez, N.; Climent, V.; Feliu, J. M. Evidence of Water Reorientation on Model Electrocatalytic Surfaces from Nanosecond-Laser-Pulsed Experiments. J. Am. Chem. Soc. 2008, 130 (12), 3824-3833. https://doi.org/10.1021/ja0761481.
(11) Ledezma-Yanez, I.; Wallace, W. D. Z.; Sebastien-Pascual, P.; Climent, V.; Feliu, J. M.; Koper, M. T. M. Interfacial Water Reorganization as a PH-Dependent Descriptor of the Hydrogen Evolution Rate on Platinum Electrodes. Nature Energy 2017, 2 (4), 1-7. https://doi.org/10.1038/nenergy.2017.31.
(12) Sarabia, F. J.; Sebastien-Pascual, P.; Koper, M. T. M.; Climent, V.; Feliu, J. M. Effect of the Interfacial Water Structure on the Hydrogen Evolution Reaction on Pt(111) Modified with Different Nickel Hydroxide Coverages in Alkaline Media. ACS Appl. Mater. Interfaces 2019, 11(1), 613-623. https://doi.org/10.1021/acsami.8b15003.
1 M. J. Pennino, J. E. Compton and S. G. Leibowitz, Environ Sc Technol, 2017, 51, 13450-13460.
2 1981, 531.
3 M. H. Ward, R. R. Jones, J. D. Brender, T. M. de Kok, P. J. Weyer, B. T. Nolan, C. M. Villanueva and S. G. van Breda, Int J Environ Res Public Health.
4 National Academy of Engineering Grand Challenges For Engineers, National Academy of Engineering, 2017.
5 C. J. Werth, C. Yan and J. P. Troutman, ACS EST Eng., 2021, 1, 6-20.
6 F. Rezvani, M.-H. Sarrafzadeh, S. Ebrahimi and H.-M. Oh, Environ Sci Pollut Res Int, 2019, 26, 1124-1141.
7 N. Singh and B. R. Goldsmith, ACS Catal., 2020, 10, 3365-3371.
8 Z. Wang, D. Richards and N. Singh, Catal. Sci. Technol., 2021, 11, 705-725.
9 P. H. van Langevelde, I. Katsounaros and M. T. M. Koper, Joule, 2021, 5, 290-294.
1. Liu, J.-X., Richards, D., Singh, N., and Goldsmith, B. R. ACS Catalysis 9, no. 8 (2019): 7052-7064.
2. Wang, Z., Young, S. D., Goldsmith, B. R., and Singh, N. Journal of Catalysis 395, (2021): 143-154.
3. McEnaney, J. M., Blair, S. J., Nielander, A. C., Schwalbe, J. A., Koshy, D. M., Cargnello, M., and Jaramillo, T. F. ACS Sustainable Chemistry & Engineering 8, no. 7 (2020): 2672-2681.
4. Langevelde, P. H. Van, Katsounaros, I., and Koper, M. T. M. Joule 5, (2021): 1-5.

1. A method for electrocatalytic conversion of nitrate to ammonia, comprising:
contacting a nitrate containing source with an electrode comprising a PtₓRu_{y}/C catalyst while applying a potential sufficient to reduce nitrate to thereby convert nitrate present in the nitrate containing source to ammonia, wherein the PtₓRu_{y}/C catalyst comprises a carbon substrate having PtₓRu_{y} nanoparticles disposed thereon, and x is about 48 at % to about 90 at %, and y is 1−x.

2. A method for electrocatalytic nitrate reduction in a flow reactor, comprising:
flowing a nitrate containing source into a working electrode compartment of an electrochemical cell while applying a potential to the cathode,
wherein:
the electrochemical cell comprising a cathode electrode in the catholyte electrode compartment, and an anode electrode disposed in an anolyte electrode compartment,
the anode electrode compartment being separated from the cathode electrode compartment by a membrane,
the cathode electrode comprises a carbon substrate with a PtₓRu_{y} nanoparticles disposed thereon to form a PtₓRu_{y}/C catalyst, with x being about 48 at % to about 90 at %, and y is 1−x, and
upon contact with the PtₓRu_{y}/C catalyst nitrate is converted to ammonia.

3. The method of claim 1, wherein the carbon substrate is carbon felt.

4. The method of claim 3, wherein the carbon felt is disposed on a graphite rod.

5. The method of claim 1, wherein the counter electrode comprises a carbon substrate having a conductive catalyst disposed thereon.

6. The method of claim 5, wherein the conductive catalyst is RuO₂, IrO₂ or mixtures.

7. The method of claim 1, wherein the nitrate source comprises an electrolyte and nitrate present in a concentration of about 1 mM to about 1 M.

8. The method of claim 1, wherein the nitrate source has a pH of about 5 to about 7.

9. The method of claim 1, wherein the cathode electrode has a catalyst loading of about 0.1 mg per cm² to about 10 mg per cm².

10. A method of thermocatalytic conversion of nitrate to ammonia comprising:
generating H₂ in an aqueous suspension of a PtₓRu/C catalyst, wherein x is about 48 at % to about 90 at % and y is 1−x;
flowing a nitrate containing source into the suspension containing the catalyst and generated H₂, wherein upon contact with the catalyst nitrate in the nitrate containing source is converted to ammonia.

11. The method of claim 10, wherein the aqueous suspension has a pH of about 1 to about 5.

12. The method of claim 10, wherein the aqueous suspension is stirred at a rate of about 100 rpm to about 10,000 rpm, while flowing a nitrate containing source into the suspension.

13. (canceled)

14. The method of claim 10, wherein generating H₂ comprising applying a potential to the aqueous suspension to generate H₂ through water splitting or sparging the aqueous suspension with H₂ gas.

15. (canceled)

16. The method of claim 10, wherein the suspension is maintained at a temperature of about 25° C. to about 90° C. while the nitrate containing source is flowed through the suspension.

17. The method of claim 10, wherein the catalyst is present in the aqueous suspension in an amount of about 1 mg catalyst per liter aqueous suspension to about 100 mg catalyst per liter aqueous suspension.

18. The method of claim 1, wherein the x is about 75 to 90.

19. The method of claim 1, wherein the PtₓRu_{y} nanoparticles have an average diameter of about 2 nm to about 6 nm.

20. The method of claim 1, wherein the method has an ammonia Faradaic Efficiency of at least about 85%.

21. The method of claim 1, wherein the nitrate source is wastewater, agricultural runoff, refuse runoff, sewage waste, low-level nuclear waste, and urban drainage.

22. The method of claim 1, wherein the nitrate source comprises nitrate in a concentration of about 1 mM to about 1000 mM.

23. (canceled)

24. (canceled)

25. (canceled)
